(19) United States
(12) Patent Application Publication
(10) Pub. No.: US 2026/0305612 A1
(43) Pub. Date: Oct. 8, 2026

(54) COPPER-BASED ANTIMICROBIAL CLEAR AND COLORLESS REACTIVE COATINGS INCLUDING COPPER(I) AND ADDITIVES

(71) Applicant: CORNING INCORPORATED, CORNING, NY (US)

(72) Inventors: Theresa Chang, Painted Post, NY (US); Sean Nichols Sacks, Corning, NY (US); Joel Teye Tetteh, Rosharon, TX (US); Shu Yuan, Vienna, VA (US)

(21) Appl. No.: 19/481,950

(22) PCT Filed: Jul. 8, 2024
(86) PCT No.: PCT/US2024/037025

§ 371 Date: Nov. 6, 2025

Related U.S. Application Data
(60) Provisional application No. 63/527,973, filed on Jul. 20, 2023.

(51) Int. Cl. A01N 57/12; A01N 25/10; A01N 57/14; A01N 59/20; A01P 1/00

(52) U.S. Cl. CPC A01N 57/12; A01N 25/10; A01N 57/14; A01N 59/20; A01P 1/00

(57) ABSTRACT

A biocidal composition including a carrier, including a polyurethane, a polyurethane precursor, an epoxy resin, an epoxy resin precursor, a melamine resin, or any combination thereof; a copper(I) salt; and a copper-assisting additive different from the carrier including a phosphite, a phosphine, or a combination thereof; and wherein the biocidal composition or a film thereof exhibits an antimicrobial efficacy of at least 3 log kill after storage of the biocidal composition or the film thereof at ambient temperature and ambient relative humidity for 90 days is provided. A biocidal additive formulation including a copper(I) salt and a copper-assisting additive, wherein a biocidal composition including the biocidal additive formulation and a carrier, or a film of the biocidal composition, exhibits an antimicrobial efficacy of at least 3 log kill as measured with an EPA Test, is further provided.

### CROSS-REFERENCE TO RELATED APPLICATIONS

This application claims priority to U.S. Provisional Patent Application No. 63/527,973, filed on Jul. 20, 2023, which is incorporated herein by reference in its entirety for all purposes.

### TECHNICAL FIELD

The present disclosure relates to biocidal compositions. More particularly, the disclosure relates to biocidal compositions comprising polyurethanes and/or epoxy resins, or precursors thereof, copper(I) salts, and copper-assisting additives.

### BACKGROUND

Compositions may exist as articles, layers, or coatings, or as liquid compositions including suspensions and solutions, which may be applied on a surface or stored in a container (for example, prior to use). Copper-containing compositions initially having antimicrobial efficacy and/or color stability may experience reduced antimicrobial efficacy and/or color drift over time, which may render the compositions visually unattractive or unsuitable for a particular purpose. For example, although copper(I) ions and complexes may be colorless and have effective antimicrobial properties, over time copper(I) may be oxidized to copper(II), which has a green or blue/green color and has less effective antimicrobial properties. Such changes are typically undesired. Additionally, in certain compositions, the availability of copper at a surface (for example, the surface of an article) may be a challenge. Reactive systems dependent upon cross-linking and curing of reactive precursors, such as polyurethanes and epoxy resins, involve the added challenge of ensuring that copper ligands do not interfere with the curing process so as to retain high durability performance of a highly crosslinked coating material.

Thus, there is a need for copper-containing compositions including polyurethanes and/or epoxy resins, or precursors thereof, having improved availability of copper, such as copper(I).

### SUMMARY

In an example, the present disclosure provides a biocidal composition, including: a carrier, including a polyurethane, a polyurethane precursor, an epoxy resin, an epoxy resin precursor, a melamine resin, or any combination thereof; a copper(I) salt; and copper-assisting additive from the carrier. The copper-assisting additive includes a phosphite, a phosphine, or a combination thereof. The biocidal composition or a film thereof exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein).

In certain examples, the phosphite may be a compound of formula (I):

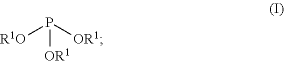

wherein each R¹ is independently selected from C₁-C₂₀ alkyl, aryl, and aryl(C₁-C₄)alkyl, any of which is optionally fluorosubstituted. In certain examples, the phosphine may be a compound of formula (II):

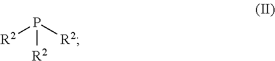

wherein each R² is independently selected from C₁-C₂₀ alkyl, aryl, and aryl(C₁-C₄)alkyl, any of which is optionally substituted with a hydroxy group. In certain examples, the carrier may include a polyurethane, a polyurethane precursor, or a combination thereof. In certain examples, the carrier may include an epoxy resin, an epoxy resin precursor, or a combination thereof. In certain examples, the carrier may include an organic solvent. In certain examples, the copper(I) salt may be a copper(I) halide, iodo (triethyl phosphite)copper(I), or a tetrakis(acetonitrile)copper(I) salt. In certain examples, the copper(I) salt may be copper(I) bromide or copper(I) iodide. In certain examples, each R¹ may be independently selected from C₂-C₁₃ alkyl and phenyl. In certain examples, each R³ may be independently selected from C₂-C₁₃ alkyl. In certain examples, the copper-assisting additive may be triethyl phosphite, tributyl phosphine, triphenyl phosphite, or any combination thereof. In certain examples, a molar ratio of the copper-assisting additive to the copper(I) salt may be at least 0.5:1. In certain examples, the biocidal composition may further include a compound of formula (III), (IV), (V), or any combination thereof:

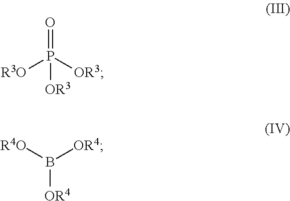

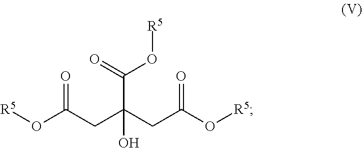

wherein each R³ is independently selected from hydrogen, C₁-C₂₀ alkyl, aryl, and aryl(C₁-C₄)alkyl, provided that all R³ are not simultaneously hydrogen; wherein each R⁴ is independently selected from hydrogen, C₁-C₂₀ alkyl, aryl, and aryl(C₁-C₄)alkyl, provided that all R⁴ are not simultaneously hydrogen; wherein each R⁵ is independently selected from hydrogen, C₁-C₂₀ alkyl, aryl, and aryl(C₁-C₄)alkyl, provided that all R⁵ are not simultaneously hydrogen. In certain examples, each R³ may be independently selected from C₁-C₁₃ alkyl. In certain examples, the biocidal composition may further include 2-ethylhexyl phosphate. In certain examples, each R⁴ may be independently selected from C₁-C₁₃ alkyl. In certain examples, the biocidal composition may further include tributyl borate. In certain examples, each R⁵ may be independently selected from C₁-C₁₃ alkyl. In certain examples, the biocidal composition may further include tributyl citrate. In certain examples, the biocidal composition may exhibit a ΔE of less than 6, as calculated according to

$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$

and wherein L*, a*, and b* are CIE values of the biocidal composition after preparing and then storing the biocidal composition at ambient temperature and ambient relative humidity for 90 days or at least 90 days (or any other time period disclosed herein), and

$${L}_{control}^{*} , {a}_{control}^{*} ,$$

and

$${b}_{control}^{*}$$

are CIE values of an otherwise identical composition without either the copper(I) salt or the copper-assisting additive. In certain examples, the biocidal composition or the film thereof may exhibit a transmittance of at least 98% as measured at each wavelength from 400 to 700 nanometers when measured at a thickness of 40 μm. In certain examples, the transmittance may be within 10 percentage points of a second transmittance of an otherwise identical composition or film thereof without either the copper(I) salt or the copper-assisting additive when measured at a thickness of 40 μm. In certain examples, a method of preparing the biocidal composition may include adding a biocidal additive formulation to a carrier; wherein when the carrier is a polyurethane or an epoxy resin, the biocidal additive formulation includes the copper(I) salt and the copper-assisting additive; wherein when the carrier is a second polyurethane precursor, the biocidal additive formulation includes a first polyurethane precursor, the copper(I) salt, and the copper-assisting additive; and wherein when the carrier is a second epoxy resin precursor, the biocidal additive formulation includes a first epoxy resin precursor, the copper(I) salt, and the copper-assisting additive.

In another example, the present disclosure provides a biocidal additive formulation, including: a copper(I) salt; and a copper-assisting additive. A biocidal composition including the biocidal additive formulation and a carrier, or a film of the biocidal composition, exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein). The carrier includes a polyurethane, a polyurethane precursor, an epoxy resin, an epoxy resin precursor, a melamine resin, or any combination thereof. The biocidal composition exhibits a ΔE of less than 6, as calculated according to

$$Δ E = \sqrt{( {( L * - {L}_{control}^{*} )}^{2} + {( a * - {a}_{control}^{*} )}^{2} + {( b * - {b}_{control}^{*} )}^{2} )} .$$

L*, a*, and b* are CIE values of the biocidal composition after preparing and then storing the biocidal composition at ambient temperature and ambient relative humidity for 90 days or at least 90 days (or any other time period disclosed herein), and L*_{control}, a*_{control}, and b*_{control} are CIE values of an otherwise identical composition without either the copper(I) salt or the copper-assisting additive.

In certain examples, the biocidal additive formulation may further include an organic solvent, a first polyurethane precursor, a first epoxy resin precursor, or any combination thereof. In certain examples, the copper(I) salt may be a copper(I) halide, iodo (triethyl phosphite)copper(I), or a tetrakis(acetonitrile)copper(I) salt. In certain examples, the copper(I) salt may be copper(I) bromide or copper(I) iodide. In certain examples, the copper-assisting additive may include a phosphite, a phosphine, or a combination thereof. In certain examples, the phosphite may be a compound of formula (I):

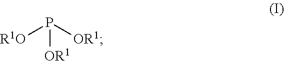

wherein each R¹ is independently selected from C₁-C₂₀ alkyl, aryl, and aryl(C₁-C₄)alkyl, any of which is optionally fluorosubstituted. In certain examples, the phosphine may be a compound of formula (I):

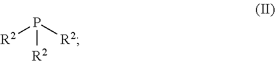

wherein each R² is independently selected from C₁-C₂₀ alkyl, aryl, and aryl(C₁-C₄)alkyl, any of which is optionally substituted with a hydroxy group. In certain examples, each R¹ may be independently selected from C₂-C₁₃ alkyl and phenyl. In certain examples, each R² may be independently selected from C₂-C₁₃ alkyl. In certain examples, the copper-assisting additive may be triethyl phosphite, tributyl phosphine, triphenyl phosphite, or any combination thereof. In certain examples, a molar ratio of the copper-assisting additive to the copper(I) salt may be at least 0.5:1. In certain examples, the biocidal additive formulation may further include a compound of formula (III), (IV), (V), or any combination thereof:

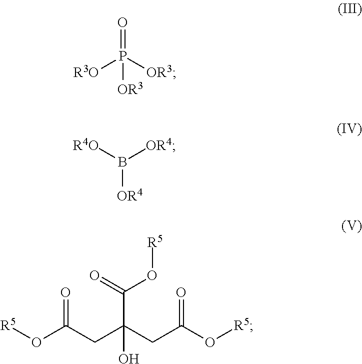

wherein each R³ is independently selected from hydrogen, C₁-C₂₀ alkyl, aryl, and aryl(C₁-C₄)alkyl, provided that all R³ are not simultaneously hydrogen; wherein each R⁴ is independently selected from hydrogen, C₁-C₂₀ alkyl, aryl, and aryl(C₁-C₄)alkyl, provided that all R⁴ are not simultaneously hydrogen; wherein each R⁵ is independently selected from hydrogen, C₁-C₂₀ alkyl, aryl, and aryl(C₁-C₄)alkyl, provided that all R⁵ are not simultaneously hydrogen. In certain examples, each R³ may be independently selected from C₁-C₁₃ alkyl. In certain examples, the biocidal additive formulation may further include 2-ethylhexyl phosphate. In certain examples, each R⁴ may be independently selected from C₁-C₁₃ alkyl. In certain examples, the biocidal additive formulation may further include tributyl borate. In certain examples, each R⁵ may be independently selected from C₁-C₁₃ alkyl. In certain examples, the biocidal additive formulation may further include tributyl citrate. The biocidal composition or the film thereof may exhibit a transmittance of at least 98% as measured at each wavelength from 400 to 700 nanometers when measured at a thickness of 40 μm. In certain examples, the transmittance may be within 10 percentage points of a second transmittance of an otherwise identical composition or film thereof without either the copper(I) salt or the copper-assisting additive when measured at a thickness of 40 μm. In certain examples, the biocidal additive formulation may further include an antioxidant package. In certain examples, the biocidal additive formulation may further include a reducing agent. In certain examples, the formulation may be in a sealed container including an inert atmosphere.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale. Moreover, in the figures, like-referenced numerals designate corresponding parts throughout the different views. The drawings described herein are for illustration purposes only and are not intended to limit the scope of the present disclosure in any way.

FIG. 1 illustrates a plot of antimicrobial efficacy for various examples of biocidal compositions including two-part polyurethanes as carrier and including copper sources such as tetrakis(acetonitrile)copper(I) and copper-containing glass (“CCG”), prepared according to the principles of the present disclosure;

FIG. 2 illustrates a plot of antimicrobial efficacy for examples of biocidal compositions including two-part polyurethanes as carrier, copper sources such as tetrakis(acetonitrile)copper(I) and CCG, triethyl phosphite (“TEP”) as copper-assisting additive, and also including 2-ethylhexyl phosphate (“EHP”), prepared according to the principles of the present disclosure;

FIG. 3 illustrates a plot of antimicrobial efficacy for examples of biocidal compositions including epoxy resins as carrier, copper sources such as tetrakis(acetonitrile)copper(I) and CCG, TEP as copper-assisting additive, and also including EHP, prepared according to the principles of the present disclosure;

FIG. 4 illustrates a plot of antimicrobial efficacy for examples of biocidal compositions including two-part polyurethanes as carrier, iodo (triethyl phosphite)copper(I) (“CuI (TEP)”) as copper source, TEP as copper-assisting additive, and also including EHP, prepared according to the principles of the present disclosure;

FIG. 5 illustrates a plot of antimicrobial efficacy for examples of biocidal compositions including epoxy resins as carrier, including copper(I) iodide and various molar ratios of TEP, prepared according to the principles of the present disclosure;

FIG. 6 illustrates a plot of antimicrobial efficacy for examples of biocidal compositions including epoxy resins as carrier, including iodo (triethyl phosphite)copper(I) and various molar ratios of potassium phosphate monobasic, prepared according to the principles of the present disclosure;

FIG. 7 illustrates a plot of antimicrobial efficacy for examples of biocidal compositions including two-part polyurethanes as carrier, copper(I) bromide as copper source, TEP as copper-assisting additive, and also including EHP, prepared according to the principles of the present disclosure;

FIG. 8 illustrates a plot of antimicrobial efficacy for examples of biocidal compositions including two-part polyurethanes as carrier, copper(I) bromide as copper source, TEP as copper-assisting additive, and varied molar excesses of EHP and ethyl acetate solvent, prepared according to the principles of the present disclosure;

FIG. 9 illustrates a plot of antimicrobial efficacy for examples of biocidal compositions including two-part polyurethanes as carrier, copper(I) bromide as copper source, TEP as copper-assisting additive, and varied molar ratios of tributyl citrate or tributyl borate, prepared according to the principles of the present disclosure; and

FIG. 10 illustrates a plot of antimicrobial efficacy for examples of biocidal compositions including two-part polyurethanes as carrier, copper(I) bromide as copper source, tributyl phosphine (“TBP”) as copper-assisting additive in varying molar ratios relative to copper, and also including EHP, prepared according to the principles of the present disclosure; and

FIG. 11 illustrates a plot of % transmittance at each wavelength from 350 nanometers to 750 nanometers, of a polyurethane film of a biocidal composition including copper(I) salt and a copper-assisting additive (“dosed”) as compared to a polyurethane film on glass that is not dosed (“undosed”) and further compared to the glass without any coating applied (“control”).

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Numerical values, including endpoints of ranges, may be expressed herein as approximations preceded by the term “about,” “approximately,” or the like. In such cases, other examples include the particular numerical values. Regardless of whether a numerical value is expressed as an approximation, two examples are included in this disclosure: one expressed as an approximation, and another not expressed as an approximation. It will be further understood that an endpoint of each range is significant both in relation to another endpoint, and independently of another endpoint.

As used herein, the term “antimicrobial” refers to a composition, a material, or a surface of a material, including when such composition or material is in the form of a coating or dry film, that will kill or inhibit the growth of microbes including, but not limited to, bacteria, viruses, mildew, mold, algae, fungi, or any combination thereof. The term “antimicrobial,” as used herein, does not necessarily mean the material or the surface of the material will kill or inhibit the growth of all species of microbes within such families, but that the material or the surface of the material will kill or inhibit the growth of one or more species of microbes from such families.

As used herein, the term “full kill” refers to a log reduction of a given microbe and/or virus that is comparable to the log reduction of the same microbe and/or virus on a copper metal surface.

As used herein, the term “dry film” refers to a coating that has been applied to a surface and allowed to actively or passively dry, such that the coating has a moisture content that has reached equilibrium with the ambient environment. In some aspects, a moisture content may be used to describe a dry film, such as a moisture content of less than 20 wt. %, for example, less than 15 wt. %, less than 10 wt. %, less than 5 wt. %, less than 4 wt. %, less than 3 wt. %, less than 2 wt. %, less than 1 wt. %, less than 0.5 wt. %, or less than 0.1 wt. %; alternatively, or additionally, a moisture content of greater than 0 wt. %, greater than 0.1 wt. %, greater than 0.5 wt. %, greater than 1 wt. %, greater than 2 wt. %, greater than 3 wt. %, greater than 4 wt. %, greater than 5 wt. %, greater than 10 wt. %, or greater than 15 wt. %; or a range formed from any two of the foregoing weight percentages; including any subranges therebetween.

As used herein, the term “biocidal” refers to a composition or material with an active substance that is intended to destroy, deter, render harmless, prevent the action of, or otherwise exert a controlling effect on undesired organisms such as bacteria, viruses, mildew, mold, algae, and/or fungi, and in some aspects a biocidal composition has antimicrobial properties.

As used herein, the term “logarithmic reduction” refers to the negative value of log (Cₐ/C₀), where Cₐ refers to the colony form unit (“CFU”) number of the antimicrobial surface and C₀ refers to the CFU of the control surface that is not an antimicrobial surface. As an example, a 3 logarithmic reduction equals 99.9% of the microbes killed and a logarithmic reduction of 5 equals 99.999% of microbes killed. The logarithmic reduction value may be measured according to one or more of the ASTM D2574-16 (2016) “Standard Test Method for Resistance of Emulsion Paints in the Container to Attack by Microorganisms,” the Modified JIS Z 2801 Test for Bacteria, the Modified JIS Z 2801 Test for Viruses, or the EPA Test, as described in more detail elsewhere herein. “Logarithmic reduction” may also be referred to herein as “log kill.” Unless otherwise specified, all logarithmic reduction information disclosed herein employs the EPA Test.

The uses of the terms “a” and “an” and “the” and similar referents in the context of describing the present disclosure (especially in the context of the following claims) are to be construed to cover both the singular and the plural, unless otherwise indicated herein or clearly contradicted by context. Recitation of ranges of values herein are merely indicated to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

As used herein, the terms “comprise(s),” “include(s),” “having,” “has,” “can,” “contain(s),” and variants thereof, are intended to be open-ended transitional phrases, terms, or words that do not preclude the possibility of additional acts, structures, elements, or components. The present description also contemplates other examples “comprising,” “consisting of,” and “consisting essentially of,” the examples or elements presented herein, whether explicitly set forth or not.

As used herein, the term “about,” when used in the context of a numerical value or range set forth refers to a variation of ±15%, or less, of the numerical value. For example, a value differing by ±15%, ±14%, ±10%, or ±5%, among others, would satisfy the definition of “about,” unless more narrowly defined in particular instances.

The term “alkyl,” by itself or as part of another substituent, refers, unless otherwise stated, to a straight, branched, or cyclic chain hydrocarbon (“cycloalkyl”) having the number of carbon atoms designated (in other words, “C₁-C₃₀” means one to thirty carbons). Examples include methyl, ethyl, propyl, isopropyl, cyclopropyl, butyl, isobutyl, sec-butyl, tert-butyl, cyclobutyl, methylcyclopropyl, cyclopropylmethyl, pentyl, neopentyl, hexyl, and cyclohexyl. Other examples are —(C₁-C₁₈)alkyl, —(C₁-C₁₅)alkyl, —(C₁-C₁₀)alkyl, —(C₁-C₈)alkyl, —(C₁-C₆)alkyl, and —(C₂-C₆)alkyl. Such alkyl groups and depicted ranges of carbon counts may apply to any formula, R group, or chemical species disclosed herein. In certain examples of the present disclosure, a —(C₁-C₃₀)alkyl group, whether straight, branched, or cyclic, may not be a -C₁alkyl group, and/or may not be a -C₂alkyl group, and/or may not be a —C₃alkyl group, and/or may not be a -C₄alkyl group, and/or may not be a -C₅alkyl group, and/or may not be a -C₆alkyl group, and/or may not be a -C₇alkyl group, and/or may not be a C₈alkyl group, and/or may not be a -C₉alkyl group, and/or may not be a -C₁₀alkyl group, and/or may not be a -C₁₁alkyl group, and/or may not be a -C₁₂alkyl group, and/or may not be a -C₁₃alkyl group, and/or may not be a -C₁₄alkyl group, and/or may not be a -C₁₅alkyl group, and/or may not be a -C₁₆alkyl group, and/or may not be a -C₁₇alkyl group, and/or may not be a -C₁₈alkyl group, and/or may not be a -C₁₉alkyl group, and/or may not be a -C₂₀alkyl group, and/or may not be a -C₂₁alkyl group, and/or may not be a -C₂₂alkyl group, and/or may not be a -C₂₃alkyl group, and/or may not be a -C₂₄alkyl group, and/or may not be a —C₂₅ alkyl group, and/or may not be a -C₂₆alkyl group, and/or may not be a -C₂₇alkyl group, and/or may not be a -C₂₈alkyl group, and/or may not be a -C₂₉alkyl group, and/or may not be a -C₃₀alkyl group. In certain examples of the present disclosure, at least one hydrogen of the alkyl group is replaced with a hydroxy group, represented by —OH.

The term “aromatic” generally refers to a carbocycle or heterocycle having one or more polyunsaturated rings having aromatic character (in other words, having (4n+2) delocalized π (pi) electrons where n is an integer).

The term “aryl,” by itself or in combination with another substituent, refers, unless otherwise stated, to a carbocyclic aromatic system containing one or more rings (typically one, two, or three rings) wherein such rings may be attached together in a pendant manner, such as a biphenyl, or may be fused, such as naphthalene. Examples may include phenyl, anthracyl, and naphthyl. Preferred are phenyl and naphthyl, most preferred is phenyl.

The term “aryl(C₁-C₄)alkyl” refers to a functional group wherein a one to four carbon alkylene chain is attached to an aryl group, for example, —CH₂—CH₂-phenyl. Examples may include benzyl.

The term “fluorosubstituted” refers to an organic chemical compound or moiety either (1) contains both carbon-hydrogen bonds and carbon-fluorine bonds; or (2) is “perfluorinated,” in which case carbon is bonded to fluorine atoms and no hydrogen atoms.

As used herein, unless otherwise specified, the term “carrier” may refer to a melamine resin, a polyurethane, a precursor thereof, an epoxy resin, a precursor thereof, or a combination thereof, as described herein.

As used herein, the term “polyurethane” refers to a class of polymers, such as alternating copolymers, including organic units joined by carbamate (urethane) links.

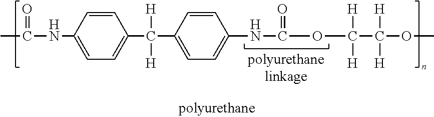

Polyurethanes may have a highly crosslinked molecular structure. Examples of polyurethanes may be produced by reacting together two separate polyurethane precursors, optionally in the presence of a catalyst or upon exposure to ultraviolet light. In certain examples, a polyurethane precursor may include a diisocyanate species. Examples of diisocyanates may include toluene-2,4-diisocyanate, toluene-2,6-diisocyanate, and 4,4′-diphenylmethane diisocyanate:

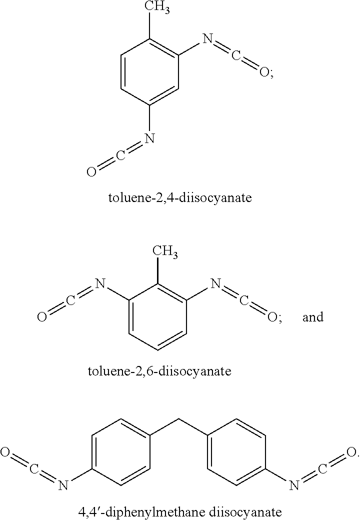 [SMILES: Cc1ccc(N=C=O)cc1N=C=O ; Cc1c(N=C=O)cccc1N=C=O ; O=C=Nc1ccc(Cc2ccc(N=C=O)cc2)cc1]

In other examples, a polyurethane precursor may include a polyol species. Polyol species may be compatible with examples of copper(I) salts and examples of copper-assisting additives of the present disclosure. Examples of bifunctional polyols may include ethylene glycol, diethylene glycol, triethylene glycol, tetraethylene glycol, 1,3-propanediol, 1,4-butanediol, and 1,6-butanediol:

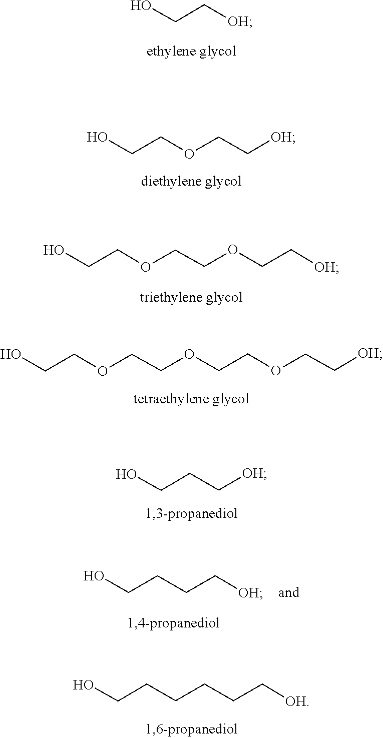

Examples of commercially available polyurethanes may include Eastwood® 4:1 High Solids Urethane Premium Show Clear.

As used herein, the term “epoxy resin” refers to a class of copolymers also known as “polyepoxides.” Examples of commercially available epoxy resins may include WiseBond® Bar & Table Top 1:1 Ratio. Examples of epoxy resins may be produced by reacting together two separate epoxy resin precursors. In certain examples, an epoxy resin precursor may include an epoxide functional group. Examples of epoxy resin precursors that include an epoxide functional group may include bisphenol A diglycidyl ether:

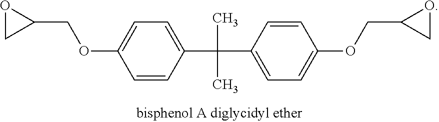 [SMILES: CC(C)(c1ccc(OCC2CO2)cc1)c1ccc(OCC2CO2)cc1]

In other examples, an epoxy resin precursor may include a polyfunctional amine, carboxylic acid, phenol, alcohol, thiol, or any combination thereof, which may react as a nucleophile with an epoxide-containing monomer to form the epoxy resin, and which may be compatible with examples of copper(I) salts and examples of copper-assisting additives of the present disclosure.

As used herein, the term “halide” refers to a negative ion (“anion”) of a halogen atom bearing a -1 formal charge. Examples of halides include fluoride (F-1), chloride (C₁-1), bromide (Br-1), and Iodide (I-1).

As used herein, the term “copper-assisting additive” refers to an additive that promotes the availability and/or persistence of copper(I) ions in a composition or material, including promoting availability of copper(I) at a surface and/or interface of a composition or material, consisting with the following explanation. Without wishing to be bound by theory, it is believed that copper(I) is largely colorless and more antimicrobially efficacious, while copper(II) is typically energetically favorable but produces color and has lower antimicrobial efficacy. As such, copper(I) is generally favored for function and color, but copper(II) is usually more stable. To promote the persistence and/or availability of copper(I) in a composition or material, several strategies/mechanisms may be considered, including employing a reducing agent (for example, to reduce copper(II) to copper(I), or to reduce other oxidants that may be present), an antioxidant (for example, to scavenge oxidants either by reduction or by sequestering by coordination or binding so as to make such oxidants unavailable to oxidize copper(II) to copper(I)), a ligand with a hydrophobic and/or bulky side chain (for example, to limit oxidant access to copper(I) in a copper complex), a ligand that favors complexation with copper(I) over copper(II) (for example, to energetically favor copper(I) to be maintained), a ligand that facilitates migration of copper(I) to a surface and/or interface, or any combination thereof. Accordingly, the copper-assisting additives disclosed herein generally are believed to perform one or more of the aforementioned functions to promote the persistence of copper(I), including in some aspects in a composition in liquid form (e.g., at ambient conditions (1 atm (~101.3 kPa) and 20° C.)), in a coating (for example, dry film), and/or in a bulk material (for example, a polyurethane, or an epoxy resin). In some aspects, the copper-assisting additive is a reducing agent, an antioxidant, a copper-coordinating ligand (for example, coordinating with copper(I) and/or copper(II)) with one or more hydrophobic side chains, a copper-coordinating ligand (for example, coordinating with copper(I) and/or copper(II)) with one or more bulky side chains, a copper-coordinating ligand (for example, coordinating with copper(I) and/or copper(II)) that complexes with copper(I) preferentially over complexing with copper(II), a copper-coordinating ligand (for example, coordinating with copper(I) and/or copper(II)) that has two or more copper coordination sites, or any combination thereof.

As used herein, the term “at. %” refers to atomic weight percent. In some aspects, “at. %” is used in reference to an amount of copper in a composition. Simply by way of example, the biocidal composition may include copper in an amount of “X at. %” (where X is a number), and this means the mass of copper atoms (using molecular weight) is summed and expressed as a percent relative to a given basis (for example, based on mass of biocidal composition). In this regard, the mass of other species in a copper complex or molecule (for example, the oxygen atom in Cu₂O) is exclude when determining mass of copper, but included as part of the biocidal composition. The amount of copper in terms of at. % may be determined by methods known in the art.

As used herein, “weight” and “mass” are used interchangeably.

As used herein, the naming convention for functional groups containing phosphorus are standardized herein. Generally, the naming convention of a functional group with respect to a given phosphorus atom is determined by how many oxygen atoms are double bonded to a phosphorus atom (“A”), the total number of carbon and hydrogen atoms single-bonded to the phosphorus atom (“B”), and the number of oxygen atoms single-bonded to the phosphorus atom (“C”). In this regard, the coordinate “(A,B,C)” may be employed to identify a phosphorus-containing functional group. In this regard, a “phosphate” has coordinate (1,0,3); a “phosphite” has coordinate (0,0,3); a “phosphine” has coordinate (0,3,0). Formula (I) is an example of a phosphite. Formula (II) is an example of a phosphine. Formula (III) is an example of a phosphate.

As used herein, the term “ambient temperature” refers to the temperature of the atmosphere in the immediate surrounding environment of an objection or equipment.

As used herein, the term “ambient relative humidity” refers to an amount of water vapor present in a specific volume of immediately surrounding atmosphere at ambient temperature expressed as a percentage of the amount of water vapor needed for saturation at the same temperature. In certain examples, ambient relative humidity may have a value of 42%.

As used herein, the term “percentage point” refers to a unit for an arithmetic difference between two percentages. For example, a difference between transmittance values of 88 percent and 98 percent for a particular measurement is a difference of 10 percentage points on the same measurement scale (calculated by subtracting 98 from 88; or 88 from 98). Percentages, by contrast, indicate the relative or proportionate part of a total; in the above example, 88 constitutes 90% of 98 (calculated by dividing 88 by 98 and multiplying by 100), and 98 constitutes 111% of 88 (calculated by dividing 98 by 88 and multiplying by 100).

In an example, the present disclosure provides a biocidal composition, including a carrier, a copper(I) salt, and a copper-assisting additive different from the carrier. In certain examples, a molar ratio of the copper-assisting additive to the copper(I) salt is at least 0.5:1. In other examples, the copper-assisting additive may be combined with the copper(I) salt and added to a carrier at a sum total concentration of both components of from 1 to 300 grams per liter of biocidal composition.

In an example, the copper(I) salt may include a copper(I) halide, iodo (triethyl phosphite)copper(I), or a tetrakis(acetonitrile)copper(I) salt, or any combination thereof. In certain examples, the copper(I) halide may be copper(I) fluoride, copper(I) chloride, copper(I) bromide, copper(I) iodide, or any combination thereof. In certain examples, the tetrakis(acetonitrile)copper(I) salt may be tetrakis(acetonitrile)copper(I) hexafluorophosphate, tetrakis(acetonitrile)copper(I) tetrafluoroborate, tetrakis(acetonitrile)copper(I) perchlorate, tetrakis(acetonitrile)copper(I) trifluoromethanesulfonate, tetrakis(acetonitrile)copper(I) hydrogen oxalate-oxalic acid-acetonitrile, or any combination thereof.

In an example, the biocidal composition may include a carrier, a copper(I) salt, and a copper-assisting additive. In certain examples, the carrier may include a polyurethane, a polyurethane precursor, an epoxy resin, an epoxy resin precursor, a melamine resin, or any combination thereof. In other examples, the copper(I) salt may be combined with a copper-assisting additive and a carrier while maintaining antimicrobial efficacy (or preventing a decrease in antimicrobial efficacy to below a particular level) and/or stabilizing the color of the carrier when the copper(I) salt is combined with the copper-assisting additive and the carrier or when then copper(I) salt and the copper-assisting additive are combined with the carrier. Examples of the present disclosure may maintain antimicrobial efficacy (or prevent a decrease in antimicrobial efficacy to below a particular level) and/or reduce changes in color of the carrier at the time of combining the copper(I) salt with the copper-assisting additive and the carrier or combining the copper(I) salt and the copper-assisting additive with the carrier. Examples of the present disclosure may reduce changes in the antimicrobial efficacy and/or reduce changes in the color of the carrier between a period of time after combining the copper(I) salt with the copper-assisting additive and the carrier or combining the copper(I) salt and the copper-assisting additive with the carrier and the final antimicrobial efficacy and/or color of the carrier.

In an example, a material (for example, a coating such as a dry film) may exhibit the logarithmic reductions described herein under one or more of the U.S. Environmental Protection Agency “Test Method of Efficacy of Copper Alloy as a Sanitizer” (2009) (also referred to herein as “the EPA Test”), the Modified Japanese Industrial Standard (JIS) Z 2801 Test for Bacteria and/or the Modified JIS Z 2801 Test for Viruses, for a period of one month or greater or for a period of three months or greater, or any of the other time periods described elsewhere herein. The time periods (for example, one-month period or three-month period) may commence a tor after the application of the material to a surface as a layer. In such examples, the layer exhibits the logarithmic reductions described herein. Each of the EPA Test, the Modified Japanese Industrial Standard (JIS) Z 2801 Test for Bacteria, and the Modified JIS Z 2801 Test for Viruses are incorporated herein by reference in their entireties.

In an example, antimicrobial efficacy of a composition or coating may be maintained, or at least a decrease in antimicrobial efficacy to below a particular level may be prevented, in the biocidal compositions disclosed herein, for example, by use of a copper-assisting additive. The effectiveness of a composition (for example, a coating such as a dry film) of the present disclosure as a biocidal composition may be measured as a function of the logarithmic reduction of the biocidal composition. The logarithmic reduction value of the biocidal composition may be relevant to the ability of the biocidal composition to kill a wide variety of biological organisms to which the biocidal composition is exposed, but may also allow the copper(I) salt to act as a preservative for the composition during storage (for example, in a container such as, but not limited to, a tank, a can, a bucket, a drum, a bottle, or a tube). According to examples of the present disclosure, a logarithmic reduction of the biocidal composition may be at least 2, at least 3, at least 4, at least 5, at least 6, at least 7, at least 8, at least 9, at least 10, in a range from 1 to 10, 3 to 7, 4 to 6, or less than, equal to, or greater than 1, 2, 3, 4, 5, 6, 7, 8, 9, or 10. In certain examples, the logarithmic reduction may be maintained (for example, prevented from falling below) at or above any of the aforementioned values over a given time period, as described elsewhere herein. The biocidal properties of the composition may make it effective for substantially killing a wide variety of biological organisms including bacteria, viruses, and fungi. Where the coating is configured to have biocidal properties with respect to bacteria, suitable examples of bacteria include Staphylococcus aureus, Enterobacter aerogenes, Pseudomonas aeruginosa, Methicillin Resistant Staphylococcus aureus, E. coli, and mixtures thereof. In certain examples, the copper(I) salt exhibits at least a logarithmic reduction, a 4 logarithmic reduction, a 5 logarithmic reduction, or even a 6 logarithmic reduction in the concentration of at least one of Staphylococcus aureus, Enterobacter aerogenes, Pseudomonas aeruginosa bacteria, Methicillin Resistant Staphylococcus aureus, and E coli under the EPA Test, or a 3 logarithmic reduction or greater, or a 4 logarithmic reduction or greater (for example, 5 logarithmic reduction or greater) under JIS Z 2801 (2000) testing conditions or under the Modified JIS Z 2801 Test for Bacteria. In other examples, the copper(I) salt exhibits a 2 logarithmic reduction or greater, a 3 logarithmic reduction or greater, a 4 logarithmic reduction or greater, or a 5 logarithmic reduction or greater in the concentration of Murine Novovirus or severe acute respiratory syndrome (“SARS”) coronavirus 2 (“SARS-CoV-2”) under a Modified JIS Z 2801 for Viruses test. The procedures for the Modified JIS Z 2801 (2000) Test for Bacteria, and the Modified JIS Z 2801 (2000) Test for Viruses, are provided in International Patent Application Pub. No. WO 2021/055300 A1, COLOR STABILIZATION OF BIOCIDAL COATINGS, which is incorporated by reference herein in its entirety.

Briefly, as used herein, Modified JIS Z 2801 Test for Bacteria includes evaluating the bacteria under the standard JIS Z 2801 (2000) test with modified conditions including heating the glass or article to a temperature of 23 degrees Celsius to 37 degrees Celsius at a humidity of 38 percent to 42 percent for 6 hours. The Modified JIS Z 2801 (2000) Test for Viruses includes the following procedure. For each material tested (for example, a biocidal composition, a composition including the copper(I) salt, a composition including the copper-assisting additive, control compositions), three samples of the material (contained in individual sterile petri dishes) are each inoculated with a 20 μL aliquot of a test virus (where antimicrobial activity is measured) or a test medium including an organic soil load of 5% fetal bovine serum with or without the test virus (where cytotoxicity is measured). The inoculum is then covered with a film and the film is pressed down so the test virus and/or the test medium spreads over the film, but does not spread past the edge of the film. The exposure time begins when each sample was inoculated. The inoculated samples are transferred to a control chamber set to room temperature or “ambient” temperature (20° C.) in a relative humidity of 42% for 2 hours. Exposure time with respect to control samples are discussed below. Following the 2-hour exposure time, the film is lifted off using sterile forces and a 2.00 mL aliquot of the test virus and/or test medium is pipetted individually onto each sample of material and the underside of the film (or the side of the film exposed to the sample) used to cover each sample. The surface of each sample is individually scraped with a sterile plastic cell scraper to collect the test virus or test medium. The test virus and/or test medium is collected (at 102 dilution), mixed using a vortex type mixer and serial 10-fold dilutions are prepared. The dilutions are then assayed for antimicrobial activity and/or cytotoxicity.

To prepare a control sample for testing antimicrobial activity (which are also referred to as “zero time vims controls”) for the Modified JIS Z 2801 Test for Viruses, three control samples (contained in individual sterile petri dishes) are each inoculated with a 20 μL aliquot of the test virus. Immediately following inoculation, a 2.00 mL aliquot of test virus is pipetted onto each control sample. The surface of each sample was individually scraped with a sterile plastic cell scraper to collect test virus. The test virus is collected (at 102 dilution), mixed using a vortex type mixer, and serial 10-fold dilutions were prepared. The dilutions are assayed for antimicrobial activity.

To prepare control samples for cytotoxicity (which are also referred to as “2 hour control virus”) for the Modified JIS Z 2801 Test for Viruses, one control sample (contained in an individual sterile petri dish) is inoculated with a 20 μL aliquot of a test medium containing an organic soil load (5% fetal bovine serum), without the test virus. The inoculum is covered with a film and the film is pressed so the test medium spreads over the film but does not spread past the edge of the film. The exposure time begins when each control sample is inoculated. The control sample is transferred to a controlled chamber set to room temperature (20° C.) in a relative humidity of 42% for a duration of 2 hours exposure time. Following this exposure time, the film is lifted off using sterile forceps and a 2.00 mL aliquot of the test medium is pipetted individually onto each control sample and the underside of the film (the side exposed to the sample). The surface of each sample is individually scraped with a sterile plastic cell scraper to collect the test medium. The test medium is collected (at 102 dilution), mixed using a vortex type mixer, and serial 10-fold dilutions were prepared. The dilutions were assayed for cytotoxicity.

A representative description of performing the EPA Test is as follows. A copper(I) salt is milled to powder using a 2-inch jet mill. The jet milled powder of the copper(I) salt is then added to a carrier (for example, commercially available Eastwood® two-part urethane) and mixed. Control coupons coated with a carrier without copper(I) salt were prepared alongside coupons coated with the copper(I) salt. A 7-mil wet film thickness drawdown bar was used to form films onto Lenata Scrub Charts (P121-10N). The films were dried for 2 days at ambient lab temperature before the antimicrobial test was conducted. Dry film thickness was around 80 μm. 1-Inch×1-inch square coupons were cut from the center of the painted scrub test panels. Stainless steel carriers, used as reference, were cleaned and sterilized by immersion in a 75% ethanol solution following by rinsing with DI water. Vials containing Staphylococcus aureus (ATCC 6538) bacterial stock culture were stored at −80° C. until use. 20 μL aliquots of thawed bacterial cultures were added to 10 mL of Tryptic Soy Broth. These bacterial suspensions were serially incubated 3× at 36° C. for 18-24 hours in an orbital shaker, and then 1× in polypropylene snap tubes for 48 hours. Cultures were subsequently mixed on a vortex mixer and allowed to settle. The upper two-thirds of suspension from each tube was aspirated and OD₆₀₀ was measured to estimate bacterial density. The culture was diluted with phosphate buffer saline to achieve a bacterial inoculum concentration near a target value of 1.0·10⁷ CFU/mL. 0.25 mL of 5% fetal bovine serum and 0.05 mL Triton™ X-100 were added to 4.70 mL bacterial suspension to aid in spreading the inoculum. Each test coupon was inoculated with 20 μL of the bacterial test culture. The inoculum volume was spread evenly using bent sterile pipette tips to ensure full and even coverage, spreading as close to the edge of the coupon as possible. Coupons were then incubated in a controlled environment set at 42% relative humidity and 23° C. for a period of 120 minutes. Following the 120-minute exposure period, coupons were neutralized in Letheen broth. Ten-fold serial dilutions of the neutralized solutions were plated using standard spread plate technique on Tryptic Soy Agar plates and incubated for 24 hours at 36° C. to yield countable numbers of survivors (approximately 20-200 colonies per plate). Log and percentage of reductions for bactericidal efficacy tests measure differences in CFUs between stainless steel and glass containing coupons. The antimicrobial efficacy measurements in terms of logarithmic reduction were performed in duplicate and the results averaged to provide an average log kill value.

In an example, it is possible to combine the copper(I) salt with a copper-assisting additive to prevent reduction of antimicrobial efficacy below a certain threshold (for example, less than a 3 logarithmic reduction or any other value disclosed herein) and/or limit the shift of the color of the biocidal composition form the color of a standard carrier (for example, the carrier in the absence of either the copper(I) or the copper-assisting additive). For example, it is possible to achieve a CIE L*a*b*ΔE* between the observed color and a standard of less than 30, less than 25, less than 20, less than 15, less than 12, less than 10, less than 9, less than 8, less than 7, less than 6, less than 5, less than 4, less than 3, less than 2, less than 1, in a range of from 1 to 30, 2 to 25, 5 to 15, 3 to 8, 4 to 7, 5 to 6, less than, equal to, or greater than 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30.

As understood, the CIE L*a*b* color space is a color scale for determining a color. The three coordinates (or dimensions/components) of CIE L*a*b* represent the lightness of the color (L*=0 indicates black and L*=100 indicates white), the position between red (sometimes referenced as magenta) and green (negative a* values indicate green while positive a* values indicate red), and the position between yellow and below (negative b* values indicate blue and positive b* values indicate yellow). The L* component closely matches human perception of lightness. Related to the CIE L*a*b* color space is the CIE L*C*h* color space that is a cylindrical representation of the three perceptual color correlates: lightness, chroma, and hue. The axial component of CIE L*C*h* is the same lightness attribute L* as CIE L*a*b*, the radial component is the chroma, and the angular component is hue. Using the CIE L*a*b* and CIE L*C*h* color spaces, the difference (for example, a ΔE*) in color between a standard and observed color may be measured, and the extent to which the desired color of a coating is altered by the components therein may be measured.

In an example, disclosed is a biocidal composition, including: a carrier; a copper(I) salt; and a copper-assisting additive. In certain examples, the carrier may include a polyurethane, a polyurethane precursor, an epoxy resin, an epoxy resin precursor, a melamine resin, or any combination thereof. In certain examples, the biocidal composition is in liquid form at ambient conditions (1 atm (~101.3 kPa) and 20° C.). In certain examples, the biocidal composition does not contain (for example, and/or the composition is not in the form of) a polyurethane, and/or does not contain a polyurethane precursor, and/or does not contain an epoxy resin, and/or does not contain an epoxy resin precursor, and/or does not contain a melamine precursor.

In certain examples, employing a copper-assisting additive allows the achievement of a desired level of antimicrobial efficacy (for example, via any test disclosed herein, such as the EPA Test).

In certain examples, the carrier and the copper-assisting additive are different. As used herein, “different” means that a given chemical species (for example, a polyurethane) cannot qualify as both the carrier and the copper-assisting additive; rather, if the carrier is, for example, a polyurethane, then the copper assisting additive cannot be a polyurethane but must instead be another chemical species (for example, triethyl phosphite).

In certain examples, the biocidal composition includes a polymer, a monomer, a binder, an organic solvent, an inorganic solvent, water, a dispersion of finely divided solids in a liquid medium that may be applied to a surface to form a film, a pigment, a filler, an extender, a drier, a rheology modifier, or any combination thereof. In certain examples the biocidal composition does not contain (for example, and/or the carrier is not or does not contain) a polymer, and/or does not contain a monomer, and/or does not contain a binder, and/or does not contain an organic solvent, and/or does not contain an inorganic solvent, and/or does not contain water, and/or does not contain a dispersion of finely divided solids in a liquid medium that may be applied to a surface to form a film, and/or does not contain a pigment, and/or does not contain a filler, and/or does not contain an extender, and/or does not contain a drier, and/or does not contain a rheology modifier.

In an example, a copper-assisting additive is or includes a phosphite, a phosphine, or any combination thereof. In certain examples, the copper-assisting additive may be hydrophobic, hydrophilic, or amphiphilic, and any of the aforementioned copper-assisting additives (or any other copper-assisting additive disclosed herein) may be characterized as hydrophobic, hydrophilic, or amphiphilic. For example, the copper-assisting additive may be or may include a hydrophobic phosphite, a hydrophobic phosphine, or any combination thereof.

In certain examples, the biocidal composition does not contain (for example, and/or the copper-assisting additive is not) a phosphite, and/or does not contain a phosphine, and/or does not contain a hydrophobic copper-assisting additive, and/or does not contain a hydrophilic copper-assisting additive, and/or does not contain an amphiphilic copper-assisting additive.

In an example, a copper-assisting additive is a compound of formula (I), formula (II), or any combination thereof.

In an example, a copper-assisting additive may be a compound of formula (I):

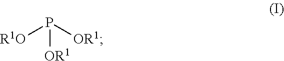

wherein each R¹ is independently selected from C₁-C₂₀ alkyl, aryl, and aryl(C₁-C₄)alkyl, and of which may be optionally fluorosubstituted.

In certain examples, each R¹ is independently selected from C₂-C₁₃ alkyl, phenyl, and benzyl.

In certain examples, each R¹ is independently selected from C₁-C₈ alkyl.

In certain examples, each R¹ is independently selected from C₁-C₅ alkyl.

In certain examples, the alpha-carbon of at least one R¹ is a secondary or tertiary carbon.

Certain examples of compounds of formula (I) may include particular combinations of R¹ selected independently such that the compounds of formula (I) complex with, interact with, or otherwise affect copper(for example, by affecting the persistence of a given oxidation state, such as copper(I)), but not as desirably or preferably as other particular combinations of R¹ due to the combined effects of chemical phenomena understood by those skilled in the art, including, but not limited to, hydrophobicity, solubility, electronic effects, and/or steric effects resulting from the chemical structure of a particular compound of formula (I). In certain examples of compounds of formula (I), each R¹ independently may not be any one of C₁-C₂₀ alkyl, and/or may not be aryl, and/or may not be aryl(C₁-C₄)alkyl. In certain examples, a biocidal composition does not include a compound of formula (I) and/or the copper-assisting additive is not a compound of formula (I).

Examples of compounds of formula (I) may include trimethyl phosphite, triethyl phosphite, triphenyl phosphite, tris(2,2,2-fluoroethyl)phosphite, tris(2-ethylhexyl)phosphite, triisopropyl phosphite, and tris(1,1,1,3,3,3-hexafluoro-2-propyl)phosphite. In certain examples, the biocidal composition does not include (for example, the copper-assisting additive is not)trimethyl phosphite, and/or does not include triethyl phosphite, and/or does not include tris(2,2,2-fluoroethyl)phosphite, and/or does not include tris(2-ethylhexyl)phosphite, triisopropyl phosphite, and/or does not contain tris(1,1,1,3,3,3-hexafluoro-2-propyl)phosphite, and/or does not include triphenyl phosphite.

In certain examples, for compounds of any of formulae (I), (II), (III), (IV), or (V), C₁-C₂₀ alkyl may include C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, C₁-C₉ alkyl, C₁-C₈ alkyl, C₁-C₇ alkyl, C₁-C₆ alkyl, C₁-C₅ alkyl, C₁-C₄ alkyl, C₁-C₃ alkyl, C₁-C₂ alkyl, C₂-C₂₀ alkyl, C₂-C₁₉ alkyl, C₂-C₁₈ alkyl, C₂-C₁₇ alkyl, C₂-C₁₆ alkyl, C₂-C₁₅ alkyl, C₂-C₁₄ alkyl, C₂-C₁₃ alkyl, C₂-C₁₂ alkyl, C₂-C₁₁ alkyl, C₂-C₁₀ alkyl, C₂-C₉ alkyl, C₂-C₈ alkyl, C₂-C₇ alkyl, C₂-C₆ alkyl, C₂-C₅ alkyl, C₂-C₄ alkyl, C₂-C₃ alkyl, C₃-C₂₀ alkyl, C₃-C₁₉ alkyl, C₃-C₁₈ alkyl, C₃-C₁₇ alkyl, C₃-C₁₆ alkyl, C₃-C₁₅ alkyl, C₃-C₁₄ alkyl, C₃-C₁₃ alkyl, C₃-C₁₂ alkyl, C₃-C₁₁ alkyl, C₃-C₁₀ alkyl, C₃-C₉ alkyl, C₃-C₈ alkyl, C₃-C₇ alkyl, C₃-C₆ alkyl, C₃-C₅ alkyl, C₃-C₄ alkyl, C₄-C₂₀ alkyl, C₄-C₁₉ alkyl, C₄-C₁₈ alkyl, C₄-C₁₇ alkyl, C₄-C₁₆ alkyl, C₄-C₁₅ alkyl, C₄-C₁₄ alkyl, C₄-C₁₃ alkyl, C₄-C₁₂ alkyl, C₄-C₁₁ alkyl, C₄-C₁₀ alkyl, C₄-C₉ alkyl, C₄-C₈ alkyl, C₄-C₇ alkyl, C₄-C₆ alkyl, C₄-C₅ alkyl, C₅-C₂₀ alkyl, C₅-C₁₉ alkyl, C₅-C₁₈ alkyl, C₅-C₁₇ alkyl, C₅-C₁₆ alkyl, C₅-C₁₅ alkyl, C₅-C₁₄ alkyl, C₅-C₁₃ alkyl, C₅-C₁₂ alkyl, C₅-C₁₁ alkyl, C₅-C₁₀ alkyl, C₅-C₉ alkyl, C₅-C₈ alkyl, C₅-C₇ alkyl, C₅-C₆ alkyl, C₆-C₂₀ alkyl, C₆-C₁₉ alkyl, C₆-C₁₈ alkyl, C₆-C₁₇ alkyl, C₆-C₁₆ alkyl, C₆-C₁₅ alkyl, C₆-C₁₄ alkyl, C₆-C₁₃ alkyl, C₆-C₁₂ alkyl, C₆-C₁₁ alkyl, C₆-C₁₀ alkyl, C₈-C₉ alkyl, C₆-C₈ alkyl, C₆-C₇ alkyl, C₇-C₂₀ alkyl, C₇-C₁₉ alkyl, C₇-C₁₈ alkyl, C₇-C₁₇ alkyl, C₇-C₁₆ alkyl, C₇-C₁₅ alkyl, C₇-C₁₄ alkyl, C₇-C₁₃ alkyl, C₇-C₁₂ alkyl, C₇-C₁₁ alkyl, C₇-C₁₀ alkyl, C₇-C₉ alkyl, C₇-C₈ alkyl, C₈-C₂₀ alkyl, C₈-C₁₉ alkyl, C₈-C₁₈ alkyl, C₈-C₁₇ alkyl, C₈-C₁₆ alkyl, C₈-C₁₅ alkyl, C₈-C₁₄ alkyl, C₈-C₁₃ alkyl, C₈-C₁₂ alkyl, C₈-C₁₁ alkyl, C₈-C₁₀ alkyl, C₈-C₉ alkyl, C₉-C₂₀ alkyl, C₉-C₁₉ alkyl, C₉-C₁₈ alkyl, C₉-C₁₇ alkyl, C₉-C₁₆ alkyl, C₉-C₁₅ alkyl, C₉-C₁₄ alkyl, C₉-C₁₃ alkyl, C₉-C₁₂ alkyl, C₉-C₁₁ alkyl, C₉-C₁₀ alkyl, C₁₀-C₂₀ alkyl, C₁₀-C₁₉ alkyl, C₁₀-C₁₈ alkyl, C₁₀-C₁₇ alkyl, C₁₀-C₁₆ alkyl, C₁₀-C₁₅ alkyl, C₁₀-C₁₄ alkyl, C₁₀-C₁₃ alkyl, C₁₀-C₁₂ alkyl, C₁₀-C₁₁ alkyl, C₁₁-C₂₀ alkyl, C₁₁-C₁₉ alkyl, C₁₁-C₁₈ alkyl, C₁₁-C₁₇ alkyl, C₁₁-C₁₆ alkyl, C₁₁-C₁₅ alkyl, C₁₁-C₁₄ alkyl, C₁₁-C₁₃ alkyl, C₁₁-C₁₂ alkyl, C₁₂-C₂₀ alkyl, C₁₂-C₁₉ alkyl, C₁₂-C₁₈ alkyl, C₁₂-C₁₇ alkyl, C₁₂-C₁₆ alkyl, C₁₂-C₁₅ alkyl, C₁₂-C₁₄ alkyl, C₁₂-C₁₃ alkyl, C₁₃-C₂₀ alkyl, C₁₃-C₁₉ alkyl, C₁₃-C₁₈ alkyl, C₁₃-C₁₇ alkyl, C₁₃-C₁₆ alkyl, C₁₃-C₁₅ alkyl, C₁₃-C₁₄ alkyl, C₁₄-C₂₀ alkyl, C₁₄-C₁₉ alkyl, C₁₄-C₁₈ alkyl, C₁₄-C₁₇ alkyl, C₁₄-C₁₆ alkyl, C₁₄-C₁₅ alkyl, C₁₅-C₂₀ alkyl, C₁₅-C₁₉ alkyl, C₁₅-C₁₈ alkyl, C₁₅-C₁₇ alkyl, C₁₅-C₁₆ alkyl, C₁₆-C₂₀ alkyl, C₁₆-C₁₉ alkyl, C₁₆-C₁₈ alkyl, C₁₆-C₁₇ alkyl, C₁₇-C₂₀ alkyl, C₁₇-C₁₉ alkyl, C₁₇-C₁₈ alkyl, C₁₈-C₂₀ alkyl, C₁₈-C₁₉ alkyl, and C₁₉-C₂₀ alkyl.

In certain examples of compounds of formula (I), each R¹ may not be C₁ alkyl, and/or may not be optionally fluorosubstituted C₁ alkyl, and/or may not be C₂ alkyl, and/or may not be optionally fluorosubstituted C₂ alkyl, and/or may not be C₃ alkyl, and/or may not be optionally fluorosubstituted C₃ alkyl, and/or may not be C₄ alkyl, and/or may not be optionally fluorosubstituted C₄ alkyl, and/or may not be C₅ alkyl, and/or may not be optionally fluorosubstituted C₅ alkyl, and/or may not be C₆ alkyl, and/or may not be optionally fluorosubstituted C₆ alkyl, and/or may not be C₇ alkyl, and/or may not be optionally fluorosubstituted C₇ alkyl, and/or may not be C₈ alkyl, and/or may not be optionally fluorosubstituted C₈ alkyl, and/or may not be C₉ alkyl, and/or may not be optionally fluorosubstituted C₉ alkyl, and/or may not be C₁₀ alkyl, and/or may not be optionally fluorosubstituted C₁₀ alkyl, and/or may not be C₁₁ alkyl, and/or may not be optionally fluorosubstituted C₁₁ alkyl, and/or may not be C₁₂ alkyl, and/or may not be optionally fluorosubstituted C₁₂ alkyl, and/or may not be C₁₃ alkyl, and/or may not be optionally fluorosubstituted C₁₃ alkyl, and/or may not be C₁₄ alkyl, and/or may not be optionally fluorosubstituted C₁₄ alkyl, and/or may not be C₁₅ alkyl, and/or may not be optionally fluorosubstituted C₁₅ alkyl, and/or may not be C₁₆ alkyl, and/or may not be optionally fluorosubstituted C₁₆ alkyl, and/or may not be C₁₇ alkyl, and/or may not be optionally fluorosubstituted C₁₇ alkyl, and/or may not be C₁₈ alkyl, and/or may not be optionally fluorosubstituted C₁₈ alkyl, and/or may not be C₁₉ alkyl, and/or may not be optionally fluorosubstituted C₁₉ alkyl, and/or may not be C₂₀ alkyl, and/or may not be optionally fluorosubstituted C₂₀ alkyl, and/or may not be phenyl.

Without being bound by any particular theory, it is believed that the presence or maintenance of copper(I) is promoted by employing a compound of formula (I) or any salt thereof, and a biocidal composition containing a compound of formula (I) or any salt thereof exhibits one or more effects when combined with a copper(I) salt, including maintaining antimicrobial efficacy of a biocidal composition, preventing reduction of antimicrobial efficacy of a biocidal composition below a certain level (for example, less than 3 logarithmic reduction), minimizing color drift of a biocidal composition, or any combination thereof. Antimicrobial efficacy may be measured as described elsewhere herein, such as by using the EPA Test.

In an example, a copper-assisting additive may be a compound of formula (II) or any salt thereof:

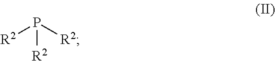

wherein each R² is independently selected from C₁-C₂₀ alkyl, aryl, and aryl(C₁-C₄)alkyl, any of which is optionally substituted with a hydroxy group.

In certain examples, each R² is independently selected from C₂-C₁₃ alkyl, any of which is optionally substituted with a hydroxy group.

In certain examples, each R² is independently selected from C₁-C₁₀ alkyl, any of which is optionally substituted with a hydroxy group.

In certain examples, each R² is independently selected from C₁-C₆ alkyl, any of which is optionally substituted with a hydroxy group.

In certain examples, an alpha-carbon of at least one R² is a secondary carbon or a tertiary carbon.

Certain examples of compounds of formula (II) may include combinations of R² selected independently such that the compounds of formula (II) complex with, interact with, or otherwise affect copper(for example, by affecting the persistence of a given oxidation state, such as copper(I)), but not as desirably or preferably as other particular combinations of R² due to the combined effects of chemical phenomena understood by those skilled in the art, including, but not limited to, hydrophobicity, solubility, electronic effects, and/or steric effects resulting from the chemical structure of a particular compound of formula (II). In certain examples of compounds of formula (II), each R² independently may not be C₁ alkyl, and/or may not be C₁ alkyl optionally substituted with a hydroxy group, and/or may not be C₂ alkyl, and/or may not be C₂ alkyl optionally substituted with a hydroxy group, and/or may not be C₃ alkyl, and/or may not be C₃ alkyl optionally substituted with a hydroxy group, and/or may not be C₄ alkyl, and/or may not be C₄ alkyl optionally substituted with a hydroxy group, and/or may not be C₅ alkyl, and/or may not be C₅ alkyl optionally substituted with a hydroxy group, and/or may not be C₆ alkyl, and/or may not be C₆ alkyl optionally substituted with a hydroxy group, and/or may not be C₇ alkyl, and/or may not be C₇ alkyl optionally substituted with a hydroxy group, and/or may not be C₈ alkyl, and/or may not be C₈ alkyl optionally substituted with a hydroxy group, and/or may not be C₉ alkyl, and/or may not be C₉ alkyl optionally substituted with a hydroxy group, and/or may not be C₁₀ alkyl, and/or may not be C₁₀ alkyl optionally substituted with a hydroxy group, and/or may not be C₁₁ alkyl, and/or may not be C₁₁ alkyl optionally substituted with a hydroxy group, and/or may not be C₁₂ alkyl, and/or may not be C₁₂ alkyl optionally substituted with a hydroxy group, and/or may not be C₁₃ alkyl, and/or may not be C₁₃ alkyl optionally substituted with a hydroxy group, and/or may not be C₁₄ alkyl, and/or may not be C₁₄ alkyl optionally substituted with a hydroxy group, and/or may not be C₁₅ alkyl, and/or may not be C₁₅ alkyl optionally substituted with a hydroxy group, and/or may not be C₁₆ alkyl, and/or may not be C₁₆ alkyl optionally substituted with a hydroxy group, and/or may not be C₁₇ alkyl, and/or may not be C₁₇ alkyl optionally substituted with a hydroxy group, and/or may not be C₁₈ alkyl, and/or may not be C₁₈ alkyl optionally substituted with a hydroxy group, and/or may not be C₁₉ alkyl, and/or may not be C₁₉ alkyl optionally substituted with a hydroxy group, and/or may not be C₂₀ alkyl, and/or may not be C₂₀ alkyl optionally substituted with a hydroxy group. In certain examples, a biocidal composition does not include a compound of formula (II) and/or the copper-assisting additive is not a compound of formula (II).

Examples of compounds of formula (II) may include tris(hydroxypropyl) phosphine and tributyl phosphine. In certain examples, the biocidal composition does not include (for example, the copper-assisting additive is not) one or more of tris(hydroxypropyl) phosphine or tributyl phosphine.

Without being bound by any particular theory, it is believed the presence or maintenance of copper(I) is promoted by employing a compound of formula (II), and a biocidal composition containing a compound of formula (II) exhibits one or more effects when combined with a copper(I) salt, including maintaining antimicrobial efficacy of a biocidal composition below a certain level (for example, less than 3 logarithmic reduction), minimizing color drift of a biocidal composition, or any combination thereof.

In an example, a biocidal composition of the present disclosure may include a compound of formula (III), (IV), (V), or any combination thereof:

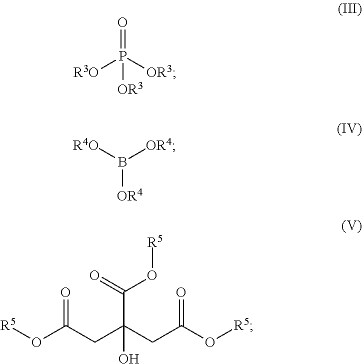

wherein each R³ is independently selected from hydrogen, C₁-C₂₀ alkyl, aryl, and aryl(C₁-C₄)alkyl, provided that all R³ not simultaneously hydrogen; wherein each R⁴ is independently selected from hydrogen, C₁-C₂₀ alkyl, aryl, and aryl(C₁-C₄)alkyl, provided that all R⁴ are not simultaneously hydrogen; and wherein each R⁵ is independently selected from hydrogen, C₁-C₂₀ alkyl, aryl, and aryl(C₁-C₄)alkyl.

In certain examples, each R³ is independently selected from the group consisting of hydrogen, C₁-C₁₃ alkyl, phenyl, and benzyl, provided that all R³ are not simultaneously hydrogen.

In certain examples, the alpha-carbon of at least one R³ is a secondary or tertiary carbon.

Certain examples of compounds of formula (III) may include particular combinations of R³ selected independently such that the compounds of formula (III) complex with, interact with, or otherwise affect copper(for example, by affecting the persistence of a given oxidation state, such as copper(I)), but not as desirably or preferably as other particular combinations of R³ due to the combined effects of chemical phenomena understood by those skilled in the art, including, but not limited to, hydrophobicity, solubility, electronic effects, and/or steric effects resulting from the chemical structure of a particular compound of formula (III). In certain examples of compounds of formula (III), each R³ independently may not be hydrogen, and/or may not be any one of C₁-C₂₀ alkyl, and/or may not be aryl, and/or may not be aryl(C₁-C₄)alkyl. In certain examples, a biocidal composition does not include a compound of formula (III).

Examples of compounds of formula (III) may include 2-ethylhexyl phosphate, bis(2-ethylhexyl)phosphate, tris(2-ethylhexyl)phosphate, methyl phosphate, diethyl phosphate, trimethyl phosphate, butyl phosphate (for example, n-butyl, sec-butyl, or tert-butyl), dibutyl phosphate (for example, n-butyl, sec-butyl, and/or tert-butyl), tributyl phosphate (for example, n-butyl, sec-butyl, and/or tert-butyl), phenyl phosphate, diphenyl phosphate, triphenyl phosphate, benzyl phosphate, dibenzyl phosphate, tribenzyl phosphate, or any combination thereof. In certain examples, the biocidal composition does not include 2-ethylhexyl phosphate, and/or does not include bis(2-ethylhexyl)phosphate, and/or does not include tris(2-ethylhexyl)phosphate, and/or does not include methyl phosphate, and/or does not include dimethyl phosphate, and/or does not include trimethyl phosphate, and/or does not include butyl phosphate (for example, n-butyl, sec-butyl, or tert-butyl), and/or does not include dibutyl phosphate (for example, n-butyl, sec-butyl, or tert-butyl), and/or does not include tributyl phosphate (for example, n-butyl, sec-butyl, or tert-butyl), and/or does not include phenyl phosphate, and/or does not include diphenyl phosphate, and/or does not include triphenyl phosphate, and/or does not include benzyl phosphate, and/or does not include dibenzyl phosphate, and/or does not include tribenzyl phosphate.

In certain examples of compounds of formula (III), each R³ may not be C₁ alkyl, and/or may not be C₂ alkyl, and/or may not be C₃ alkyl, and/or may not be C₄ alkyl, and/or may not be C₅ alkyl, and/or may not be C₆ alkyl, and/or may not be C₇ alkyl, and/or may not be C₈ alkyl, and/or may not be C₉ alkyl, and/or may not be C₁₀ alkyl, and/or may not be C₁₁ alkyl, and/or may not be C₁₂ alkyl, and/or may not be C₁₃ alkyl, and/or may not be C₁₄ alkyl, and/or may not be C₁₅ alkyl, and/or may not be C₁₆ alkyl, and/or may not be C₁₇ alkyl, and/or may not be C₁₈ alkyl, and/or may not be C₁₉ alkyl, and/or may not be C₂₀ alkyl.

In certain examples, each R⁴ is independently selected from the group consisting of hydrogen, C₁-C₁₃ alkyl, phenyl, and benzyl, provided that all R⁴ are not all simultaneously hydrogen.

In certain examples, the alpha-carbon of at least one R⁴ is a secondary or tertiary carbon.

Certain examples of compounds of formula (IV) may include particular combinations of R⁴ selected independently such that the compounds of formula (IV) complex with, interact with, or otherwise affect copper(for example, by affecting the persistence of a given oxidation state, such as copper(I)), but not as desirably or preferably as other particular combinations of R⁴ due to the combined effects of chemical phenomena understood by those skilled in the art, including, but not limited to, hydrophobicity, solubility, electronic effects, and/or steric effects resulting from the chemical structure of a particular compound of formula (IV). In certain examples of compounds of formula (IV), each R⁴ independently may not be hydrogen, and/or may not be any one of C₁-C₂₀ alkyl, and/or may not be aryl, and/or may not be aryl(C₁-C₄)alkyl. In certain examples, a biocidal composition does not include a compound of formula (IV).

Examples of compounds of formula (IV) may include tributyl borate. In certain examples, the biocidal composition does not include tributyl borate.

In certain examples of compounds of formula (IV), each R⁴ may not be C₁ alkyl, and/or may not be C₂ alkyl, and/or may not be C₃ alkyl, and/or may not be C₄ alkyl, and/or may not be C₅ alkyl, and/or may not be C₆ alkyl, and/or may not be C₇ alkyl, and/or may not be C₈ alkyl, and/or may not be C₉ alkyl, and/or may not be C₁₀ alkyl, and/or may not be C₁₁ alkyl, and/or may not be C₁₂ alkyl, and/or may not be C₁₃ alkyl, and/or may not be C₁₄ alkyl, and/or may not be C₁₅ alkyl, and/or may not be C₁₆ alkyl, and/or may not be C₁₇ alkyl, and/or may not be C₁₈ alkyl, and/or may not be C₁₉ alkyl, and/or may not be C₂₀ alkyl.

In certain examples, each R⁵ is independently selected from the group consisting of hydrogen, C₁-C₁₃ alkyl, phenyl, and benzyl, provided that all R⁵ are not all simultaneously hydrogen.

In certain examples, the alpha-carbon of at least one R⁵ is a secondary or tertiary carbon.

Certain examples of compounds of formula (V) may include particular combinations of R⁵ selected independently such that the compounds of formula (V) complex with, interact with, or otherwise affect copper(for example, by affecting the persistence of a given oxidation state, such as copper(I)), but not as desirably or preferably as other particular combinations of R⁵ due to the combined effects of chemical phenomena understood by those skilled in the art, including, but not limited to, hydrophobicity, solubility, electronic effects, and/or steric effects resulting from the chemical structure of a particular compound of formula (V). In certain examples of compounds of formula (V), each R⁵ independently may not be hydrogen, and/or may not be any one of C₁-C₂₀ alkyl, and/or may not be aryl, and/or may not be aryl(C₁-C₄)alkyl. In certain examples, a biocidal composition does not include a compound of formula (V).

Examples of compounds of formula (V) may include tributyl citrate. In certain examples, the biocidal composition does not include tributyl citrate.

In an example, the biocidal composition includes copper in an amount of at least 0.01 at. % based on 100 weight percent of the biocidal composition. In certain examples, the biocidal composition includes copper in an amount of less than 10 at. % based on a total 100 weight percent of the biocidal composition. In certain examples, the biocidal composition includes copper in an amount (at. % based on 100 weight percent of the biocidal composition) of 0.01-10, 0.01-9, 0.01-8, 0.01-7, 0.01-6, 0.01-5, 0.01-4, 0.01-3, 0.01-2, 0.01-1, 0.01-0.9, 0.01-0.8, 0.01-0.7, 0.01-0.6, 0.01-0.5, 0.01-0.4, 0.01-0.3, 0.01-0.2, 0.01-0.1, 0.01-0.05, 0.02-10, 0.02-9, 0.02-8, 0.02-7, 0.02-6, 0.02-5, 0.02-4, 0.02-3, 0.02 2, 0.02-1, 0.02-0.9, 0.02-0.8, 0.02-0.7, 0.02-0.6, 0.02-0.5, 0.02-0.4, 0.02-0.3, 0.02-0.2, 0.02-0.1, 0.02-0.05, 0.05-10, 0.05-9, 0.05-8, 0.05-7, 0.05-6, 0.05-5, 0.05-4, 0.05-3, 0.05-2, 0.05-1, 0.05-0.9, 0.05-0.8, 0.05-0.7, 0.05-0.6, 0.05-0.5, 0.05-0.4, 0.05-0.3, 0.05-0.2, 0.05-0.1, 0.1-10, 0.1-9, 0.1-8, 0.1-7, 0.1-6, 0.1-5, 0.1-4, 0.1-3, 0.1-2, 0.1-1, 0.1-0.9, 0.1-0.8, 0.1-0.7, 0.1-0.6, 0.1-0.5, 0.1-0.4, 0.1-0.3, 0.1-0.2, 0.2-10, 0.2-9, 0.2-8, 0.2-7, 0.2-6, 0.2-5, 0.2-4, 0.2-3, 0.2-2, 0.2-1, 0.2-0.9, 0.2-0.8, 0.2-0.7, 0.2-0.6, 0.2-0.5, 0.2-0.4, 0.2-0.3, 0.3-10, 0.3-9, 0.3-8, 0.3-7, 0.3-6, 0.3-5, 0.3-4, 0.3-3, 0.3-2, 0.3-1, 0.3-0.9, 0.3-0.8, 0.3-0.7, 0.3-0.6, 0.3-0.5, 0.3-0.4, 0.4-10, 0.4-9, 0.4-8, 0.4-7, 0.4-6, 0.4-5, 0.4-4, 0.4-3, 0.4-2, 0.4-1, 0.4-0.9, 0.4-0.8, 0.4-0.7, 0.4-0.6, 0.4-0.5, 0.5-10, 0.5-9, 0.5-8, 0.5-7, 0.5-6, 0.5-5, 0.5-4, 0.5-3, 0.5-2, 0.5-1, 0.5-0.9, 0.5-0.8, 0.5-0.7, 0.5-0.6, 0.6-10, 0.6-9, 0.6-8, 0.6-7, 0.6-6, 0.6-5, 0.6-4, 0.6-3, 0.6-2, 0.6-1, 0.6-0.9, 0.6-0.8, 0.6-0.7, 0.7-10, 0.7-9, 0.7-8, 0.7-7, 0.7-6, 0.7-5, 0.7-4, 0.7-3, 0.7 2, 0.7-1, 0.7-0.9, 0.7-0.8, 0.8-10, 0.8-9, 0.8-8, 0.8-7, 0.8-6, 0.8-5, 0.8-4, 0.8 3, 0.8-2, 0.8-1, 0.8-0.9, 0.9-10, 0.9-9, 0.9-8, 0.9-7, 0.9-6, 0.9-5, 0.9-4, 0.9-3, 0.9-2, 0.9-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4 8, 4-7, 4-6, 4-5, 5-10, 5-9, 5-8, 5-7, 5-6, 6-10, 6-9, 6-8, 6-7, 7-10, 7-9, 7-8, 8-10, 8-9, 9-10, 0.06-0.5, 0.07-0.4, 0.08-0.3, 0.09-0.2, 0.02-1.9, 0.03-1.8, 0.03-1.7, 0.04-1.7, 0.05-1.8, 0.06-1.7, 0.07-1.6, 0.08-1.5, 0.09-1.4, 0.1-1.3, 0.2-1.2, 0.3-1.1; or any combination thereof; or any range formed from any two of the foregoing at. % values; including any subranges therebetween.

In an example, the copper(I) salt alone, the copper-assisting additive alone, or a sum total of both the copper(I) salt and the copper-assisting additive may be described by any of the following numbers and ranges: from 0.01 wt. % based on total 100 wt. % of the carrier or the biocidal composition to 20 wt. % based on weight of the carrier of the biocidal composition, such as, an amount (wt. % based on 100 wt. % of the carrier or the biocidal composition) of 0.01 19, 0.01-18, 0.01-17, 0.01-16, 0.01-15, 0.01-14, 0.01-13, 0.01-12, 0.01-11, 0.01-10, 0.01-9, 0.01-8, 0.01-7, 0.01-6, 0.01-5, 0.01-4.9, 0.01-4.8, 0.01-4.7, 0.01-4.6, 0.01-4.5, 0.01-4.4, 0.01-4.3, 0.01-4.2, 0.01-4.1, 0.01-4, 0.01-3.9, 0.01-3.8, 0.01-3.7, 0.01-3.6, 0.01-3.5, 0.01-3.4, 0.01-3.3, 0.01-3.2, 0.01-3.1, 0.01-3, 0.01-2.9, 0.01-2.8, 0.01-2.7, 0.01-2.6, 0.01-2.5, 0.01-2.4, 0.01-2.3, 0.01-2.2, 0.01-2.1, 0.01-2, 0.01-1.9, 0.01-1.8, 0.01-1.7, 0.01-1.6, 0.01-1.5, 0.01-1.4, 0.01-1.3, 0.01-1.2, 0.01-1.1, 0.01-1, 0.01-0.9, 0.01-0.8, 0.01-0.7, 0.01-0.6, 0.01-0.5, 0.01-0.4, 0.01-0.3, 0.01-0.2, 0.01-0.1, 0.02-5, 0.03-5, 0.04-5, 0.05-5, 0.06-5, 0.07-5, 0.08 5, 0.09-5, 0.1-5, 0.2-5, 0.3-5, 0.4-5, 0.5-5, 0.6-5, 0.7-5, 0.8-5, 0.9-5, 1-5, 1 4, 1-3, 1-2, 2-5, 2-4, 2-3, 3-5, 4-5, 0.1-3, 0.1-2, 0.1-1, 0.1-1.9, 0.1-1.8, 0.1-1.7, 0.1-1.6, 0.1-1.5, 0.1-1.4, 0.1-1.3, 0.1-1.2, 0.1-1.1, 0.1-1, 0.1-0.9, 0.1-0.8, 0.1-0.7, 0.1-0.6, 0.1-0.5, 0.1-0.4, 0.1-0.3, 0.1-0.2, 0.1-5, 0.2-4.5, 0.3-4, 0.4-3.5, 0.5-3, 0.6-2.5, 0.7-2, 0.8-1.5, 0.9-1, 0.15-1.8, 0.2-1.6, 0.25-1.4, 0.3-1.2, 0.35 1, 0.4-0.95, 0.45-0.9, 0.5-0.85, 6-20, 7-20, 8-20, 9-20, 10-20, 11-20, 12-20, 13-20, 14-20, 15-20, 16-20, 17-20, 18-20, 19-20, 0.1-15, 0.5-14, 1-13, 1.5-12, 2-10, or any combination thereof. Such numbers may refer to the absolute amount present, or to the amount added to a composition. The basis weight may be either the carrier or the biocidal composition, as will be made clear from context because, in certain examples, the carrier is a main component of the biocidal composition. As such, in certain examples, the amount of a given component (or components) relative to either the carrier or the biocidal composition will be a similar value.

In one or more examples, the copper(I) salt and the copper-assisting additive may be present in a sum total amount of at least 10 grams per liter of carrier (or biocidal composition), or at least 15 grams per liter of carrier (or biocidal composition), or at least 20 grams per liter of carrier (or biocidal composition), or at least 25 grams per liter of carrier (or biocidal composition), or at least 30 grams per liter of carrier (or biocidal composition), or at least 35 grams per liter of carrier (or biocidal composition), or at least 40 grams per liter of carrier (or biocidal composition).

In an example, the copper(I) salt and copper-assisting additive may be present in a sum total amount (grams per liter of carrier or biocidal composition) of from 1-50, 1-45, 1-40, 1-35, 1-30, 1-25, 1-20, 1-15, 1-10, 1-5, 2-50, 2-45, 2-40, 2-35, 2-30, 2-25, 2-20, 2-15, 2-10, 2-5, 3-50, 3-45, 3-40, 3-35, 3-30, 3-25, 3-20, 3-15, 3 10, 3-5, 4-50, 4-45, 4-40, 4-35, 4-30, 4-25, 4-20, 4-15, 4-10, 4-5, 5-50, 5 45, 5-40, 5-35, 5-30, 5-25, 5-20, 5-15, 5-10, 10-50, 10-45, 10-40, 10-35, 10-30, 10-25, 10-20, 10-15, 15-50, 15-45, 15-40, 15-35, 15-30, 15-25, 15-20, 20-50, 20-45, 20-40, 20-35, 20-30, 20-25, 25-50, 25-45, 25-40, 25-35, 25 30, 30-50, 30-45, 30-40, 30-35, 35-50, 35-45, 35-40, 40-50, 40-45, 45-50, 6 50, 6-45, 6-40, 6-35, 6-30, 6-25, 6-20, 6-15, 6-10, 7-50, 7-45, 7-40, 7-35, 7-30, 7-25, 7-20, 7-15, 7-10, 8-50, 8-45, 8-40, 8-35, 8-30, 8-25, 8-20, 8-15, 8-10, 9-50, 9-45, 9-40, 9-35, 9-30, 9-25, 9-20, 9-15, or 9-10. As disclosed elsewhere herein, the basis may be expressed as either carrier or biocidal composition.

In an example, the copper(I) salt may be present in the biocidal composition in an amount of at least 1 gram per liter of biocidal composition or carrier. In certain examples, the copper(I) salt may be present in the biocidal composition or carrier in an amount of less than 135 grams per liter of biocidal composition or carrier. In certain examples, the copper(I) salt may be present in the biocidal composition or carrier in an amount (grams per liter of biocidal composition or carrier) of 1-135, 1-130, 1-125, 1-120, 1-115, 1-110, 1-105, 1-100, 1-95, 1-90, 1-85, 1-80, 1-75, 1-70, 1-65, 1-60, 1-55, 1-50, 1-45, 1-40, 1-35, 1-30, 1-25, 1-20, 1-15, 1-10, 1-5, 2-135, 2-130, 2-125, 2-120, 2-115, 2-110, 2-105, 2-100, 2-95, 2-90, 2-85, 2-80, 2-75, 2-70, 2-65, 2-60, 2-55, 2-50, 2-45, 2-40, 2-35, 2-30, 2-25, 2-20, 2-15, 2-10, 2-5, 5-135, 5-130, 5-125, 5-120, 5-115, 5-110, 5-105, 5-100, 5-95, 5-90, 5-85, 5-80, 5-75, 5-70, 65, 5-60, 5-55, 5-50, 5-45, 5-40, 5-35, 5-30, 5-25, 5-20, 5-15, 5-10, 10-135, 10-130, 10-125, 10-120, 10-115, 10-110, 10-105, 10-100, 10-95, 10-90, 10 85, 10-80, 10-75, 10-70, 10-65, 10-60, 10-55, 10-50, 10-45, 10-40, 10-35,-30, 10-25, 10-20, 10-15, 15-135, 15-130, 15-125, 15-120, 15-115, 15-110, 105, 15-100, 15-95, 15-90, 15-85, 15-80, 15-75, 15-70, 15-65, 15-60, 15-55, 15-50, 15-45, 15-40, 15-35, 15-30, 15-25, 15-20, 20-135, 20-130, 20-125, 120, 20-115, 20-110, 20-105, 20-100, 20-95, 20-90, 20-85, 20-80, 20-75, 20-70, 20-65, 20-60, 20-55, 20-50, 20-45, 20-40, 20-35, 20-30, 20-25, 25-135, 25-130, 25-125, 25-120, 25-115, 25-110, 25-105, 25-100, 25-95, 25-90, 25 85, 25-80, 25-75, 25-70, 25-65, 25-60, 25-55, 25-50, 25-45, 25-40, 25-35, 30, 30-135, 30-130, 30-125, 30-120, 30-115, 30-110, 30-105, 30-100, 30-95, 30-90, 30-85, 30-80, 30-75, 30-70, 30-65, 30-60, 30-55, 30-50, 30-45, 30 40, 30-35, 35-135, 35-130, 35-125, 35-120, 35-115, 35-110, 35-105, 35-100, 35-95, 35-90, 35-85, 35-80, 35-75, 35-70, 35-65, 35-60, 35-55, 35-50, 35-45, 35-40, 40-135, 40-130, 40-125, 40-120, 40-115, 40-110, 40-105, 40-100, 40 95, 40-90, 40-85, 40-80, 40-75, 40-70, 40-65, 40-60, 40-55, 40-50, 40-45, 45-135, 45-130, 45-125, 45-120, 45-115, 45-110, 45-105, 45-100, 45-95, 45-90, 45-85, 45-80, 45-75, 45-70, 45-65, 45-60, 45-55, 45-50, 50-135, 50-130, 50-125, 50-120, 50-115, 50-110, 50-105, 50-100, 50-95, 50-90, 50-85, 50-80, 50-75, 50-70, 50-65, 50-60, 50-55, 55-135, 55-130, 55-125, 55-120, 55-115, 55-110, 55-105, 55-100, 55-95, 55-90, 55-85, 55-80, 55-75, 55-70, 55-65, 55-60, 60-135, 60-130, 60-125, 60-120, 60-115, 60-110, 60-105, 60-100, 60-95, 60-90, 60-85, 60-80, 60-75, 60-70, 60-65, 65-135, 65-130, 65-125, 65-120, 65 115, 65-110, 65-105, 65-100, 65-95, 65-90, 65-85, 65-80, 65-75, 65-70, 70-135, 70-130, 70-125, 70-120, 70-115, 70-110, 70-105, 70-100, 70-95, 70-90, 70-85, 70-80, 70-75, 75-135, 75-130, 75-125, 75-120, 75-115, 75-110, 75-105, 75-100, 75-95, 75-90, 75-85, 75-80, 80-135, 80-130, 80-125, 80-120, 80-115, 80-110, 80-105, 80-100, 80-95, 80-90, 80-85, 85-135, 85-130, 85-125, 85-120, 85-115, 85-110, 85-105, 85-100, 85-95, 85-90, 90-135, 90-130, 90-125, 90-120, 90-115, 90-110, 90-105, 90-100, 90-95, 95-135, 95-130, 95-125, 95-120, 95-115, 95-110, 95-105, 95-100, 100-135, 100-130, 100-125, 100-120, 100-115, 100-110, 100-105, 105-135, 105-130, 105-125, 105-120, 105-115, 105-110, 110-135, 110-130, 110-125, 110-120, 110-115, 115-135, 115-130, 115-125, 115-120, 120-135, 120-130, 120-125, 125-135, 125-130, 130-135; any combination thereof; or any range formed from any two of the foregoing amounts of grams per liter; including any subranges therebetween.

In an example, the molar ratio of the copper-assisting additive to the copper(I) salt in the biocidal composition may be from 0.1:1 to 50:1, including, for example, from 0.1:1 to 49:1, from 0.1:1 to 48:1, from 0.1:1 to 47:1, from 0.1:1 to 46:1, from 0.1:1 to 45:1, from 0.1:1 to 44:1, from 0.1:1 to 43:1, from 0.1:1 to 42:1, from 0.1:1 to 41:1, from 0.1:1 to 40:1, from 0.1:1 to 39:1, from 0.1:1 to 38:1, from 0.1:1 to 37:1, from 0.1:1 to 36:1, from 0.1:1 to 35:1, from 0.1:1 to 34:1, from 0.1:1 to 33:1, from 0.1:1 to 32:1, from 0.1:1 to 31:1, from 0.1:1 to 30:1, from 0.1:1 to 29:1, from 0.1:1 to 28:1, from 0.1:1 to 27:1, from 0.1:1 to 26:1, from 0.1:1 to 25:1, from 0.1:1 to 24:1, from 0.1:1 to 23:1, from 0.1:1 to 22:1, from 0.1:1 to 21:1, from 0.1:1 to 20:1, from 0.1:1 to 19:1, from 0.1:1 to 18:1, from 0.1:1 to 17:1, from 0.1:1 to 16:1, from 0.1:1 to 15:1, from 0.1:1 to 14.9:1, from 0.1:1 to 14.8:1, from 0.1:1 to 14.7:1, from 0.1:1 to 14.6:1, from 0.1:1 to 14.5:1, from 0.1:1 to 14.4:1, from 0.1:1 to 14.3:1, from 0.1:1 to 14.2:1, from 0.1:1 to 14.1:1, from 0.1:1 to 14:1, from 0.1:1 to 13.9:1, from 0.1:1 to 13.8:1, from 0.1:1 to 13.7:1, from 0.1:1 to 13.6:1, from 0.1:1 to 13.5:1, from 0.1:1 to 13.4:1, from 0.1:1 to 13.3:1, from 0.1:1 to 13.2:1, from 0.1:1 to 13.1:1, from 0.1:1 to 13:1, from 0.1:1 to 12.9:1, from 0.1:1 to 12.8:1, from 0.1:1 to 12.7:1, from 0.1:1 to 12.6:1, from 0.1:1 to 12.5:1, from 0.1:1 to 12.4:1, from 0.1:1 to 12.3:1, from 0.1:1 to 12.2:1, from 0.1:1 to 12.1:1, from 0.1:1 to 12:1, from 0.1:1 to 11.9:1, from 0.1:1 to 11.8:1, from 0.1:1 to 11.7:1, from 0.1:1 to 11.6:1, from 0.1:1 to 11.5:1, from 0.1:1 to 11.4:1, from 0.1:1 to 11.3:1, from 0.1:1 to 11.2:1, from 0.1:1 to 11.1:1, from 0.1:1 to 11:1, from 0.1:1 to 10.9:1, from 0.1:1 to 10.8:1, from 0.1:1 to 10.7:1, from 0.1:1 to 10.6:1, from 0.1:1 to 10.5:1, from 0.1:1 to 10.4:1, from 0.1:1 to 10.3:1, from 0.1:1 to 10.2:1, from 0.1:1 to 10.1:1, from 0.1:1 to 10:1, from 0.1:1 to 9.9:1, from 0.1:1 to 9.8:1, from 0.1:1 to 9.7:1, from 0.1:1 to 9.6:1, from 0.1:1 to 9.5:1, from 0.1:1 to 9.4:1, from 0.1:1 to 9.3:1, from 0.1:1 to 9.2:1, from 0.1:1 to 9.1:1, from 0.1:1 to 9:1, from 0.1:1 to 8.9:1, from 0.1:1 to 8.8:1, from 0.1:1 to 8.7:1, from 0.1:1 to 8.6:1, from 0.1:1 to 8.5:1, from 0.1:1 to 8.4:1, from 0.1:1 to 8.3:1, from 0.1:1 to 8.2:1, from 0.1:1 to 8.1:1, from 0.1:1 to 8:1, from 0.1:1 to 7.9:1, from 0.1:1 to 7.8:1, from 0.1:1 to 7.7:1, from 0.1:1 to 7.6:1, from 0.1:1 to 7.5:1, from 0.1:1 to 7.4:1, from 0.1:1 to 7.3:1, from 0.1:1 to 7.2:1, from 0.1:1 to 7.1:1, from 0.1:1 to 7:1, from 0.1:1 to 6.9:1, from 0.1:1 to 6.8:1, from 0.1:1 to 6.7:1, from 0.1:1 to 6.6:1, from 0.1:1 to 6.5:1, from 0.1:1 to 6.4:1, from 0.1:1 to 6.3:1, from 0.1:1 to 6.2:1, from 0.1:1 to 6.1:1, from 0.1:1 to 6:1, from 0.1:1 to 5.9:1, from 0.1:1 to 5.8:1, from 0.1:1 to 5.7:1, from 0.1:1 to 5.6:1, from 0.1:1 to 5.5:1, from 0.1:1 to 5.4:1, from 0.1:1 to 5.3:1, from 0.1:1 to 5.2:1, from 0.1:1 to 5.1:1, from 0.1:1 to 5:1, from 0.1:1 to 4.9:1, from 0.1:1 to 4.8:1, from 0.1:1 to 4.7:1, from 0.1:1 to 4.6:1, from 0.1:1 to 4.5:1, from 0.1:1 to 4.4:1, from 0.1:1 to 4.3:1, from 0.1:1 to 4.2:1, from 0.1:1 to 4.1:1, from 0.1:1 to 4:1, from 0.1:1 to 3.9:1, from 0.1:1 to 3.8:1, from 0.1:1 to 3.7:1, from 0.1:1 to 3.6:1, from 0.1:1 to 3.5:1, from 0.1:1 to 3.4:1, from 0.1:1 to 3.3:1, from 0.1:1 to 3.2:1 from 0.1:1 to 3.1:1, from 0.1:1 to 3:1, from 0.1:1 to 2.9:1, from 0.1:1 to 2.8:1, from 0.1:1 to 2.7:1, from 0.1:1 to 2.6:1, from 0.1:1 to 2.5:1, from 0.1:1 to 2.4:1, from 0.1:1 to 2.3:1, from 0.1:1 to 2.2:1, from 0.1:1 to 2.1:1, from 0.1:1 to 2:1, from 0.1:1 to 1.9:1, from 0.1:1 to 1.8:1, from 0.1:1 to 1.7:1, from 0.1:1 to 1.6:1, from 0.1:1 to 1.5:1, from 0.1:1 to 1.4:1, from 0.1:1 to 1.3:1, from 0.1:1 to 1.2:1, from 0.1:1 to 1.1:1, from 0.1:1 to 1:1, from 0.2:1 to 50:1, from 0.3:1 to 50:1, from 0.4:1 to 50:1, from 0.5:1 to 50:1, from 0.6:1 to 50:1, from 0.7:1 to 50:1, from 0.8:1 to 50:1, from 0.9:1 to 50:1, from 1:1 to 50:1, from 1.1:1 to 50:1, from 1.2:1 to 50:1, from 1.3:1 to 50:1, from 1.4:1 to 50:1, from 1.5:1 to 50:1, from 1.6:1 to 50:1, from 1.7:1 to 50:1, from 1.8:1 to 50:1, from 1.9:1 to 50:1, from 2:1 to 50:1, from 2.1:1 to 50:1, from 2.2:1 to 50:1, from 2.3:1 to 50:1, from 2.4:1 to 50:1, from 2.5:1 to 50:1, from 2.6:1 to 50:1, from 2.7:1 to 50:1, from 2.8:1 to 50:1, from 2.9:1 to 50:1, from 3:1 to 50:1, from 3.1:1 to 50:1, from 3.2:1 to 50:1, from 3.3:1 to 50:1, from 3.4:1 to 50:1, from 3.5:1 to 50:1, from 3.6:1 to 50:1, from 3.7:1 to 50:1, from 3.8:1 to 50:1, from 3.9:1 to 50:1, from 4:1 to 50:1, from 4.1:1 to 50:1 from 4.2:1 to 50:1, from 4.3:1 to 50:1, from 4.4:1 to 50:1, from 4.5:1 to 50:1, from 4.6:1 to 50:1, from 4.7:1 to 50:1, from 4.8:1 to 50:1, from 4.9:1 to 50:1, from 5:1 to 50:1, from 5.1:1 to 50:1, from 5.2:1 to 50:1, from 5.3:1 to 50:1, from 5.4:1 to 50:1, from 5.5:1 to 50:1, from 5.6:1 to 50:1, from 5.7:1 to 50:1, from 5.8:1 to 50:1, from 5.9:1 to 50:1, from 6:1 to 50:1, from 6.1:1 to 50:1, from 6.2:1 to 50:1, from 6.3:1 to 50:1, from 6.4:1 to 50:1, from 6.5:1 to 50:1, from 6.6:1 to 50:1, from 6.7:1 to 50:1, from 6.8:1 to 50:1, from 6.9:1 to 50:1, from 7:1 to 50:1, from 7.1:1 to 50:1, from 7.2:1 to 50:1, from 7.3:1 to 50:1, from 7.4:1 to 50:1, from 7.5:1 to 50:1, from 7.6:1 to 50:1, from 7.7:1 to 50:1, from 7.8:1 to 50:1, from 7.9:1 to 50:1, from 8:1 to 50:1, from 8.1:1 to 50:1, from 8.2:1 to 50:1, from 8.3:1 to 50:1, from 8.4:1 to 50:1, from 8.5:1 to 50:1, from 8.6:1 to 50:1, from 8.7:1 to 50:1, from 8.8:1 to 50:1, from 8.9:1 to 50:1, from 9:1 to 50:1, from 9.1:1 to 50:1, from 9.2:1 to 50:1, from 9.3:1 to 50:1, from 9.4:1 to 50:1, from 9.5:1 to 50:1, from 9.6:1 to 50:1, from 9.7:1 to 50:1, from 9.8:1 to 50:1, from 9.9:1 to 50:1, from 10:1 to 50:1, from 10.1:1 to 50:1, from 10.2:1 to 50:1, from 10.3:1 to 50:1, from 10.4:1 to 50:1, from 10.5:1 to 50:1, from 10.6:1 to 50:1, from 10.7:1 to 50:1, from 10.8:1 to 50:1, from 10.9:1 to 50:1, from 11:1 to 50:1, from 11.1:1 to 50:1, from 11.2:1 to 50:1, from 11.3:1 to 50:1, from 11.4:1 to 50:1, from 11.5:1 to 50:1, from 11.6:1 to 50:1, from 11.7:1 to 50:1, from 11.8:1 to 50:1, from 11.9:1 to 50:1, from 12:1 to 50:1, from 12.1:1 to 50:1, from 12.2:1 to 50:1, from 12.3:1 to 50:1, from 12.4:1 to 50:1, from 12.5:1 to 50:1, from 12.6:1 to 50:1, from 12.7:1 to 50:1, from 12.8:1 to 50:1, from 12.9:1 to 50:1, from 13:1 to 50:1, from 13.1:1 to 50:1, from 13.2:1 to 50:1, from 13.3:1 to 50:1, from 13.4:1 to 50:1, from 13.5:1 to 50:1, from 13.6:1 to 50:1, from 13.7:1 to 50:1, from 13.8:1 to 50:1, from 13.9:1 to 50:1, from 14:1 to 50:1, from 14.1:1 to 50:1, from 14.2:1 to 50:1, from 14.3:1 to 50:1, from 14.4:1 to 50:1, from 14.5:1 to 50:1, from 14.6:1 to 50:1, from 14.7:1 to 50:1, from 14.8:1 to 50:1, from 14.9:1 to 50:1, from 15:1 to 50:1, from 16:1 to 50:1, from 17:1 to 50:1, from 18:1 to 50:1, from 19:1 to 50:1, from 20:1 to 50:1, from 21:1 to 50:1, from 22:1 to 50:1, from 23:1 to 50:1, from 24:1 to 50:1, from 25:1 to 50:1, from 26:1 to 50:1, from 27:1 to 50:1, from 28:1 to 50:1, from 29:1 to 50:1, from 30:1 to 50:1, from 31:1 to 50:1, from 32:1 to 50:1, from 33:1 to 50:1, from 34:1 to 50:1, from 35:1 to 50:1, from 36:1 to 50:1, from 37:1 to 50:1, from 38:1 to 50:1, from 39:1 to 50:1, from 40:1 to 50:1, from 41:1 to 50:1, from 42:1 to 50:1, from 43:1 to 50:1, from 44:1 to 50:1, from 45:1 to 50:1, from 46:1 to 50:1, from 47:1 to 50:1, from 48:1 to 50:1, from 49:1 to 50:1; or any range formed from any two of the foregoing ratios, including any subratios therebetween. The foregoing ratios generally refer to the moles of copper-assisting additive relative to moles of copper(I) salt, but such ratios may also be used to express moles of copper-assisting additive relative to moles of copper (calculated on an atomic basis).

Upon combination of the copper(I) salt and the copper-assisting additive with a carrier, as described herein, the composition (for example, biocidal composition) or resulting material may be formed into a desired article or be applied to a surface. Where the composition includes or is, for example, a polyurethane, a polyurethane precursor, an epoxy resin, an epoxy resin precursor, a melamine resin, or the like, such a composition may be applied to a surface as a layer. Examples of surfaces to which the biocidal composition may be applied include wood, polymer, metal, glass, ceramic, stone, concrete, cement, mineral, drywall, asphalt, or any combination thereof. Examples of articles that may be formed using the compositions described herein include housings or cases for electronic devices (for example, mobile phones, smart phones, tablets, video players, information terminal devices, laptop computers), architectural structures (for examples, countertops, walls, trim, ceilings, floors, exterior facades, and trim), appliances 9 for example, cooktops, refrigerator doors, and dishwasher doors), information displays (for example, whiteboards), automotive components (for example, dashboard panels, windshields, window components), and high touch surfaces (for example, a computer mouse, a computer keyboard, a railing, a door, a doorknob, a door push plate, a phone, a phone button, or an elevator button). Articles may be formed by any method known in the art, such as by molding (for example, injection molding), or otherwise forming the article into a desired shape. In certain examples, an entire article may include the biocidal composition (for example, an entire article is formed from the biocidal composition). In certain examples, disclosed is a method of forming an article, the method including providing a masterbatch of the biocidal composition, and then forming the article therefrom by any known technique, such as by extrusion or molding (for example, injection molding). In certain examples, disclosed is a method of preparing a masterbatch, including mixing a concentrated form of the biocidal composition.

The compositions described herein may include pigments to impart color. Accordingly, the coatings or layers made from such compositions may exhibit a wide variety of colors, depending on the carrier color, mixtures of carriers, and amount of particle loading. Moreover, it is contemplated that the compositions and/or coatings described herein will show no adverse effect to paint adhesion as measured by ASTM D4541. In certain examples, the adhesion of the composition or coating to an underlying substrate is greater than the cohesive strength of the substrate. In other words, in testing, the adhesion between the coating and the substrate is so strong that the underlying substrate failed before the coating was separated from the surface of the substrate.

In some aspects, the biocidal composition may be in the form of an article, a layer, a coating, a dry film, or as a liquid composition including suspensions and solutions, which may be applied on a surface or stored in a container (for example, prior to use). In some aspects, the biocidal composition is not in the form of a molded article, e.g., an injection molded article, or an extruded article.

One or more examples of the biocidal compositions of the present disclosure may include the copper(I) salt (which may optionally be pre-treated with a pretreatment solution), a copper-assisting additive, and a carrier with a loading level of the copper(I) salt such that the composition may exhibit resistance or preservation against the presence or growth of foulants (for example, microbes). Foulants include fungi, bacteria, viruses, mold, mildew, algae, and combinations thereof. In certain examples, the presence of foulants in materials, such as polyurethanes, epoxy resins, and the like may cause color changes to the composition, may degrade the integrity of the composition, and may negatively affect various properties of the composition. By including a minimum loading of copper(I) salt (for example, 5 weight % or less, 4 weight % or less, 3 weight % or less, 2 weight % or less, or 1 weight % or less; alternatively, or additionally, in an amount of 0 weight % or more, for example, greater than 0 weight %, 0.01 weight % or more, 0.05 weight % or more, 0.1 weight % or more, 0.5 weight % or more, 1 weight % or more, 2 weight % or more, 3 weight % or more, or 4 weight % or more, based on weight of the carrier or composition) and copper-assisting additive in the carrier, the foulants may be eliminated or reduced. In certain examples, the compositions may or may not include certain components, when fouling is eliminated or reduced. Therefore, the formulations used in one or more examples of the compositions described herein may have more flexibility and variations than previously possible, when used in known compositions that do not include the copper(I) salt.

In an example, a biocidal composition may exhibit one or more of the following effects: (1) a greater than 3 logarithmic reduction in a concentration of a microbe selected from the group consisting of Staphylococcus aureus, Enterobacter aerogenes, Pseudomonas aeruginosa, Methicillin Resistant Staphylococcus aureus, E. coli, SARS-Cov-2, and mixtures thereof; (2) a change in color in the biocidal composition is minimized relative to a change in color of a mixture of the carrier and the copper(I) salt in the absence of the copper-assisting additive or the carrier and the copper-assisting additive absent the copper(I) salt; or (3) any combination thereof. Antimicrobial efficacy may be measured as described elsewhere herein, such as by using the EPA Test.

In an example, a biocidal composition including a carrier, a copper(I) salt, and a copper-assisting additive has better antimicrobial efficacy over time (for example, for 7 days or at least 7 days, or any other time period disclosed herein, such as 30 days or at least 30 days, or 90 days or at least 90 days) compared to an otherwise identical composition that does not include the copper-assisting additive or does not include the copper(I) salt (for example, in the amounts specified, such as copper in an amount of 0.01 at. % to 10 at. % or 0.01 at. % to 2 at. %; copper(I) salt in the composition in an amount of 0.01 wt. % to 15 wt. %; and/or a molar ratio of the amount of the copper-assisting additive to the amount of copper is from 0.1:1 to 50:1). Similarly, in certain examples, such a biocidal composition also has minimized color change (for example, color drift and/or color shift) compared to an otherwise identical composition, as disclosed elsewhere herein.

In an example, when the biocidal composition is formed into a coating (for example, a dry film) within one day of preparing the biocidal composition and the coating is stored at ambient conditions for 7 days or at least 7 days (for example, 10 days or at least 10 days, 15 days or at least 15 days, 20 days or at least 20 days, 25 days or at least 25 days, 30 days or at least 30 days, 40 days or at least 40 days, 50 days or at least 50 days, 60 days or at least 60 days, 75 days or at least 75 days, 90 days or at least 90 days, 100 days or at least 100 days, 120 days or at least 120 days, 150 days or at least 150 days, 180 days or at least 180 days, 365 days or at least 365 days, 2 years or at least 2 years, 3 years or at least 3 years, 4 years or at least 4 years, 5 years or at least 5 years, or 6 years or at least 6 years; alternatively, or additionally, less than 6 years, less than 5 years, less than 4 years, less than 3 years, less than 2 years, less than 365 days, less than 180 days, less than 150 days, less than 120 days, less than 100 days, less than 90 days, less than 75 days, less than 60 days, less than 50 days, less than 40 days, less than 30 days, less than 25 days, less than 20 days, less than 15 days, or less than 10 days) to form a stored coating or stored article, the stored coating or article exhibits greater than 1 logarithmic reduction (for example, greater than 2.5 logarithmic reduction, greater than 3 logarithmic reduction, greater than 3.5 logarithmic reduction, greater than 4 logarithmic reduction, greater than 4.5 logarithmic reduction, or greater than 5 logarithmic reduction; alternatively, or additionally, less than 6 logarithmic reduction, less than 5.5 logarithmic reduction, less than 5 logarithmic reduction, less than 4.5 logarithmic reduction, less than 4 logarithmic reduction, less than 3.5 logarithmic reduction, less than 3 logarithmic reduction, less than 2.5 logarithmic reduction, less than 2 logarithmic reduction, or less than 1.5 logarithmic reduction) in the concentration of microbe selected from the group consisting of Staphylococcus aureus, Enterobacter aerogenes, Pseudomonas aeruginosa, Methicillin Resistant Staphylococcus aureus, E. coli, SARS-Cov-2, and mixtures thereof. Generally, and without wishing to be bound by theory, it is believed that the above feature shows the longevity of antimicrobial efficacy of a coating (for example, dry film) or article including the biocidal composition over time. Antimicrobial efficacy can be measured as described elsewhere herein, such as by using the EPA Test.

As used herein, the term “for X days” or “for X years” in which X is a number, means that the longevity of a specified property lasts minimally for X days (or for X years). The longevity of the specified property may last for a longer period of time, and after such longer period of time the specified property (e.g., log reduction or color value) may begin to decrease; however, “for X days” (or “for X years”) is met if the specified property was present at X days (or X years). In this regard, the terms “for X days” and the term “for at least X days” are meant to be synonymous terms.

In an example, when the biocidal composition is stored as a liquid composition, mixture, or suspension at ambient conditions for a period of 7 days or at least 7 days (for example, 10 days or at least 10 days, 15 days or at least 15 days, 20 days or at least 20 days, 25 days or at least 25 days, 30 days or at least 30 days, 40 days or at least 40 days, 50 days or at least 50 days, 60 days or at least 60 days, 75 days or at least 75 days, 90 days or at least 90 days, 100 days or at least 100 days, 120 days or at least 120 days, 150 days or at least 150 days, 180 days or at least 180 days, 365 days or at least 365 days (1 year), 2 years or at least 2 years, 3 years or at least 3 years, 4 years or at least 4 years, 5 years or at least 5 years, or 6 years or at least 6 years; alternatively, or additionally, less than 6 years, less than 5 years, less than 4 years, less than 3 years, less than 2 years, less than 365 days, less than 180 days, less than 150 days, less than 120 days, less than 100 days, less than 90 days, less than 75 days, less than 60 days, less than 50 days, less than 40 days, less than 30 days, less than 25 days, less than 20 days, less than 15 days, or less than 10 days) to form a stored liquid composition, mixture, or suspension within one day exhibits greater than 1 logarithmic reduction (for example, greater than 2.5 logarithmic reduction, greater than 3 logarithmic reduction, greater than 3.5 logarithmic reduction, greater than 4 logarithmic reduction, greater than 4.5 logarithmic reduction, or greater than 5 logarithmic reduction; alternatively, or additionally, less than 6 logarithmic reduction, less than 5.5 logarithmic reduction, less than 5 logarithmic reduction, less than 4.5 logarithmic reduction, less than 4 logarithmic reduction, less than 3.5 logarithmic reduction, less than 3 logarithmic reduction, less than 2.5 logarithmic reduction, less than 2 logarithmic reduction, or less than 1.5 logarithmic reduction) in the concentration of microbe selected from the group consisting of Staphylococcus aureus, Enterobacter aerogenes, Pseudomonas aeruginosa, Methicillin Resistant Staphylococcus aureus, E. coli, SARS-Cov-2, and mixtures thereof. Generally, and without wishing to be bound by theory, it is believed that the above feature shows the antimicrobial efficacy of a coating (for example, dry film) or article after the biocidal composition has been stored in liquid form (for example, a can of polyurethane precursor or epoxy resin precursor) for a certain period of time. Antimicrobial efficacy may be measured as described elsewhere herein, such as by using the EPA Test.

In an example, minimizing a change in color corresponds to a CIE ΔE-value of the biocidal composition being less than 10, or less than 9, or less than 8, or less than 7, or less than 6, or less than 5, or less than 4, or less than 3, or less than 2, as measured according to formula (VI):

$$Δ E *= \sqrt{( {( L * - {L}_{control}^{*} )}^{2} + {( a * - {a}_{control}^{*} )}^{2} + {( b * - {b}_{control}^{*} )}^{2} )} \qquad ( VI )$$

wherein L″, a, and b* are the CIE L″, a*, and b* values of the biocidal compositions and the

$${L}_{control}^{*} , {a}_{control}^{*} ,$$

and

$${b}_{control}^{*}$$

are the CIE L*, a*, and b* values of an otherwise identical composition without either the copper(I) salt or the copper-assisting additive.

In an example, a biocidal composition or a film prepared from the biocidal composition may exhibit (1) a transmittance as measured at each wavelength from 400 to 700 nm, and/or (2) an average transmittance as measured over the wavelength range of from 400 to 700 nm, of at least 50%, or at least 51%, or at least 52%, or at least 53%, or at least 54%, or at least 55%, or at least 56%, or at least 57%, or at least 58%, or at least 59%, or at least 60%, or at least 61%, or at least 62%, or at least 63%, or at least 64%, or at least 65%, or at least 66%, or at least 67%, or at least 68%, or at least 69%, or at least 70%, or at least 71%, or at least 72%, or at least 73%, or at least 74%, or at least 75%, or at least 76%, or at least 77%, or at least 78%, or at least 79%, or at least 80%, or at least 81%, or at least 82%, or at least 83%, or at least 84%, or at least 85%, or at least 86%, or at least 87%, or at least 88%, or at least 89%, or at least 90%, or at least 90.5%, or at least 91.0%, or at least 91.5%, or at least 92.0%, or at least 92.5%, or at least 93.0%, or at least 93.5%, or at least 94.0%, or at least 94.5%, or at least 95.0%, or at least 95.1%, or at least 95.2%, or at least 95.3%, or at least 95.4%, or at least 95.5%, or at least 95.6%, or at least 95.7%, or at least 95.8%, or at least 95.9%, or at least 96.0%, or at least 96.1%, or at least 96.2%, or at least 96.3%, or at least 96.4%, or at least 96.5%, or at least 96.6%, or at least 96.7%, or at least 96.8%, or at least 96.9%, or at least 97.0%, or at least 97.1%, or at least 97.2%, or at least 97.3%, or at least 97.4%, or at least 97.5%, or at least 97.6%, or at least 97.7%, or at least 97.8%, or at least 97.9%, or at least 98.0%, or at least 98.1%, or at least 98.2%, or at least 98.3%, or at least 98.4%, or at least 98.5%, or at least 98.6%, or at least 98.7%, or at least 98.8%, or at least 98.9%, or at least 99.0%, or at least 99.1%, or at least 99.2%, or at least 99.3%, or at least 99.4%, or at least 99.5%, or at least 99.6%, or at least 99.7%, or at least 99.8%, or at least 99.9%, or at least >99.9%; when measured at a thickness of 40 μm. Average transmittance is calculated by summing the transmittance at each wavelength between 400 and 700 nm and dividing by the total number of such wavelengths.

In an example, a biocidal composition, or a film thereof, may exhibit a transmittance as measured at each wavelength from 400 to 700 nanometers that is within 20 percentage points of a second transmittance of an otherwise identical composition or film thereof without either the copper(I) salt or the copper-assisting additive when measured at a thickness of 40 μm; including, for example, within 19.5 percentage points, or within 19.0 percentage points, or within 18.5 percentage points, or within 18.0 percentage points, or within 17.5 percentage points, or within 17.0 percentage points, or within 16.5 percentage points, or within 16.0 percentage points, or within 15.5 percentage points, or within 15.0 percentage points, or within 14.5 percentage points, or within 14.0 percentage points, or within 13.5 percentage points, or within 13.0 percentage points, or within 12.5 percentage points, or within 12.0 percentage points, or within 11.5 percentage points, or within 11.0 percentage points, or within 10.5 percentage points, or within 10.0 percentage points, or within 9.9 percentage points, or within 9.8 percentage points, or within 9.7 percentage points, or within 9.6 percentage points, or within 9.5 percentage points, or within 9.4 percentage points, or within 9.3 percentage points, or within 9.2 percentage points, or within 9.1 percentage points, or within 9.0 percentage points, or within 8.9 percentage points, or within 8.8 percentage points, or within 8.7 percentage points, or within 8.6 percentage points, or within 8.5 percentage points, or within 8.4 percentage points, or within 8.3 percentage points, or within 8.2 percentage points, or within 8.1 percentage points, or within 8.0 percentage points, or within 7.9 percentage points, or within 7.8 percentage points, or within 7.7 percentage points, or within 7.6 percentage points, or within 7.5 percentage points, or within 7.4 percentage points, or within 7.3 percentage points, or within 7.2 percentage points, or within 7.1 percentage points, or within 7.0 percentage points, or within 6.9 percentage points, or within 6.8 percentage points, or within 6.7 percentage points, or within 6.6 percentage points, or within 6.5 percentage points, or within 6.4 percentage points, or within 6.3 percentage points, or within 6.2 percentage points, or within 6.1 percentage points, or within 6.0 percentage points, or within 5.9 percentage points, or within 5.8 percentage points, or within 5.7 percentage points, or within 5.6 percentage points, or within 5.5 percentage points, or within 5.4 percentage points, or within 5.3 percentage points, or within 5.2 percentage points, or within 5.1 percentage points, or within 5.0 percentage points, or within 4.9 percentage points, or within 4.8 percentage points, or within 4.7 percentage points, or within 4.6 percentage points, or within 4.5 percentage points, or within 4.4 percentage points, or within 4.3 percentage points, or within 4.2 percentage points, or within 4.1 percentage points, or within 4.0 percentage points, or within 3.9 percentage points, or within 3.8 percentage points, or within 3.7 percentage points, or within 3.6 percentage points, or within 3.5 percentage points, or within 3.4 percentage points, or within 3.3 percentage points, or within 3.2 percentage points, or within 3.1 percentage points, or within 3.0 percentage points, or within 2.9 percentage points, or within 2.8 percentage points, or within 2.7 percentage points, or within 2.6 percentage points, or within 2.5 percentage points, or within 2.4 percentage points, or within 2.3 percentage points, or within 2.2 percentage points, or within 2.1 percentage points, or within 2.0 percentage points, or within 1.9 percentage points, or within 1.8 percentage points, or within 1.7 percentage points, or within 1.6 percentage points, or within 1.5 percentage points, or within 1.4 percentage points, or within 1.3 percentage points, or within 1.2 percentage points, or within 1.1 percentage points, or within 1.0 percentage points, or within 0.9 percentage points, or within 0.8 percentage points, or within 0.7 percentage points, or within 0.6 percentage points, or within 0.5 percentage points, or within 0.4 percentage points, or within 0.3 percentage points, or within 0.2 percentage points, or within 0.1 percentage points.

In an example, a film of a biocidal composition may have a thickness of from 30 μm to 3000 μm, including, for example, from 40 μm, or from 50 μm, or from 60 μm, or from 70 μm, or from 80 μm, or from 90 μm, or from 100 μm, or from 110 μm, or from 120 μm, or from 130 μm, or from 140 μm, or from 150 μm, or from 160 μm, or from 170 μm, or from 180 μm, or from 190 μm, or from 200 μm, or from 210 μm, or from 220 μm, or from 230 μm, or from 240 μm, or from 250 μm, or from 260 μm, or from 270 μm, or from 280 μm, or from 290 μm, or from 300 μm, or from 310 μm, or from 320 μm, or from 330 μm, or from 340 μm, or from 350 μm, or from 360 μm, or from 370 μm, or from 380 μm, or from 390 μm, or from 400 μm, or from 410 μm, or from 420 μm, or from 430 μm, or from 440 μm, or from 450 μm, or from 460 μm, or from 470 μm, or from 480 μm, or from 490 μm, or from 500 μm, or from 510 μm, or from 520 μm, or from 530 μm, or from 540 μm, or from 550 μm, or from 560 μm, or from 570 μm, or from 580 μm, or from 590 μm, or from 600 μm, or from 610 μm, or from 620 μm, or from 630 μm, or from 640 μm, or from 650 μm, or from 660 μm, or from 670 μm, or from 680 μm, or from 690 μm, or from 700 μm, or from 710 μm, or from 720 μm, or from 730 μm, or from 740 μm, or from 750 μm, or from 760 μm, or from 770 μm, or from 780 μm, or from 790 μm, or from 800 μm, or from 810 μm, or from 820 μm, or from 830 μm, or from 840 μm, or from 850 μm, or from 860 μm, or from 870 μm, or from 880 μm, or from 890 μm, or from 900 μm, or from 910 μm, or from 920 μm, or from 930 μm, or from 940 μm, or from 950 μm, or from 960 μm, or from 970 μm, or from 980 μm, or from 990 μm, or from 1000 μm, or from 1050 μm, or from 1100 μm, or from 1150 μm, or from 1200 μm, or from 1250 μm, or from 1300 μm, or from 1350 μm, or from 1400 μm, or from 1450 μm, or from 1500 μm, or from 1550 μm, or from 1600 μm, or from 1650 μm, or from 1700 μm, or from 1750 μm, or from 1800 μm, or from 1850 μm, or from 1900 μm, or from 1950 μm, or from 2000 μm, or from 2050 μm, or from 2100 μm, or from 2150 μm, or from 2200 μm, or from 2250 μm, or from 2300 μm, or from 2350 μm, or from 2400 μm, or from 2450 μm, or from 2500 μm, or from 2550 μm, or from 2600 μm, or from 2650 μm, or from 2700 μm, or from 2750 μm, or from 2800 μm, or from 2850 μm, or from 2900 μm, or from 2950 μm to 3000 μm; or from 30 μm to 40 μm, or to 50 μm, or to 60 μm, or to 70 μm, or to 80 μm, or to 90 μm, or to 100 μm, or to 110 μm, or to 120 μm, or to 130 μm, or to 140 μm, or to 150 μm, or to 160 μm, or to 170 μm, or to 180 μm, or to 190 μm, or to 200 μm, or to 210 μm, or to 220 μm, or to 230 μm, or to 240 μm, or to 250 μm, or to 260 μm, or to 270 μm, or to 280 μm, or to 290 μm, or to 300 μm, or to 310 μm, or to 320 μm, or to 330 μm, or to 340 μm, or to 350 μm, or to 360 μm, or to 370 μm, or to 380 μm, or to 390 μm, or to 400 μm, or to 410 μm, or to 420 μm, or to 430 μm, or to 440 μm, or to 450 μm, or to 460 μm, or to 470 μm, or to 480 μm, or to 490 μm, or to 500 μm, or to 510 μm, or to 520 μm, or to 530 μm, or to 540 μm, or to 550 μm, or to 560 μm, or to 570 μm, or to 580 μm, or to 590 μm, or to 600 μm, or to 610 μm, or to 620 μm, or to 630 μm, or to 640 μm, or to 650 μm, or to 660 μm, or to 670 μm, or to 680 μm, or to 690 μm, or to 700 μm, or to 710 μm, or to 720 μm, or to 730 μm, or to 740 μm, or to 750 μm, or to 760 μm, or to 770 μm, or to 780 μm, or to 790 μm, or to 800 μm, or to 810 μm, or to 820 μm, or to 830 μm, or to 840 μm, or to 850 μm, or to 860 μm, or to 870 μm, or to 880 μm, or to 890 μm, or to 900 μm, or to 910 μm, or to 920 μm, or to 930 μm, or to 940 μm, or to 950 μm, or to 960 μm, or to 970 μm, or to 980 μm, or to 990 μm, or to 1000 μm, or to 1050 μm, or to 1100 μm, or to 1150 μm, or to 1200 μm, or to 1250 μm, or to 1300 μm, or to 1350 μm, or to 1400 μm, or to 1450 μm, or to 1500 μm, or to 1550 μm, or to 1600 μm, or to 1650 μm, or to 1700 μm, or to 1750 μm, or to 1800 μm, or to 1850 μm, or to 1900 μm, or to 1950 μm, or to 2000 μm, or to 2050 μm, or to 2100 μm, or to 2150 μm, or to 2200 μm, or to 2250 μm, or to 2300 μm, or to 2350 μm, or to 2400 μm, or to 2450 μm, or to 2500 μm, or to 2550 μm, or to 2600 μm, or to 2650 μm, or to 2700 μm, or to 2750 μm, or to 2800 μm, or to 2850 μm, or to 2900 μm, or to 2950 μm, or a range formed from any two of the foregoing thicknesses; including any subranges therebetween.

In an example, disclosed is a method of preparing a biocidal composition, the method including adding a biocidal additive formulation to a carrier. When the carrier is a polyurethane or an epoxy resin, the biocidal additive formulation may include the copper(I) salt and the copper-assisting additive. When the carrier is a second polyurethane precursor, the biocidal additive formulation may include a first polyurethane precursor, the copper(I) salt, and the copper-assisting additive. When the carrier is a second epoxy resin precursor, the biocidal additive formulation may include a first epoxy resin precursor, the copper(I) salt, and the copper-assisting additive.

In an example, disclosed is a method including applying a biocidal composition to a surface. The biocidal composition may include any of the components described elsewhere herein. In an example, the surface is or includes wood polymer (for example, plastic or rubber), metal (for example, steel, iron, copper, gold, silver, aluminum, tin, platinum, alloys thereof, or any combination thereof), glass (for example, lithium aluminosilicate, borosilicate, chemical strengthened, or ion-exchanged), ceramic, glass-ceramic, stone, concrete, cement, mineral, drywall, asphalt, or any combination thereof. In an example, the method of applying to a surface may be any suitable method, including spraying, spin coating, dipping, and the like, or any combination thereof. For example, the composition may be sprayed on a surface. In some aspects of applying to a surface, such as in a sprayed composition, the copper(I) species (for example, the ion or salt) may be at least partially in a solubilized form (for example, facilitated by complexation with a copper-assisting additive), though such copper(I) species may alternatively or additionally be in a suspension.

In an example, disclosed is a method of improving or sustaining antimicrobial efficacy in a biocidal composition (any biocidal composition disclosed herein), including: combining a carrier, a copper(I) salt, and a copper-assisting additive, wherein the biocidal composition includes copper in an amount of 0.01 at. % to 10 at. %, and the carrier and the copper-assisting additive are different. In certain examples, a molar ratio of the amount of copper-assisting additive to the amount of copper is from 0.1:1 to 50:1. In certain examples, the copper(I) salt is first combined with the copper-assisting additive to form a mixture, and the mixture is then combined with the carrier to form the biocidal composition. In other examples, the color change in the biocidal composition is minimized relative to a change in color of an otherwise identical composition in the absence of the copper-assisting additive, or an otherwise identical composition absent the copper(I) salt, or an otherwise identical composition absent both the copper-assisting additive and the copper(I) salt. In still other examples, a method of minimizing a color change in a biocidal composition is provided, wherein the copper-assisting additive is any compound or formula disclosed herein (for example, a compound of formula (I), (II), or any combination thereof), by itself or themselves, or together with a compound of formula (III), (IV), (V), or any combination thereof. In still other examples, a method of minimizing a color change in a biocidal composition is provided, wherein the copper-assisting additive is any compound disclosed herein, such as trimethyl phosphite, triethyl phosphite, triphenyl phosphite, tris(2,2,2-trifluoroethyl)phosphite, tris(2-ethylhexyl)phosphite, triisopropyl phosphite, tris(1,1,1,3,3,3-hexafluoro-2-propyl)phosphite, tris(hydroxylpropyl)phosphine, tributyl phosphine, or any combination thereof, by itself or themselves, or together with a compound such as 2-ethylhexyl phosphate, bis(2-ethylhexyl)phosphate, tris(2-ethylhexyl)phosphate, methyl phosphate, dimethyl phosphate, trimethyl phosphate, butyl phosphate (for example, n-butyl, sec-butyl, or tert-butyl), dibutyl phosphate (for example, n-butyl, sec-butyl, or tert-butyl), tributyl phosphate (for example, n-butyl, sec-butyl, or tert-butyl), phenyl phosphate, diphenyl phosphate, triphenyl phosphate, benzyl phosphate, dibenzyl phosphate, tribenzyl phosphate, tributyl borate, tributyl citrate, or any combination thereof. In still other examples, a method of minimizing a color change in a biocidal composition is provided, wherein the composition demonstrates a greater than 3 logarithmic reduction in a concentration of a microbe selected from the group consisting of Staphylococcus aureus, Enterobacter aerogenes, Pseudomonas aeruginosa, Methicillin Resistant Staphylococcus aureus, E. coli, SARS-Cov-2, and mixtures thereof. Antimicrobial efficacy may be measured as described elsewhere herein, such as by using the EPA Test. In still other examples, a method of minimizing a color change in a biocidal composition is provided, wherein a CIE ΔE* value of the biocidal material is less than 10, as measured according to formula (VI):

$$Δ E *= \sqrt{( {( L * - {L}_{control}^{*} )}^{2} + {( a * - {a}_{control}^{*} )}^{2} + {( b * - {b}_{control}^{*} )}^{2} )} \qquad ( VI )$$

wherein L*, a*, and b* are the CIE L*, a*, and b* values of the biocidal material and the L*_{control},

$${a}_{control}^{*} ,$$

and

$${b}_{control}^{*}$$

are me CIE L*, a*, and b* values of an otherwise identical composition without either the copper(I) salt or the copper-assisting additive.

In an example, a biocidal composition may exhibit a ΔE of less than 10, or less than 9, or less than 8, or less than 7, or less than 6, or less than 5, or less than 4, or less than 3, or less than 2, as measured according to formula (VI):

$$Δ E *= \sqrt{( {( L * - {L}_{control}^{*} )}^{2} + {( a * - {a}_{control}^{*} )}^{2} + {( b * - {b}_{control}^{*} )}^{2} )} \qquad ( VI )$$

wherein L*, a*, and b* are CIE values of the biocidal composition after preparing and then, within one day of preparing, storing the biocidal composition at ambient temperature and ambient relative humidity for 7 days (for example, 10 days, 15 days, 20 days, 25 days, 30 days, 40 days, 50 days, 60 days, 75 days, 90 days, 100 days, 120 days, 150 days, 180 days, 365 days, 2 years, 3 years, 4 years, or 5 years, and the

$${L}_{control}^{*} , {a}_{control}^{*} ,$$

and

$${b}_{control}^{*}$$

are CIE values of an otherwise identical composition without either the copper(I) salt or the copper-assisting additive.

In an example, the present disclosure provides a biocidal additive formulation that includes a copper(I) salt and a copper-assisting additive. In some aspects, the biocidal additive formulation may be a relatively concentrated formulation to be added to a carrier so as to provide a biocidal composition. In this regard, in some aspects, the biocidal additive formulation may be in the form of a package that may be added to, for example, a polyurethane, a polyurethane precursor, an epoxy resin, an epoxy resin precursor, or a melamine resin by an end user, so as to make the polyurethane, the polyurethane precursor, the epoxy resin, the epoxy resin precursor, or the melamine resin have antimicrobial properties without substantially impacting color and/or transparency. Such a biocidal additive formulation may also be added by a manufacturer during or after production of a bulk quantity of polyurethane precursor or epoxy resin precursor so as to impart, for example, desired antimicrobial properties. Examples of a form of a biocidal additive formulation may include a powder, a slurry, a gel, a liquid, a concentrate, and a solution. In certain examples, the biocidal additive formulation is in liquid form at ambient conditions (1 atm (~101.3 kPa) and 20° C.). In some aspects, the biocidal additive formulation comprises solubilized copper(I) salt in the form of a copper complex, in which the copper(I) salt is coordinated to or otherwise associated with a copper-assisting additive that facilitates the solubility of the copper(I) salt. Without wishing to be bound by theory, it is believed that in some aspects, it is desirable to first prepare a biocidal additive formulation for addition to a composition, rather than simply adding a copper salt to a composition, or rather than simply adding a copper salt and a copper-assisting additive separately to a composition. For example, it is believed that addition of copper salt alone, or addition of copper salt and an additive separately to the same composition (without premixing) may, in some cases, not allow the copper-assisting additive to sufficiently promote the availability and/or persistence of copper(I) ions. For example, separate addition may not allow the copper-assisting additive to find and associate with the copper salt. However, in certain aspects, separate addition of the copper salt and copper-assisting additive may be sufficient, such as, for example, where the additive is present in a sufficiently high concentration and/or the medium of the composition otherwise does not inhibit the ability of the additive and copper salt to come together, such as because of viscosity, diffusion, or some other reason. In certain examples, the biocidal additive formulation may include an antioxidant package. Antioxidant packages may include single components or ternary mixtures. Examples of antioxidant packages may include primary antioxidants; phenolics, such as BHT; secondary antioxidants, such as Ultranox™ 626, Weston™ 430 ZP, thioester-based antioxidants (thiosynergists), such as dioctadecyl 3,3′-thiodipropionate; ascorbate esters, such as ascorbyl palmitate; or any combination thereof. In certain examples, the biocidal additive formulation may include a reducing agent. Examples of reducing agents may include ascorbic acid, hydroxylamine hydrochloride, various phosphines, sulfite compounds, oxalic acid, sodium thiosulfate, or any combination thereof. Examples of a form of a biocidal additive formulation may include a powder, a slurry, a gel, a liquid, a concentrate, and a solution. In certain examples, the biocidal additive formulation may include an antioxidant package. Antioxidant packages may include single components or ternary mixtures. Examples of antioxidant packages may include primary antioxidants; phenolics, such as BHT; secondary antioxidants, such as Ultranox™ 626, Weston™ 430 ZP, thioester-based antioxidants (thiosynergists), such as dioctadecyl 3,3′-thiodipropionate; ascorbate esters, such as ascorbyl palmitate; or any combination thereof. In certain examples, the biocidal additive formulation may include a reducing agent. Examples of reducing agents may include ascorbic acid, hydroxylamine hydrochloride, various phosphines, sulfite compounds, oxalic acid, sodium thiosulfate, or any combination thereof. In certain examples, the biocidal additive formulation may be in a sealed container including an inert atmosphere.

In an example, the biocidal additive formulation has a molarity of the copper(I) salt dissolved in the biocidal additive formulation of from 20 mM to 200 mM, including, for example, from 25 mM, or from 30 mM, or from 35 mM, or from 40 mM, or from 45 mM, or from 50 mM, or from 55 mM, or from 60 mM, or from 65 mM, or from 70 mM, or from 75 mM, or from 80 mM, or from 85 mM, or from 90 mM, or from 95 mM, or from 100 mM, or from 105 mM, or from 110 mM, or from 115 mM, or from 120 mM, or from 125 mM, or from 130 mM, or from 135 mM, or from 140 mM, or from 145 mM, or from 150 mM, or from 155 mM, or from 160 mM, or from 165 mM, or form 170 mM, or from 175 mM, or from 180 mM, or from 185 mM, or from 190 mM, or from 195 mM to 200 mM; or from 20 mM to 25 mM, or to 30 mM, or to 35 mM, or to 40 mM, or to 45 mM, or to 50 mM, or to 55 mM, or to 60 mM, or to 65 mM, or to 70 mM, or to 75 mM, or to 80 mM, or to 85 mM, or to 90 mM, or to 95 mM, or to 100 mM, or to 105 mM, or to 110 mM, or to 115 mM, or to 120 mM, or to 125 mM, or to 130 mM, or to 135 mM, or to 140 mM, or to 145 mM, or to 150 mM, or to 155 mM, or to 160 mM, or to 165 mM, or to 170 mM, or to 175 mM, or to 180 mM, or to 185 mM, or to 190 mM, or to 195 mM; or a range formed from any two of the foregoing molarities; including any subranges therebetween.

In certain examples, the biocidal additive formulation may include a copper-assisting additive at a molarity of the copper-assisting additive in the biocidal additive formulation of from 0.06 mM to 0.6 mM; including, for example, from 0.065 mM, or from 0.07 mM, or from 0.075 mM, or from 0.08 mM, or from 0.085 mM, or from 0.09 mM, or from 0.095 mM, or from 0.1 mM, or from 0.105 mM, or from 0.110 mM, or from 0.115 mM, or from 0.120 mM, or from 0.125 mM, or from 0.130 mM, or from 0.135 mM, or from 0.140 mM, or from 0.145 mM, or from 0.150 mM, or from 0.155 mM, or from 0.160 mM, or from 0.165 mM, or from 0.170 mM, or from 0.175 mM, or from 0.180 mM, or from 0.185 mM, or from 0.190 mM, or from 0.195 mM, or from 0.200 mM, or from 0.205 mM, or from 0.210 mM, or from 0.215 mM, or from 0.220 mM, or from 0.225 mM, or from 0.230 mM, or from 0.235 mM, or from 0.240 mM, or from 0.245 mM, or from 0.250 mM, or from 0.255 mM, or from 0.260 mM, or from 0.265 mM, or from 0.270 mM, or from 0.275 mM, or from 0.280 mM, or from 0.285 mM, or from 0.290 mM, or from 0.295 mM, or from 0.300 mM, or from 0.305 mM, or from 0.310 mM, or from 0.315 mM, or from 0.320 mM, or from 0.325 mM, or from 0.330 mM, or from 0.335 mM, or from 0.340 mM, or from 0.345 mM, or from 0.350 mM, or from 0.355 mM, or from 0.360 mM, or from 0.365 mM, or from 0.370 mM, or from 0.375 mM, or from 0.380 mM, or from 0.385 mM, or from 0.390 mM, or from 0.395 mM, or from 0.400 mM, or from 0.405 mM, or from 0.410 mM, or from 0.415 mM, or from 0.420 mM, or from 0.425 mM, or from 0.430 mM, or from 0.435 mM, or from 0.440 mM, or from 0.445 mM, or from 0.450 mM, or from 0.455 mM, or from 0.460 mM, or from 0.465 mM, or from 0.470 mM, or from 0.475 mM, or from 0.480 mM, or from 0.485 mM, or from 0.490 mM, or from 0.495 mM, or from 0.500 mM, or from 0.505 mM, or from 0.510 mM, or from 0.515 mM, or from 0.520 mM, or from 0.525 mM, or from 0.530 mM, or from 0.535 mM, or from 0.540 mM, or from 0.545 mM, or from 0.550 mM, or from 0.555 mM, or from 0.560 mM, or from 0.565 mM, or from 0.570 mM, or from 0.575 mM, or from 0.580 mM, or from 0.585 mM, or from 0.590 mM, or from 0.595 mM to 0.600 mM; or from 0.06 mM to 0.065 mM, or to 0.07 mM, or to 0.075 mM, or to 0.08 mM, or to 0.085 mM, or to 0.09 mM, or to 0.095 mM, or to 0.100 mM, or to 0.105 mM, or to 0.110 mM, or to 0.115 mM, or to 0.120 mM, or to 0.125 mM, or to 0.130 mM, or to 0.135 mM, or to 0.140 mM, or to 0.145 mM, or to 0.150 mM, or to 0.155 mM, or to 0.160 mM, or to 0.165 mM, or to 0.170 mM, or to 0.175 mM, or to 0.180 mM, or to 0.185 mM, or to 0.190 mM, or to 0.195 mM, or to 0.200 mM, or to 0.205 mM, or to 0.210 mM, or to 0.215 mM, or to 0.220 mM, or to 0.225 mM, or to 0.230 mM, or to 0.235 mM, or to 0.240 mM, or to 0.245 mM, or to 0.250 mM, or to 0.255 mM, or to 0.260 mM, or to 0.265 mM, or to 0.270 mM, or to 0.275 mM, or to 0.280 mM, or to 0.285 mM, or to 0.290 mM, or to 0.295 mM, or to 0.300 mM, or to 0.305 mM, or to 0.310 mM, or to 0.315 mM, or to 0.320 mM, or to 0.325 mM, or to 0.330 mM, or to 0.335 mM, or to 0.340 mM, or to 0.345 mM, or to 0.350 mM, or to 0.355 mM, or to 0.360 mM, or to 0.365 mM, or to 0.370 mM, or to 0.375 mM, or to 0.380 mM, or to 0.385 mM, or to 0.390 mM, or to 0.395 mM, or to 0.400 mM, or to 0.405 mM, or to 0.410 mM, or to 0.415 mM, or to 0.420 mM, or to 0.425 mM, or to 0.430 mM, or to 0.435 mM, or to 0.440 mM, or to 0.445 mM, or to 0.450 mM, or to 0.455 mM, or to 0.460 mM, or to 0.465 mM, or to 0.470 mM, or to 0.475 mM, or to 0.480 mM, or to 0.485 mM, or to 0.490 mM, or to 0.495 mM, or to 0.500 mM, or to 0.505 mM, or to 0.510 mM, or to 0.515 mM, or to 0.520 mM, or to 0.525 mM, or to 0.530 mM, or to 0.535 mM, or to 0.540 mM, or to 0.545 mM, or to 0.550 mM, or to 0.555 mM, or to 0.560 mM, or to 0.565 mM, or to 0.570 mM, or to 0.575 mM, or to 0.580 mM, or to 0.585 mM, or to 0.590 mM, or to 0.595 mM; or a range formed from any two of the foregoing molarities; including any subranges therebetween.

In some examples, the biocidal additive formulation may include a copper(I) salt and a copper-assisting additive at any of the ratios disclosed elsewhere herein.

In certain examples, the biocidal additive formulation may include a solvent at a molarity of the solvent in the biocidal additive formulation of from 0.8 mM to 8.00 mM, including, for example, from 0.85 mM, or from 0.90 mM, or from 0.95 mM, or from 1.00 mM, or from 1.05 mM, or from 1.10 mM, or from 1.15 mM, or from 1.20 mM, or from 1.25 mM, or from 1.30 mM, or from 1.35 mM, or from 1.40 mM, or from 1.45 mM, or from 1.50 mM, or from 1.55 mM, or from 1.60 mM, or from 1.65 mM, or from 1.70 mM, or from 1.75 mM, or from 1.80 mM, or from 1.85 mM, or from 1.90 mM, or from 1.95 mM, or from 2.00 mM, or from 2.05 mM, or from 2.10 mM, or from 2.15 mM, or from 2.20 mM, or from 2.25 mM, or from 2.30 mM, or from 2.35 mM, or from 2.40 mM, or from 2.45 mM, or from 2.50 mM, or from 2.55 mM, or from 2.60 mM, or from 2.65 mM, or from 2.70 mM, or from 2.75 mM, or from 2.80 mM, or from 2.85 mM, or from 2.90 mM, or from 2.95 mM, or from 3.00 mM, or from 3.05 mM, or from 3.10 mM, or from 3.15 mM, or from 3.20 mM, or from 3.25 mM, or from 3.30 mM, or from 3.35 mM, or from 3.40 mM, or from 3.45 mM, or from 3.50 mM, or from 3.55 mM, or from 3.60 mM, or from 3.65 mM, or from 3.70 mM, or from 3.75 mM, or from 3.80 mM, or from 3.85 mM, or from 3.90 mM, or from 3.95 mM, or from 4.00 mM, or from 4.05 mM, or from 4.10 mM, or from 4.15 mM, or from 4.20 mM, or from 4.25 mM, or from 4.30 mM, or from 4.35 mM, or from 4.40 mM, or from 4.45 mM, or from 4.50 mM, or from 4.55 mM, or from 4.60 mM, or from 4.65 mM, or from 4.70 mM, or from 4.75 mM, or from 4.80 mM, or from 4.85 mM, or from 4.90 mM, or from 4.95 mM, or from 5.00 mM, or from 5.05 mM, or from 5.10 mM, or from 5.15 mM, or from 5.20 mM, or from 5.25 mM, or from 5.30 mM, or from 5.35 mM, or from 5.40 mM, or from 5.45 mM, or from 5.50 mM, or from 5.55 mM, or from 5.60 mM, or from 5.65 mM, or from 5.70 mM, or from 5.75 mM, or from 5.80 mM, or from 5.85 mM, or from 5.90 mM, or from 5.95 mM, or from 6.00 mM, or from 6.05 mM, or from 6.10 mM, or from 6.15 mM, or from 6.20 mM, or from 6.25 mM, or from 6.30 mM, or from 6.35 mM, or from 6.40 mM, or from 6.45 mM, or from 6.50 mM, or from 6.55 mM, or from 6.60 mM, or from 6.65 mM, or from 6.70 mM, or from 6.75 mM, or from 6.80 mM, or from 6.85 mM, or from 6.90 mM, or from 6.95 mM, or from 7.00 mM, or from 7.05 mM, or from 7.10 mM, or from 7.15 mM, or from 7.20 mM, or from 7.25 mM, or from 7.30 mM, or from 7.35 mM, or from 7.40 mM, or from 7.45 mM, or from 7.50 mM, or from 7.55 mM, or from 7.60 mM, or from 7.65 mM, or from 7.70 mM, or from 7.75 mM, or from 7.80 mM, or from 7.85 mM, or from 7.90 mM, or from 7.95 mM to 8.00 mM; or from 0.80 mM to 0.85 mM, or to 0.90 mM, or to 0.95 mM, or to 1.00 mM, or to 1.05 mM, or to 1.10 mM, or to 1.15 mM, or to 1.20 mM, or to 1.25 mM, or to 1.30 mM, or to 1.35 mM, or to 1.40 mM, or to 1.45 mM, or to 1.50 mM, or to 1.55 mM, or to 1.60 mM, or to 1.65 mM, or to 1.70 mM, or to 1.75 mM, or to 1.80 mM, or to 1.85 mM, or to 1.90 mM, or to 1.95 mM, or to 2.00 mM, or to 2.05 mM, or to 2.10 mM, or to 2.15 mM, or to 2.20 mM, or to 2.25 mM, or to 2.30 mM, or to 2.35 mM, or to 2.40 mM, or to 2.45 mM, or to 2.50 mM, or to 2.55 mM, or to 2.60 mM, or to 2.65 mM, or to 2.70 mM, or to 2.75 mM, or to 2.80 mM, or to 2.85 mM, or to 2.90 mM, or to 2.95 mM, or to 3.00 mM, or to 3.05 mM, or to 3.10 mM, or to 3.15 mM, or to 3.20 mM, or to 3.25 mM, or to 3.30 mM, or to 3.35 mM, or to 3.40 mM, or to 3.45 mM, or to 3.50 mM, or to 3.55 mM, or to 3.60 mM, or to 3.65 mM, or to 3.70 mM, or to 3.75 mM, or to 3.80 mM, or to 3.85 mM, or to 3.90 mM, or to 3.95 mM, or to 4.00 mM, or to 4.05 mM, or to 4.10 mM, or to 4.15 mM, or to 4.20 mM, or to 4.25 mM, or to 4.30 mM, or to 4.35 mM, or to 4.40 mM, or to 4.45 mM, or to 4.50 mM, or to 4.55 mM, or to 4.60 mM, or to 4.65 mM, or to 4.70 mM, or to 4.75 mM, or to 4.80 mM, or to 4.85 mM, or to 4.90 mM, or to 4.95 mM, or to 5.00 mM, or to 5.05 mM, or to 5.10 mM, or to 5.15 mM, or to 5.20 mM, or to 5.25 mM, or to 5.30 mM, or to 5.35 mM, or to 5.40 mM, or to 5.45 mM, or to 5.50 mM, or to 5.55 mM, or to 5.60 mM, or to 5.65 mM, or to 5.70 mM, or to 5.75 mM, or to 5.80 mM, or to 5.85 mM, or to 5.90 mM, or to 5.95 mM, or to 6.00 mM, or to 6.05 mM, or to 6.10 mM, or to 6.15 mM, or to 6.20 mM, or to 6.25 mM, or to 6.30 mM, or to 6.35 mM, or to 6.40 mM, or to 6.45 mM, or to 6.50 mM, or to 6.55 mM, or to 6.60 mM, or to 6.65 mM, or to 6.70 mM, or to 6.75 mM, or to 6.80 mM, or to 6.85 mM, or to 6.90 mM, or to 6.95 mM, or to 7.00 mM, or to 7.05 mM, or to 7.10 mM, or to 7.15 mM, or to 7.20 mM, or to 7.25 mM, or to 7.30 mM, or to 7.35 mM, or to 7.40 mM, or to 7.45 mM, or to 7.50 mM, or to 7.55 mM, or to 7.60 mM, or to 7.65 mM, or to 7.70 mM, or to 7.75 mM, or to 7.80 mM, or to 7.85 mM, or to 7.90 mM, or to 7.95 mM; or a range formed from any two of the foregoing molarities; including any subranges therebetween. Examples of organic solvents in biocidal compositions and biocidal additive formulations may include acetonitrile and ethyl acetate.

In an example, the present disclosure provides a biocidal composition, including: a carrier, including a polyurethane, a polyurethane precursor, an epoxy resin, an epoxy resin precursor, a melamine resin, or any combination thereof; a copper(I) salt; and a copper-assisting additive different from the carrier; wherein the copper-assisting additive includes a phosphite, a phosphine, or a combination thereof; and wherein the biocidal composition or a film thereof exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein).

In certain examples, the phosphite may be a compound of formula (I):

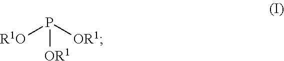

wherein each R¹ is independently selected from C₁-C₂₀ alkyl, aryl, and aryl(C₁-C₄)alkyl, any of which is optionally fluorosubstituted.

In certain examples, the phosphine may be a compound of formula (II):

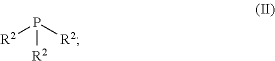

wherein each R² is independently selected from C₁-C₂₀ alkyl, aryl, and aryl(C₁-C₄)alkyl, any of which is optionally substituted with a hydroxy group.

In certain examples, the carrier may include a polyurethane, a polyurethane precursor, or a combination thereof.

In certain examples, the carrier may include an epoxy resin, an epoxy resin precursor, or a combination thereof.

In certain examples, the carrier may include an organic solvent.

In certain examples, the copper(I) salt may be a copper(I) halide, iodo (triethyl phosphite)copper(I), or a tetrakis(acetonitrile)copper(I) salt.

In certain examples, the copper(I) salt may be copper(I) bromide or copper(I) iodide.

In certain examples, each R¹ may be independently selected from C₂-C₁₃ alkyl, C₁-C₈ alkyl, C₁-C₆ alkyl, C₂-C₅ alkyl, C₂-C₄ alkyl, or phenyl.

In certain examples, each R² may be independently selected from C₂-C₁₃ alkyl, C₁-C₈ alkyl, C₁-C₆ alkyl, C₂-C₅ alkyl, or C₂-C₄ alkyl.

In certain examples, the copper-assisting additive may be triethyl phosphite, tributyl phosphine, triphenyl phosphite, or any combination thereof.

In certain examples, a molar ratio of the copper-assisting additive to the copper(I) salt may be at least 0.5:1.

In certain examples, the biocidal composition may further include a compound of formula (III), (IV), (V), or any combination thereof:

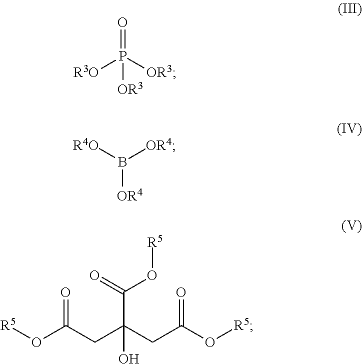

wherein each R³ may be independently selected from hydrogen, C₁-C₂₀ alkyl, aryl, and aryl(C₁-C₄)alkyl, provided that all R³ are not simultaneously hydrogen; wherein each R⁴ may be independently selected from hydrogen, C₁-C₂₀ alkyl, aryl, and aryl(C₁-C₄)alkyl, provided that all R⁴ are not simultaneously hydrogen; and wherein each R⁵ may be independently selected from hydrogen, C₁-C₂₀ alkyl, aryl, and aryl(C₁-C₄)alkyl, provided that all R⁵ are not simultaneously hydrogen.

In certain examples, each R³ may be independently selected from C₁-C₁₃ alkyl, C₁-C₈ alkyl, C₁-C₆ alkyl, C₂-C₅ alkyl, or C₂-C₄ alkyl.

In certain examples, the biocidal composition may further include 2-ethylhexyl phosphate.

In certain examples, each R⁴ may be independently selected from C₁-C₁₃ alkyl, C₁-C₈ alkyl, C₁-C₆ alkyl, C₂-C₅ alkyl, or C₂-C₄ alkyl.

In certain examples, the biocidal composition may further include tributyl borate.

In certain examples, each R⁵ may be independently selected from C₁-C₁₃ alkyl, C₁-C₈ alkyl, C₁-C₆ alkyl, C₂-C₅ alkyl, or C₂-C₄ alkyl.

In certain examples, the biocidal composition may further include tributyl citrate.

In certain examples, the biocidal composition may exhibit a ΔE of less than 6, as calculated according to

$$Δ E = \sqrt{( {( L * - {L}_{control}^{*} )}^{2} + {( a * - {a}_{control}^{*} )}^{2} + {( b * - {b}_{control}^{*} )}^{2} )} ;$$

wherein L*, a*, and b* are CIE values of the biocidal composition after preparing and then storing the biocidal composition at ambient temperature and ambient relative humidity for 90 days or at least 90 days (or any other time period disclosed herein), and

$${L}_{control}^{*} , {a}_{control}^{*} ,$$

and

$${b}_{control}^{*}$$

are CIE values of an otherwise identical composition without either the copper(I) salt or the copper-assisting additive.

In certain examples, the biocidal composition or the film thereof may exhibit a transmittance of at least 98% as measured at each wavelength from 400 to 700 nanometers when measured at a thickness of 40 μm.

In certain examples, the transmittance may be within 10 percentage points of a second transmittance of an otherwise identical composition or film thereof without either the copper(I) salt or the copper-assisting additive when measured at a thickness of 40 μm.

In certain examples, a method of preparing the biocidal composition may include: adding a biocidal additive formulation to a carrier; wherein when the carrier is a polyurethane or an epoxy resin, the biocidal additive formulation may include the copper(I) salt and the copper-assisting additive; wherein when the carrier is a second polyurethane precursor, the biocidal additive formulation may include a first polyurethane precursor, the copper(I) salt, and the copper-assisting additive; and wherein when the carrier is a second epoxy resin precursor, the biocidal additive formulation may include a first epoxy resin precursor, the copper(I) salt, and the copper-assisting additive.

In an example, a biocidal additive formulation, including: a copper(I) salt; and a copper-assisting additive; wherein a biocidal composition including the biocidal additive formulation and a carrier, or a film of the biocidal composition, exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein); wherein the carrier includes a polyurethane, a polyurethane precursor, an epoxy resin, an epoxy resin precursor, a melamine resin, or any combination thereof; wherein the biocidal composition exhibits a ΔE of less than 6, as calculated according to

$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$

wherein L*, a*, and b* are CIE values of the biocidal composition after preparing and then storing the biocidal composition at ambient temperature and ambient relative humidity for 90 days or at least 90 days (or any other time period disclosed herein), and

$${L}_{control}^{*} , {a}_{control}^{*} ,$$

and

$${b}_{control}^{*}$$

are CIE values of an otherwise identical composition without either the copper(I) salt or the copper-assisting additive.

In certain examples, the biocidal additive formulation may include an organic solvent, a first polyurethane precursor, a first epoxy resin precursor, or any combination thereof.

In certain examples, the copper(I) salt may be a copper(I) halide, iodo (triethyl phosphite)copper(I), or a tetrakis(acetonitrile)copper(I) salt.

In certain examples, the copper(I) salt may be copper(I) bromide or copper(I) iodide.

In certain examples, the copper-assisting additive may include a phosphite, a phosphine, or a combination thereof.

In certain examples the phosphite may be a compound of formula (I):

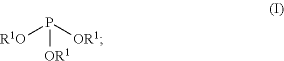

wherein each R¹ may be independently selected from C₁-C₂₀ alkyl, aryl, and aryl(C₁-C₄)alkyl, any of which is optionally fluorosubstituted, provided that all R¹ are not simultaneously hydrogen.

In certain examples, the phosphine may be a compound of formula (II):

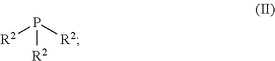

wherein each R² may be independently selected from C₁-C₂₀ alkyl, aryl, and aryl(C₁-C₄)alkyl, any of which is optionally substituted with a hydroxy group, provided that all R² are not simultaneously hydrogen.

In certain examples, each R¹ may be independently selected from C₂-C₁₃ alkyl, C₁-C₈ alkyl, C₁-C₆ alkyl, C₂-C₅ alkyl, or C₂-C₄ alkyl, or phenyl.

In certain examples, each R² may be independently selected from C₂-C₁₃ alkyl, C₁-C₈ alkyl, C₁-C₆ alkyl, C₂-C₅ alkyl, or C₂-C₄ alkyl.

In certain examples, the copper-assisting additive may be triethyl phosphite, tributyl phosphine, triphenyl phosphite, or any combination thereof.

In certain examples, a molar ratio of the copper-assisting additive to the copper(I) salt may be at least 0.5:1.

In certain examples, the biocidal additive formulation may further include a compound of formula (III), (IV), (V), or any combination thereof:

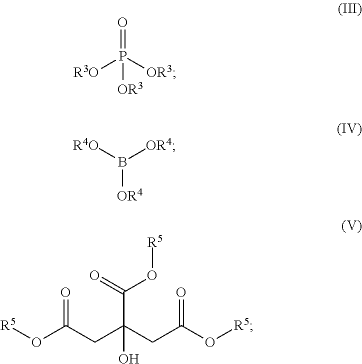

wherein each R³ may be independently selected from hydrogen, C₁-C₂₀ alkyl, aryl, and aryl(C₁-C₄)alkyl, provided that all R³ are not simultaneously hydrogen; wherein each R⁴ may be independently selected from hydrogen, C₁-C₂₀ alkyl, aryl, and aryl(C₁-C₄)alkyl, provided that all R⁴ are not simultaneously hydrogen; and wherein each R⁵ may be independently selected from hydrogen, C₁-C₂₀ alkyl, aryl, and aryl(C₁-C₄)alkyl, provided that all R⁵ are not simultaneously hydrogen.

In certain examples, each R³ may be independently selected from C₁-C₁₃ alkyl, C₁-C₈ alkyl, C₁-C₆ alkyl, C₂-C₅ alkyl, or C₂-C₄ alkyl.

In certain examples, the biocidal additive formulation may further include 2-ethylhexyl phosphate.

In certain examples, each R⁴ may be independently selected from C₁-C₁₃ alkyl, C₁-C₈ alkyl, C₁-C₆ alkyl, C₂-C₅ alkyl, or C₂-C₄ alkyl.

In certain examples, the biocidal additive formulation may further include tributyl borate.

In certain examples, each R⁵ may be independently selected from C₁-C₁₃ alkyl, C₁-C₈ alkyl, C₁-C₆ alkyl, C₂-C₅ alkyl, or C₂-C₄ alkyl.

In certain examples, the biocidal additive formulation may further include tributyl citrate.

In certain examples, the biocidal composition or the film thereof may exhibit a transmittance of at least 98% as measured at each wavelength from 400 to 700 nanometers when measured at a thickness of 40 μm.

In certain examples, the transmittance may be within 10 percentage points of a second transmittance of an otherwise identical composition or film thereof without either the copper(I) salt or the copper-assisting additive when measured at a thickness of 40 μm.

In certain examples, the biocidal additive formulation may further include an antioxidant.

In certain examples, the biocidal additive formulation may further include a reducing agent.

In certain examples, the formulation may be in a sealed container including an inert atmosphere.

Although the present disclosure has been described with reference to examples and the accompanying figures and charts, the present disclosure is not limited thereto, but may be variously modified and altered by those skilled in the art to which the present disclosure pertains without department from the spirit and scope of the present disclosure.

Various aspects are contemplated herein, several of which are set forth in the paragraphs below. It is explicitly contemplated that any aspect or portion thereof may be combined to form a combination.

A first aspect relates to a biocidal composition, comprising: a carrier, comprising a polyurethane, a polyurethane precursor, an epoxy resin, an epoxy resin precursor, a melamine resin, or any combination thereof; a copper(I) salt; and a copper-assisting additive different from the carrier; wherein the copper-assisting additive comprises a phosphite, a phosphine, or a combination thereof; and wherein the biocidal composition or a film thereof exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein).

A second aspect relates to the biocidal composition of aspect 1, or any preceding aspect, wherein the phosphite is a compound of formula (I):

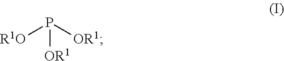

wherein each R¹ is independently selected from C₁-C₂₀ alkyl, aryl, and aryl(C₁-C₄)alkyl, any of which is optionally fluorosubstituted.

A third aspect relates to the biocidal composition of any preceding aspect, wherein the phosphine is a compound of formula (II):

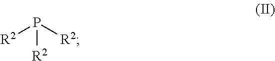

wherein each R² is independently selected from C₁-C₂₀ alkyl, aryl, and aryl(C₁-C₄)alkyl, any of which is optionally substituted with a hydroxy group.

A fourth aspect relates to the biocidal composition of any preceding aspect, wherein the carrier comprises a polyurethane, a polyurethane precursor, or a combination thereof.

A fifth aspect relates to the biocidal composition of aspects 1 to 3, or any preceding aspect, wherein the carrier comprises an epoxy resin, an epoxy resin precursor, or a combination thereof.

A sixth aspect relates to the biocidal composition of any preceding aspect, wherein the carrier comprises an organic solvent.

A seventh aspect relates to the biocidal composition of any preceding aspect, wherein the copper(I) salt is a copper(I) halide, iodo (triethyl phosphite)copper(I), or a tetrakis(acetonitrile)copper(I) salt.

An eighth aspect relates to the biocidal composition of any preceding aspect, wherein the copper(I) salt is copper(I) bromide or copper(I) iodide.

A ninth aspect relates to the biocidal composition of aspects 2 to 8, or any preceding aspect, wherein each R¹ is independently selected from C₂-C₁₃ alkyl (or C₁-C₈ alkyl, or C₁-C₆ alkyl, or C₂-C₅ alkyl, C₂-C₄ alkyl), or phenyl.

A tenth aspect relates to the biocidal composition of aspects 3 to 9, or any preceding aspect, wherein each R² is independently selected from C₂-C₁₃ alkyl (or C₁-C₈ alkyl, or C₁-C₆ alkyl, or C₂-C₅ alkyl, or C₂-C₄ alkyl).

An eleventh aspect relates to the biocidal composition of any preceding aspect, wherein the copper-assisting additive is triethyl phosphite, triphenyl phosphite, tributyl phosphine, or any combination thereof.

A twelfth aspect relates to the biocidal composition of any preceding aspect, wherein a molar ratio of the copper-assisting additive to the copper(I) salt is at least 0.5:1.

A thirteenth aspect relates to the biocidal composition of any preceding aspect, further comprising a compound of formula (III), (IV), (V), or any combination thereof:

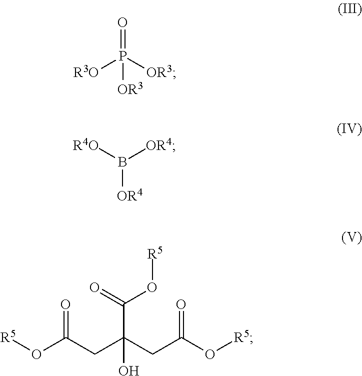

wherein each R³ is independently selected from hydrogen, C₁-C₂₀ alkyl, aryl, and aryl(C₁-C₄)alkyl, provided that all R³ are not simultaneously hydrogen; wherein each R⁴ is independently selected from hydrogen, C₁-C₂₀ alkyl, aryl, and aryl(C₁-C₄)alkyl, provided that all R⁴ are not simultaneously hydrogen; and wherein each R⁵ is independently selected from hydrogen, C₁-C₂₀ alkyl, aryl, and aryl(C₁-C₄)alkyl, provided that all R⁵ are not simultaneously hydrogen.

A fourteenth aspect relates to the biocidal composition of aspect 13, or any preceding aspect, wherein each R³ is independently selected from C₁-C₁₃ alkyl (or C₁-C₈ alkyl, or C₁-C₆ alkyl, or C₂-C₅ alkyl, or C₂-C₄ alkyl).

A fifteenth aspect relates to the biocidal composition of any preceding aspect, further comprising 2-ethylhexyl phosphate.

A sixteenth aspect relates to the biocidal composition of aspect 13, or any preceding aspect, wherein each R⁴ is independently selected from C₁-C₁₃ alkyl (or C₁-C₈ alkyl, or C₁-C₆ alkyl, or C₂-C₅ alkyl, or C₂-C₄ alkyl).

A seventeenth aspect relates to the biocidal composition of any preceding aspect, further comprising tributyl borate.

An eighteenth aspect relates to the biocidal composition of aspect 13, or any preceding aspect, wherein each R⁵ is independently selected from C₁-C₁₃ alkyl (or C₁-C₈ alkyl, or C₁-C₆ alkyl, or C₂-C₅ alkyl, or C₂-C₄ alkyl).

A nineteenth aspect relates to the biocidal composition of any preceding aspect, further comprising tributyl citrate.

A twentieth aspect relates to the biocidal composition of any preceding aspect, wherein the biocidal composition exhibits a ΔE of less than 6, as calculated according to

$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$

and wherein L*, a*, and b* are CIE values of the biocidal composition after preparing and then storing the biocidal composition at ambient temperature and ambient relative humidity for 90 days or at least 90 days (or any other time period disclosed herein), and

$${L}_{control}^{*} , {a}_{control}^{*} ,$$

and

$${b}_{control}^{*}$$

are CIE values of an otherwise identical composition without either the copper(I) salt or the copper-assisting additive.

A twenty-first aspect relates to the biocidal composition of any preceding aspect, wherein the biocidal composition or the film thereof exhibits a transmittance of at least 98% as measured at each wavelength from 400 to 700 nanometers when measured at a thickness of 40 μm.

A twenty-second aspect relates to the biocidal composition of aspect 21, or any preceding aspect, wherein the transmittance is within 10 percentage points of a second transmittance of an otherwise identical composition or film thereof without either the copper(I) salt or the copper-assisting additive when measured at a thickness of 40 μm.

A twenty-third aspect relates to a method of preparing the biocidal composition of any preceding aspect, comprising: adding a biocidal additive formulation to a carrier; wherein when the carrier is a polyurethane or an epoxy resin, the biocidal additive formulation comprises the copper(I) salt and the copper-assisting additive; wherein when the carrier is a second polyurethane precursor, the biocidal additive formulation comprises a first polyurethane precursor, the copper(I) salt, and the copper-assisting additive; and wherein when the carrier is a second epoxy resin precursor, the biocidal additive formulation comprises a first epoxy resin precursor, the copper(I) salt, and the copper-assisting additive.

A twenty-fourth aspect relates to a biocidal additive formulation, comprising: a copper(I) salt; and a copper-assisting additive; wherein a biocidal composition comprising the biocidal additive formulation and a carrier, or a film of the biocidal composition, exhibits an antimicrobial efficacy of at least 3 log kill as measured with an EPA Test after storage of the biocidal composition or the film thereof at ambient temperature and ambient relative humidity for 90 days or at least 90 days (or any other time period disclosed herein); wherein the carrier comprises a polyurethane, a polyurethane precursor, an epoxy resin, an epoxy resin precursor, a melamine resin, or any combination thereof; wherein the biocidal composition exhibits a ΔE of less than 6, as calculated according to

$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$

wherein L*, a*, and b* are CIE values of the biocidal composition after preparing and then storing the biocidal composition at ambient temperature and ambient relative humidity for 90 days or at least 90 days (or any other time period disclosed herein), and

$${L}_{control}^{*} , {a}_{control}^{*} ,$$

and

$${b}_{control}^{*}$$

are CIE values of an otherwise identical composition without either the copper(I) salt or the copper-assisting additive.

A twenty-fifth aspect relates to the biocidal additive formulation of aspect 24, or any preceding aspect, further comprising an organic solvent, a first polyurethane precursor, a first epoxy resin precursor, or any combination thereof.

A twenty-sixth aspect relates to the biocidal additive formulation of aspect 24 or 25, or any preceding aspect, wherein the copper(I) salt is a copper(I) halide, iodo (triethyl phosphite)copper(I), or a tetrakis(acetonitrile)copper(I) salt.

A twenty-seventh aspect relates to the biocidal additive formulation of aspects 24 to 26, or any preceding aspect, wherein the copper(I) salt is copper(I) bromide or copper(I) iodide.

A twenty-eighth aspect relates to the biocidal additive formulation of aspects 24 to 27, or any preceding aspect, wherein the copper-assisting additive comprises a phosphite, a phosphine, or a combination thereof.

A twenty-ninth aspect relates to the biocidal additive formulation of aspect 28, or any preceding aspect, wherein the phosphite is a compound of formula (I):

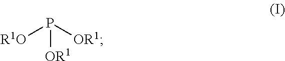

wherein each R¹ is independently selected from C₁-C₂₀ alkyl, aryl, and aryl(C₁-C₄)alkyl, any of which is optionally fluorosubstituted.

A thirtieth aspect relates to the biocidal additive formulation of aspect 28, or any preceding aspect, wherein the phosphine is a compound of formula (II):

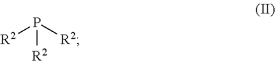

wherein each R² is independently selected from C₁-C₂₀ alkyl, aryl, and aryl(C₁-C₄)alkyl, any of which is optionally substituted with a hydroxy group.

A thirty-first aspect relates to the biocidal additive formulation of aspect 29, or any preceding aspect, wherein each R¹ is independently selected from C₂-C₁₃ alkyl (or C₁-C₈ alkyl, or C₁-C₆ alkyl, or C₂-C₅ alkyl, or C₂-C₄ alkyl).

A thirty-second aspect relates to the biocidal additive formulation of aspect 30, or any preceding aspect, wherein each R² is independently selected from C₂-C₁₃ alkyl (or C₁-C₈ alkyl, or C₁-C₆ alkyl, or C₂-C₅ alkyl, or C₂-C₄ alkyl).

A thirty-third aspect relates to the biocidal additive formulation of aspects 24 to 32, or any preceding aspect, wherein the copper-assisting additive is triethyl phosphite, tributyl phosphine, triphenyl phosphite, or any combination thereof.

A thirty-fourth aspect relates to the biocidal additive formulation of aspects 24 to 33, or any preceding aspect, wherein a molar ratio of the copper-assisting additive to the copper(I) salt is at least 0.5:1.

A thirty-fifth aspect relates to the biocidal additive formulation of aspects 24 to 34, or any preceding aspect, further comprising a compound of formula (III), (IV), (V), or any combination thereof:

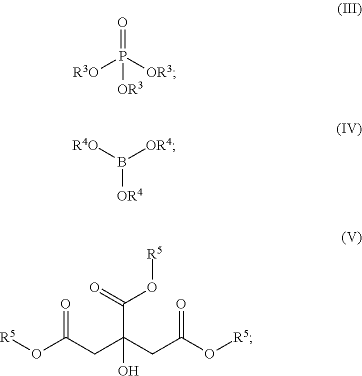

wherein each R³ is independently selected from hydrogen, C₁-C₂₀ alkyl, aryl, and aryl(C₁-C₄)alkyl, provided that all R³ are not simultaneously hydrogen; wherein each R⁴ is independently selected from hydrogen, C₁-C₂₀ alkyl, aryl, and aryl(C₁-C₄)alkyl, provided that all R⁴ are not simultaneously hydrogen; and wherein each R⁵ is independently selected from hydrogen, C₁-C₂₀ alkyl, aryl, and aryl(C₁-C₄)alkyl, provided that all R⁵ are not simultaneously hydrogen.

A thirty-sixth aspect relates to the biocidal additive formulation of aspect 35, or any preceding aspect, wherein each R³ is independently selected from C₁-C₁₃ alkyl (or C₁-C₈ alkyl, or C₁-C₆ alkyl, or C₂-C₅ alkyl, or C₂-C₄ alkyl).

A thirty-seventh aspect relates to the biocidal additive formulation of aspects 24 to 34, or any preceding aspect, further comprising 2-ethylhexyl phosphate.

A thirty-eighth aspect relates to the biocidal additive formulation of aspect 35, or any preceding aspect, wherein each R⁴ is independently selected from C₁-C₁₃ alkyl (or C₁-C₈ alkyl, or C₁-C₆ alkyl, or C₂-C₅ alkyl, or C₂-C₄ alkyl).

A thirty-ninth aspect relates to the biocidal additive formulation of aspects 24 to 34, or any preceding aspect, further comprising tributyl borate.

A fortieth aspect relates to the biocidal additive formulation of aspect 35, or any preceding aspect, wherein each R⁵ is independently selected from C₁-C₁₃ alkyl (or C₁-C₈ alkyl, or C₁-C₆ alkyl, or C₂-C₅ alkyl, or C₂-C₄ alkyl).

A forty-first aspect relates to the biocidal additive formulation of aspects 24 to 34, or any preceding aspect, further comprising tributyl citrate.

A forty-second aspect relates to the biocidal additive formulation of aspects 24 to 41, or any preceding aspect, wherein the biocidal composition or the film thereof exhibits a transmittance of at least 98% as measured at each wavelength from 400 to 700 nanometers when measured at a thickness of 40 μm.

A forty-third aspect relates to the biocidal additive formulation of aspect 42, or any preceding aspect, wherein the transmittance is within 10 percentage points of a second transmittance of an otherwise identical composition or film thereof without either the copper(I) salt or the copper-assisting additive when measured at a thickness of 40 μm.

A forty-fourth aspect relates to the biocidal additive formulation of aspects 24 to 43, or any preceding aspect, further comprising an antioxidant package.

A forty-fifth aspect relates to the biocidal additive formulation of aspects 24 to 43, or any preceding aspect, further comprising a reducing agent.

A forty-sixth aspect relates to the biocidal additive formulation of aspects 24 to 45, or any preceding aspect, wherein the formulation is in a sealed container comprising an inert atmosphere.

A forty-seventh aspect relates to a combination of any two or more preceding aspects, or any portion(s) thereof.

The compositions and methods described above may be better understood in connection with the following Examples, which are non-limiting examples provided as an illustration of the concepts disclosed herein. The illustrated methods are applicable to other examples of biocidal compositions of the present disclosure. The procedures described as general methods describe what is believed will be typically effective to prepare the compositions indicated. However, the person skilled in the art will appreciate that it may be necessary to vary the procedures for nay given example of the present disclosure, for example, vary the order or steps and/or the chemical reagents used.

### EXAMPLES

Comparison of Complexes with Copper (I) Salts to Mixtures Including Copper-Containing Glass (“CCG”).

In the Examples herein, the complexes with copper(I) salts may be compared to mixtures including copper-containing material including a plurality of copper-containing glass or glass-ceramic particles. As used herein, the term “copper-containing glass” is meant to include “copper-containing glass-ceramic” unless clearly contradicted by context. In this regard, the “ceramic” portion of the copper-containing glass-ceramic may include, in some aspects, cuprite crystals.

In certain examples, the copper-containing material may include copper-containing glass or copper-containing glass-ceramic particles. The copper-containing glass or glass-ceramic particles may be a biocidal inorganic glass or glass-ceramic powder including copper particles. Although the individual particles of the copper-containing glass particles may be effective as a biocidal agent, such copper-containing glass may have potential drawbacks related to color of the resulting composition and stability of copper(I).

The copper-containing glass or glass-ceramic particles may independently include a Cu metal, Cu¹⁺, Cu²⁺, or a combination of Cu¹⁺ and Cu²⁺. The combined total of the Cu species may be 10 weight % or more of the copper-containing material. However, as will be discussed in more detail below, the amount of Cu²⁺ may be minimized or reduced such that the copper-containing glass or glass-ceramic particles may be substantially free of Cu²⁺. The copper may be non-complexed or may have a ligand bonded thereto to form a complex. The Cu¹⁺ ions may be present on or in the surface and/or the bulk of the copper-containing glass or glass-ceramic particles. The copper-containing glass or glass-ceramic particles may include copper-containing glass or glass-ceramic, copper metal, copper(I) oxide, copper(II) oxide, or a combination thereof. In certain examples, the copper-containing glass or glass-ceramic particles may include only one of copper-containing glass or glass-ceramic, copper metal, copper(I) oxide, or copper(II) oxide. In certain examples, the Cu¹⁺ ions may be present in a glass or glass-ceramic network and/or a glass or glass-ceramic matrix of the copper-containing glass or glass-ceramic particles. Where the Cult ions are present in the glass or glass-ceramic network, the Cu¹⁺ ions and atomically bonded to the atoms in the glass or glass-ceramic mixture. Where the Cu¹⁺ ions are present in the glass or glass-ceramic matrix, the Cu¹⁺ ions may be present in the form of Cu¹⁺ crystals that are dispersed in the glass or glass-ceramic matrix. In certain examples, the Cu¹⁺ crystals may include cuprite (Cu₂O). In certain examples, where Cu¹⁺ crystals are present, the material may be referred to as a glass-ceramic or ceramic, which is intended to refer to a specific type of glass or glass-ceramic with crystals that may or may not be subjected to a traditional ceramming process by which one or more crystalline phases are introduced and/or generated in the glass or glass-ceramic. Where the Cult ions are present in a non-crystalline form, the material may be referred to as a copper-containing glass. In certain examples, both Cu¹⁺ crystals and Cu¹⁺ ions not associated with a crystal may be present in the copper-containing glasses or glass-ceramics described herein.

Copper-containing glasses or glass-ceramics may include a copper-containing oxide in an amount, in mole percent, in the range from 10 to 50, from 10 to 49, from 10 to 48, from 10 to 47, from 10 to 46, from 10 to 45, from 10 to 44, from 10 to 43, from 10 to 42, from 10 to 41, from 10 to 40, from 10 to 39, from 10 to 38, from 10 to 37, from 10 to 36, from 10 to 35, from 10 to 34, from 10 to 33, from 10 to 32, from 10 to 31, from 10 to 30, from 10 to 29, from 10 to 28, from 10 to 27, from 10 to 26, from 10 to 25, from 10 to 24, from 10 to 23, from 10 to 22, from 10 to 21, from 10 to 20, from 11 to 50, from 12 to 50, from 13 to 50, from 14 to 50, from 15 to 50, from 16 to 50, from 17 to 50, from 18 to 50, from 19 to 50, from 20 to 50, from 10 to 30, from 11 to 29, from 12 to 28, from 13 to 27, from 14 to 26, from 15 to 25, from 16 to 24, from 17 to 23, from 18 to 22, from 19 to 21; or a range formed from any two of the foregoing mole percents; and all sub-ranges therebetween. The copper-containing oxide may be present in the copper-containing glasses or glass-ceramics in an amount of 20 mole percent, 25 mole percent, 30 mole percent, or 35 mole percent. The copper-containing oxide may include CuO, Cu₂O, and/or combinations thereof. The copper-containing glass or glass-ceramic particles may include cuprous oxide in an amount from 29.0 to 36.0 weight percent of the copper-containing glass or glass-ceramic particles. The copper-containing oxides in the copper-containing glasses or glass-ceramics form the Cu¹⁺ ions present in the resulting glass or glass-ceramic. Copper may be present in a glass or glass-ceramic, or compositions thereof, in various forms, including Cu⁰, Cu¹⁺, and Cu²⁺.

The copper-containing glass or glass-ceramic portion of the individual particles of the copper-containing glass or glass-ceramic particles may be formed from a glass composition that may include, but is not limited to, in mole percent, SiO₂ in the range from 30 to 70, Al₂O₃ in the range from 0 to 20, a copper-containing oxide in the range from 10 to 50, CaO in the range from 0 to 15, MgO in the range from 0 to 15, P₂O₅ in the range from 0 to 25, B₂O₃ in the range from 0 to 25, K₂O in the range from 0 to 20, ZnO in the range from 0 to 5, Na₂O in the range from 0 to 20, and/or Fe₂O₃ in the range from 0 to 5, nanoparticles thereof, and/or a mixture thereof. In such examples, the amount of the copper-containing oxide is greater than the amount of Al₂O₃. In certain examples, the glass composition may include a content of R₂O, where R may include K, Na, Li, Rb, Cs, and combinations thereof.

In certain examples, the glass composition may include one or more divalent cation oxides, such as alkaline earth oxides and/or ZnO. In certain examples, the glass composition may include NiO, TiO₂, Fe₂O₃, Cr₂O₃, or Co₃O₄ in an amount in the range up to 10 mol %, or from 0.01 mol % to 10 mol %, from 1 mol % to 10 mol %, from 2 mol % to 10 mol %, from 5 mol % to 10 mol %, from 0.01 mol % to 0.8 mol %, or from 0.01 mol % to 5 mol %.

The copper-containing glasses or glass-ceramics formed from the glass compositions may include a plurality of Cu¹⁺ ions. In certain examples, such Cu¹⁺ ions form part of the glass network. In certain examples, the Cu¹⁺ ions that are dispersed in the glass matrix are Cu¹⁺ crystals. The Cult may be present in the form of cuprite. The cuprite present in the copper-containing glass-ceramic may form a phase distinct from the glass matrix or glass phase. In other examples, the cuprite may form part of or may be associated with one or more glass phases.

The copper-containing glass may be produced by any suitable method. For example, the copper-containing glass may be performed using melting tanks that are typically used for melting glass compositions such as soda lime silicate. In certain examples, the copper-containing glass may be formed into a sheet using forming processes known in the art. Forming methods may include float glass processes and down-draw processes such as fusion draw and slot draw. After formation, the copper-containing glass may be formed into sheets and may be shaped, polished, or otherwise processed for a desired end use. In certain examples, the copper-containing glass may be ground to a powder or particulate form. In certain examples, the particulate copper-containing glass may be combined with other materials or carriers.

The EPA Test was used to test for antimicrobial efficacy for all examples herein.

### Example 1

The following example illustrates the determination of baseline antimicrobial efficacy of a 2-part polyurethane with copper sources (copper(I) salts).

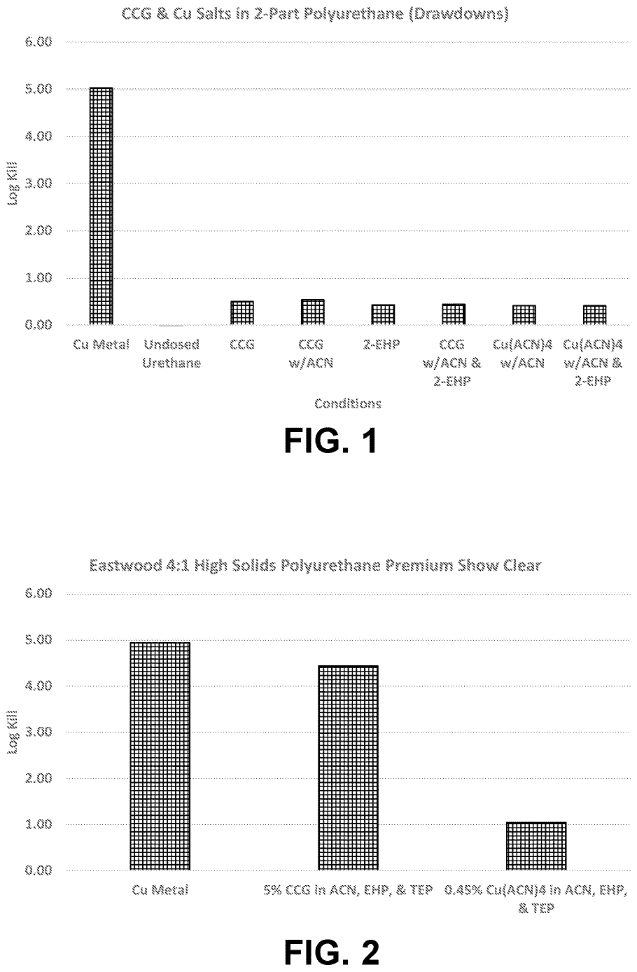

The addition of copper sources in 2-part polyurethane resulted in negligible antimicrobial efficacy with or without addition of 2-ethylhexyl phosphate (“EHP”). Drawdowns of thin samples as well as thick samples were prepared to ensure that enough copper was present in the bulk to have sufficient antimicrobial efficacy, in ingredient amounts as provided in Table 1 below. Copper-containing glass was used as a comparator in conjunction with tetrakis(acetonitrile)copper(I), but neither attained close to 3 log kill, as illustrated in FIG. 1.

A commercially available two-part polyurethane (Eastwood® 4:1 High Solids Urethane Premium Show Clear) was added per the manufacturer's instructions, using a 4:1 weight:weight ratio of Part A and Part B. Part A and Part B were mixed together first, and allowed to sit for 45 minutes before addition of copper source and copper-assisting additive. The copper(I) salt and copper-containing glass were prepared first, during which the copper source was dissolved or dispersed in acetonitrile (“ACN”) (with EHP, if used), allowed to rest for 1 hour before addition of triethyl phosphite (“TEP”), and the mixture was added to the polyurethane mixture. The resulting material was mixed thoroughly and a film was cast on a sheet of PVC and allowed to cure for 24 hours. Antimicrobial testing was performed on 1″×1″ cutouts of the resulting film.

TABLE 1

| | | | | | Mass Part | Mass Part | |
|---|---|---|---|---|---|---|---|
| | | Mass | | | A Poly- | B Poly- | |
| | Mass | Cu(ACN)₄ | Mass | Mass | urethane | urethane | Total |
| Condition | CCG (g) | (g) | EHP (g) | ACN (g) | (g) | (g) | (g) |
| Undosed | 0 | 0 | 0 | 0 | 8 | 2 | 10 |
| Polyurethane | | | | | | | |
| CCG | 0.1 | 0 | 0 | 0 | 8 | 2 | 10.1 |
| CCG in ACN | 0.1 | 0 | 0 | 0.4 | 8 | 2 | 10.5 |
| EHP | 0 | 0 | 0.1847 | 0 | 8 | 2 | 10.1847 |
| CCG in | 0.1 | 0 | 0.1847 | 0.4 | 8 | 2 | 10.6847 |
| ACN + EHP | | | | | | | |
| (Part A) | | | | | | | |
| CCG in | 0.1 | 0 | 0.1847 | 0.4 | 8 | 2 | 10.6847 |
| ACN + EHP | | | | | | | |
| (Part B) | | | | | | | |
| Cu(ACN)₄ | 0 | 0.0528 | 0 | 0.2111 | 8 | 2 | 10.2113 |
| in ACN | | | | | | | |
| Cu(ACN)₄ in | 0 | 0.0528 | 0.1847 | 0.2111 | 8 | 2 | 10.3959 |
| ACN + EHP | | | | | | | |

An equivalent procedure was performed using an epoxy resin, except the ratio of the epoxy Part A to the epoxy Part B was 1:1.

In subsequent experiments, the procedure for two-part polyurethanes and two-part epoxies was as follows: solvent and copper-assisting additive were mixed together into a homogeneous solution and added to copper species. The copper species and additive solution were mixed until the copper species was completely dissolved or a homogeneous liquid phase was formed. Additional additives were added to the mixture if necessary to achieve homogeneity. Prior to the addition of the copper species and additive solution to the two-part polyurethane, the polyurethane precursors were mixed according to the manufacturer's specified ratio, and the polyurethane mixture was allowed to rest with exposure to air and occasional stirring to allow the polyurethane mixture to begin reacting. The copper species and additive mixture was added to the polyurethane mixture, after filtering solids if necessary, and the entire mixture was stirred until homogeneous. The mixture was applied to a substrate using conventional coating techniques, including spraying, spinning, dipping, and film applicating. In the case of film applicating, the dosed 2-part polyurethane solution was applied in front of the film applicator using a syringe and the film is drawn down over the substrate with a target wet film thickness between 2 and 10 mil. The film was then allowed to cure in either ambient conditions or elevated temperature according to product specifications. Additional coats may be applied as necessary.

### Example 2

The following example illustrates experiments to determine the antimicrobial efficacy of copper(I) salt and copper-assisting additives in commercial two-part polyurethane and two-part epoxy resin prepared according to the procedure of Example 1.

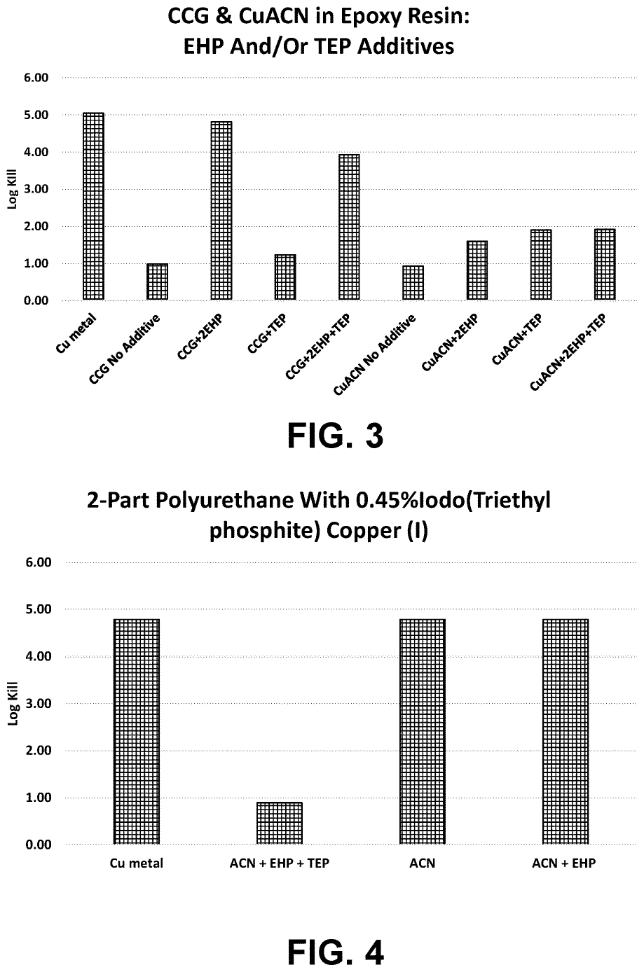

An additional copper-assisting additive (TEP) was used in combination with EHP in an attempt to keep the copper that is extracted by EHP from being oxidized. However, in both 2-part polyurethane in amounts according to Table 2 below, and in two-part epoxy resin, in amounts according to Table 3 below, as illustrated in FIGS. 2 and 3, respectively, the copper-containing glass achieved antimicrobial efficacy of at least 3 log kill. Antimicrobial efficacy was lower using copper(I) salt as the copper source, a log kill of about 1-2. The same additives in the same stoichiometry, with the same order of addition, were used for both the CCG samples and the copper(I) salt samples.

TABLE 2

| | | | | | | Mass Part | Mass Part | |
|---|---|---|---|---|---|---|---|---|
| | | Mass | | | | A of Poly- | B of Poly- | |
| | Mass | Cu(ACN)₄ | Mass | Mass | Mass | urethane | urethane | Total |
| Conditions | CCG (g) | (g) | ACN (g) | EHP (g) | TEP (g) | (g) | (g) | (g) |
| CCG in | 0.774 | 0 | 3.096 | 1.06 | 0.546 | 8 | 2 | 15.48 |
| ACN + | | | | | | | | |
| EHP + | | | | | | | | |
| TEP (5 | | | | | | | | |
| weight %) | | | | | | | | |
| Cu(ACN)₄ | 0 | 0.345 | 1.382 | 0.897 | 0.462 | 8 | 2 | 13.09 |
| in ACN + | | | | | | | | |
| EHP + | | | | | | | | |
| TEP (0.45 | | | | | | | | |
| weight %) | | | | | | | | |

Note:
5% CCG refers to 5 weight % CCG in solution, 0.45% Cu(ACN)₄ refers to 0.45 weight % copper in solution (5% CCG equates to approximately 0.45 % available copper).

TABLE 3

| | | Mass | | | | Part A | Part B |
|---|---|---|---|---|---|---|---|
| | Mass | Cu salt | Mass | Mass | Mass | of Epoxy | of Epoxy |
| Conditions | CCG (g) | (g) | ACN (g) | EHP (g) | TEP (g) | (g) | (g) |
| CCG (No | 0.774 | — | 1.4 | 0 | 0 | 5 | 5 |
| additive) | | | | | | | |
| CCG + EHP | 0.774 | — | 1.4 | 1.06 | 0 | 5 | 5 |
| CCG + TEP | 0.774 | — | 1.4 | — | 0.546 | 5 | 5 |
| CCG + EHP + | 0.774 | — | 1.4 | 1.06 | 0.546 | 5 | 5 |
| TEP | | | | | | | |
| Cu(ACN)₄ | — | 0.345 | 1.4 | — | — | 5 | 5 |
| (No additive) | | | | | | | |
| Cu(ACN)₄ + | — | 0.345 | 1.4 | 0.897 | — | 5 | 5 |
| EHP | | | | | | | |
| Cu(ACN)₄ + | — | 0.345 | 1.4 | — | 0.462 | 5 | 5 |
| TEP | | | | | | | |
| Cu(ACN)₄ + | — | 0.345 | 1.4 | 0.897 | 0.462 | 5 | 5 |
| EHP + TEP | | | | | | | |

### Example 3

The following example illustrates experiments demonstrating the antimicrobial efficacy of copper(I)-additive complexes in two-part polyurethane prepared according to the procedure of Example 1 in which iodo (triethyl phosphite)copper(I) (“CuI (TEP)”) was the copper(I) salt.

CuI (TEP) resulted in full kill, whether EHP was added or not. While the EHP seemingly had no effect on antimicrobial efficacy, EHP addition in the amount according to Table 4 below advantageously provides a more neutral color hue in the resultant film. The further addition of TEP surprisingly and unexpectedly resulted in a reduction of antimicrobial activity for at least 90 days, as illustrated in FIG. 4, suggesting that there is a narrow range of TEP to Cu(I) stoichiometry that is antimicrobially efficacious, and excess TEP (greater than 2:1 molar ratio of TEP to copper(I)) results in dramatically reduced antimicrobial efficacy.

TABLE 4

| | | | | | Mass Part | Mass Part | |
|---|---|---|---|---|---|---|---|
| | Mass | | | | A of Poly- | B of Poly- | |
| | Cu Salt | Mass | Mass | Mass | urethane | urethane | Total |
| Condition | (g) | ACN (g) | EHP (g) | TEP (g) | (g) | (g) | (g) |
| Iodo(TEP)Cu(I) | 0.2898 | 1.1592 | 0 | 0 | 8 | 2 | 11.449 |
| in ACN (g) | | | | | | | |
| (0.45%) | | | | | | | |
| Iodo(TEP)Cu(I) | 0.3146 | 1.2582 | 0.8508 | 0 | 8 | 2 | 12.4237 |
| in ACN + | | | | | | | |
| EHP (0.45%) | | | | | | | |
| Iodo(TEP)Cu(I) | 0.3292 | 1.3168 | 0.8904 | 0.4589 | 8 | 2 | 12.9953 |
| in ACN + | | | | | | | |
| EHP + TEP | | | | | | | |
| (0.45%) | | | | | | | |

“0.45%” refers to 0.45 weight % copper in solution.

### Example 4

The following example illustrates experiments to determine the antimicrobial efficacy of copper(I)-additives complexes in epoxy resin prepared according to the procedure of Example 1 in which iodo (triethyl phosphite)copper(I) was the copper(I) salt.

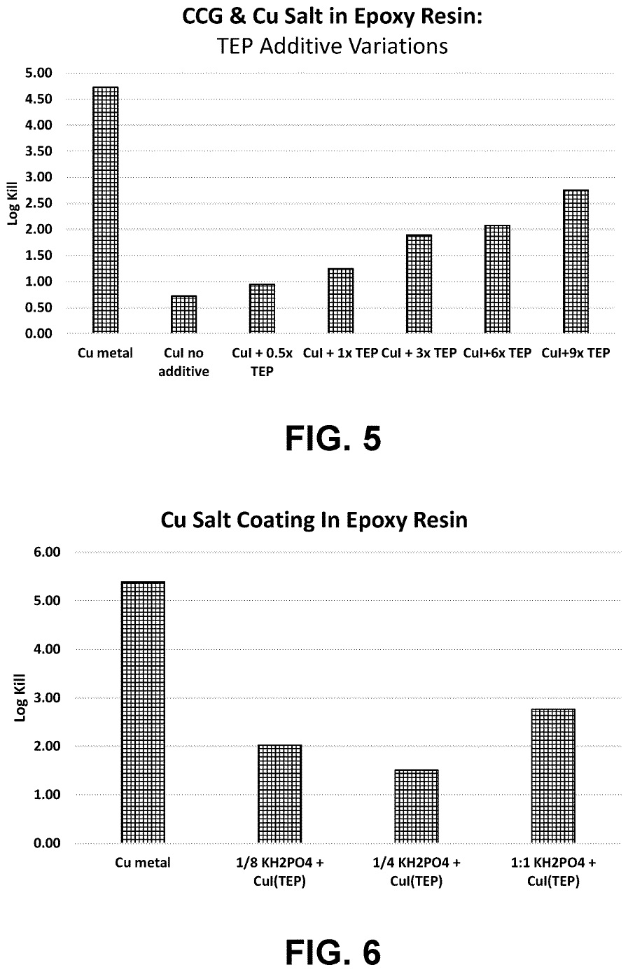

The use of the iodo (triethyl phosphite)copper(I) complex did not yield full kill in epoxy resin, and did not change the antimicrobial efficacy above the base epoxy resin, as illustrated in FIGS. 5 and 6. The addition of TEP to tetrakis(acetonitrile)copper(I) (3:1 molar ratio) or to copper(I) iodide (3:1 molar ratio) illustrates that for epoxy resin, more TEP is required for antimicrobial efficacy as compared to polyurethanes. The addition of more TEP (from 0.5:1 to 9:1 moles relative to copper(I) according to Table 5) did result in higher antimicrobial efficacy with higher amounts of TEP. While TEP may be a strong copper-assisting additive, there are more amine groups in an epoxy resin relative to binding groups in TEP.

TABLE 5

| | | | | Mass | Mass |
|---|---|---|---|---|---|
| | Mass | | | Part A | Part B |
| | CuI | Mass | Mass | of Epoxy | of Epoxy |
| Condition | Salt (g) | ACN (g) | TEP (g) | Resin (g) | Resin (g) |
| CuI (no additive) | 0.176 | 1.4 | 0 | 5 | 5 |
| CuI + 0.5 equiv. | 0.176 | 1.4 | 0.07 | 5 | 5 |
| TEP | | | | | |
| CuI + 1.0 equiv. | 0.176 | 1.4 | 0.15 | 5 | 5 |
| TEP | | | | | |
| CuI + 3.0 equiv. | 0.176 | 1.4 | 0.45 | 5 | 5 |
| TEP | | | | | |
| CuI + 6.0 equiv. | 0.176 | 1.4 | 0.9 | 5 | 5 |
| TEP | | | | | |
| CuI + 9.0 equiv. | 0.176 | 1.4 | 1.35 | 5 | 5 |
| TEP | | | | | |

Even a strongly binding ligand such as TEP cannot outcompete amines present in an epoxy resin in a reasonable quantity, so it makes sense to reduce the effectiveness of amines as ligands to allow TEP to bind to copper(I). The use of potassium phosphate monobasic in the amounts according to Table 6 below, was only partly effective, as the salt form was not very soluble in epoxy resin. The acid form (phosphoric acid or boric acid) of soluble glass components may catalyze epoxy ring opening, and protonation of amines may limit the effectiveness of the amines ligand, but the epoxy reaction should not be negatively impacted.

TABLE 6

| | | | | Mass | Mass |
|---|---|---|---|---|---|
| | | | | Part | Part |
| | Mass | | | A of | B of |
| | CuI(TEP) | Mass | Mass | Epoxy | Epoxy |
| | Salt | ACN | KH₂PO₄ | Resin | Resin |
| Condition | (g) | (g) | (g) | (g) | (g) |
| 0.3 weight % | 0.33 | 1.4 | 0.033 | 5 | 5 |
| KH₂PO₄ + CuI(TEP) | | | | | |
| 0.6 weight % | 0.33 | 1.4 | 0.66 | 5 | 5 |
| KH₂PO₄ + CuI(TEP) | | | | | |
| 2.4 weight % | 0.33 | 1.4 | 0.264 | 5 | 5 |
| KH₂PO₄ + CuI(TEP) | | | | | |

### Example 5

The following example illustrates antimicrobial efficacy for copper-ligand complexes generated in situ in two-part polyurethane coating prepared according to the procedure of Example 1.

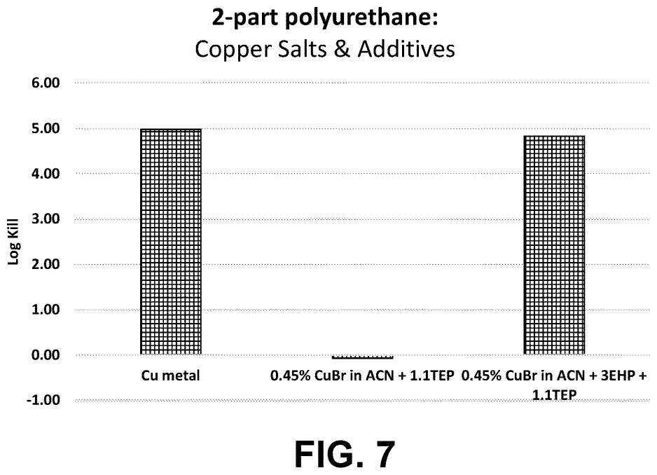

An iodo- or bromo (triethyl phosphite)copper(I) complex may be generated in situ without the need for synthesizing the complex first. In acetonitrile, it was possible to fully dissolve the copper(I) bromide, by addition of three molar equivalents of EHP in addition to 1 equivalent of TEP, resulting in antimicrobial efficacy (full kill) in the amounts according to Table 7 below, as illustrated in FIG. 7. Without addition of TEP, the copper(I) bromide was not solubilized in solution, resulting in no antimicrobial efficacy. The solution of the copper(I) salt and the copper-assisting additive was pre-filtered prior to the addition to the two-part polyurethane, as particulates in the coating would have resulted in a bumpy coating. Incorporation of undissolved copper(I) salts may eventually result in antimicrobial efficacy.

TABLE 7

| | | | | | Mass Part | Mass Part | |
|---|---|---|---|---|---|---|---|
| | Mass | | | | A of Poly- | B of Poly- | |
| | Cu Salt | Mass | Mass | Mass | urethane | urethane | Total |
| Condition | (g) | ACN (g) | EHP (g) | TEP (g) | (g) | (g) | (g) |
| CuBr in ACN + | 0.116 | 1.1602 | 0 | 0.1478 | 8 | 2 | 11.4241 |
| 1.1 equiv. TEP | | | | | | | |
| (0.45%) | | | | | | | |
| CuBr in ACN + | 0.126 | 1.2596 | 0.8493 | 0.1605 | 8 | 2 | 12.3953 |
| 3 equiv. EHP + | | | | | | | |
| 1.1 equiv. TEP | | | | | | | |
| (0.45%) | | | | | | | |

“0.45%” refers to 0.45 weight % copper in solution, and the values for EHP and TEP refer to molar equivalents relative to amount of copper in solution.

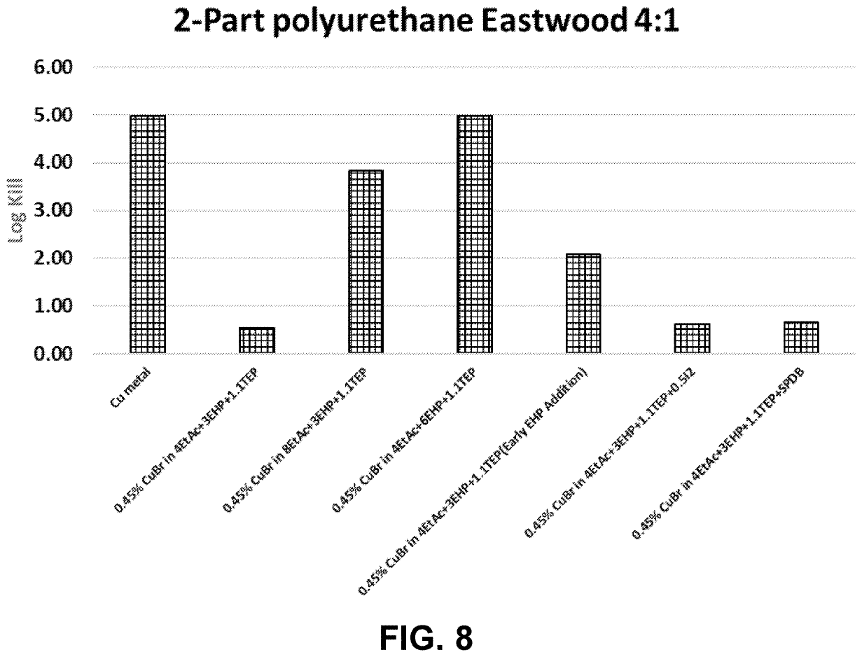

In situ formation was also demonstrated using ethyl acetate as a solvent instead of acetonitrile. Copper (I) bromide and TEP were added together in ethyl acetate and stirred for 2 hours in the amounts according to Table 8 below, then EHP was added to the mixture and stirred for another hour before addition into a mixture of Parts A and B of polyurethane. The mixture yielded essentially no efficacy. Doubling the amount of solvent increased the solubility, and the efficacy increased to ~4 log kill, as illustrated in FIG. 8. Doubling the amount of EHP further increased the efficacy to full kill. Even the addition of EHP at the start of the procedure of preparing the mixture, rather than after 2 hours) gave a slight boost to antimicrobial efficacy (log 2 instead of 0.5). The addition of sodium phosphate dibasic (“SPDB”) or iodine (“I₂”) did not improve the solubility or antimicrobial efficacy.

TABLE 8

| | | | | | | | Mass Part | Mass Part | |
|---|---|---|---|---|---|---|---|---|---|
| | Mass | | | | | | A of Poly- | B of Poly- | |
| | Cu Salt | Mass | Mass | Mass | Mass | Mass | urethane | urethane | Total |
| Condition | (g) | I₂ (g) | EtOAc (g) | EHP (g) | TEP (g) | SPDB (g) | (g) | (g) | (g) |
| CuBr in 4 | 0.1172 | 0 | 0.4686 | 0.79 | 0.1493 | 0 | 8 | 2 | 11.525 |
| equiv. EtOAc + | | | | | | | | | |
| 3 equiv. EHP + | | | | | | | | | |
| 1.1 equiv. | | | | | | | | | |
| TEP (0.45%) | | | | | | | | | |
| CuBr in 8 | 0.1228 | 0 | 0.9824 | 0.828 | 0.1565 | 0 | 8 | 2 | 12.0896 |
| equiv. EtOAC + | | | | | | | | | |
| 3 equiv. EHP + | | | | | | | | | |
| 1.1 equiv. | | | | | | | | | |
| TEP (0.45%) | | | | | | | | | |
| CuBr in 4 | 0.1271 | 0 | 0.5083 | 1.7139 | 0.1619 | 0 | 8 | 2 | 12.5112 |
| equiv. EtOAc + | | | | | | | | | |
| 6 equiv. EHP + | | | | | | | | | |
| 1.1 equiv. | | | | | | | | | |
| TEP (0.45%) | | | | | | | | | |
| CuBr in 4 | 0.1172 | 0 | 0.4686 | 0.79 | 0.1493 | 0 | 8 | 2 | 11.525 |
| equiv. EtOAc + | | | | | | | | | |
| 3 equiv. EHP + | | | | | | | | | |
| 1.1 equiv. | | | | | | | | | |
| TEP (0.45%) | | | | | | | | | |
| (Earlier EHP | | | | | | | | | |
| Addition) | | | | | | | | | |
| CuBr in 4 | 0.1183 | 0.1046 | 0.4731 | 0.7976 | 0.1507 | 0 | 8 | 2 | 11.6443 |
| equiv. EtOAc + | | | | | | | | | |
| 1 equiv. I₂ + 3 | | | | | | | | | |
| equiv. EHP + | | | | | | | | | |
| 1.1 equiv. | | | | | | | | | |
| TEP (0.45%) | | | | | | | | | |
| CuBr in 4 | 0.1172 | 0 | 0.4686 | 0.79 | 0.1493 | 0.0065 | 8 | 2 | 11.5315 |
| equiv. EtOAc + | | | | | | | | | |
| 3 equiv. EHP + | | | | | | | | | |
| 1.1 equiv. | | | | | | | | | |
| TEP + 1 | | | | | | | | | |
| equiv. | | | | | | | | | |
| SPDB (0.45%) | | | | | | | | | |

“0.45%” refers to 0.45 weight % copper in solution, and the “equiv.” values for EtOAc, EHP, TEP, I₂, and SPDB are molar equivalents relative to amount of copper in solution.

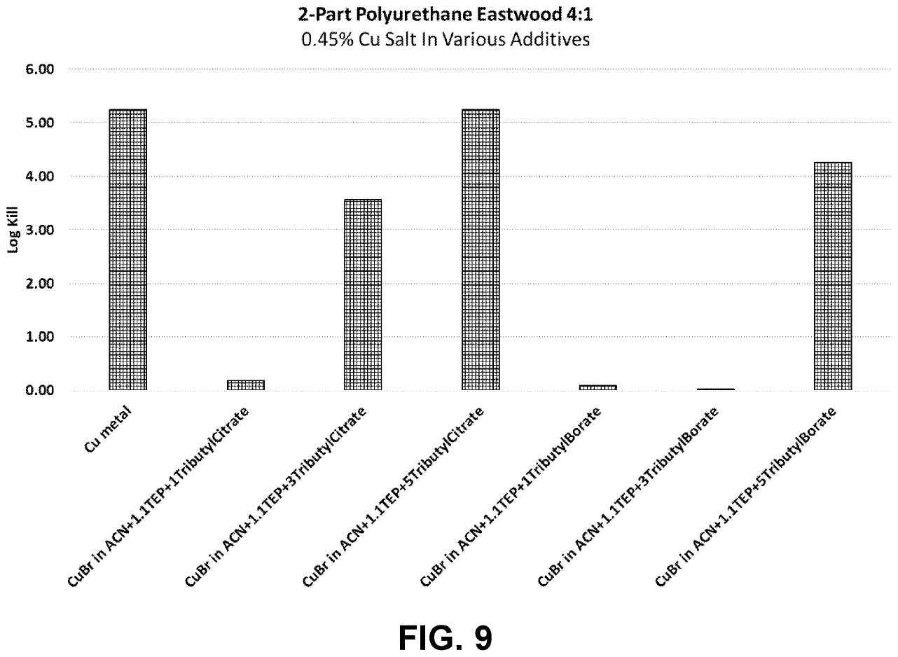

EHP may be substituted for another solubilizer such as tributyl citrate (“TBC”) or tributyl borate (“TBB”) in the amounts according to Table 9 below, which have both been shown to yield higher antimicrobial efficacy (tributyl citrate full kill, tributyl borate >4 log kill), as illustrated in FIG. 9.

TABLE 9

| | | | | | Mass Part | Mass Part | |
|---|---|---|---|---|---|---|---|
| | Mass | | Mass | | A of Poly- | B of Poly- | |
| | Cu Salt | Mass | TBC or | Mass | urethane | urethane | Total |
| Condition | (g) | ACN (g) | TBB (g) | TEP (g) | (g) | (g) | (g) |
| CuBr in 35 | 0.1196 | 1.1982 | 0.3006 | 0.1524 | 8 | 2 | 11.7709 |
| equiv. ACN + | | | | | | | |
| 1 equiv. TBC + | | | | | | | |
| 1.1 equiv. | | | | | | | |
| TEP (0.45%) | | | | | | | |
| CuBr in 35 | 0.1273 | 1.2751 | 0.9597 | 0.1622 | 8 | 2 | 12.5243 |
| equiv. ACN + | | | | | | | |
| 3 equiv. TBC + | | | | | | | |
| 1.1 equiv. | | | | | | | |
| TEP (0.45%) | | | | | | | |
| CuBr in 35 | 0.1359 | 1.361 | 1.7072 | 0.1731 | 8 | 2 | 13.3772 |
| equiv. ACN + | | | | | | | |
| 5 equiv. TBC + | | | | | | | |
| 1.1 equiv. | | | | | | | |
| TEP (0.45%) | | | | | | | |
| CuBr in 35 | 0.1183 | 1.1847 | 0.1898 | 0.1507 | 8 | 2 | 11.6434 |
| equiv. ACN + | | | | | | | |
| 1 equiv. TBB + | | | | | | | |
| 1.1 equiv. | | | | | | | |
| TEP (0.45%) | | | | | | | |
| CuBr in 35 | 0.123 | 1.2321 | 0.5921 | 0.1567 | 8 | 2 | 12.104 |
| equiv. ACN + | | | | | | | |
| 3 equiv. TBB + | | | | | | | |
| 1.1 equiv. | | | | | | | |
| TEP (0.45%) | | | | | | | |
| CuBr in 35 | 0.1278 | 1.2796 | 1.0249 | 0.1628 | 8 | 2 | 12.5951 |
| equiv. ACN + | | | | | | | |
| 5 equiv. TBB + | | | | | | | |
| 1.1 equiv. | | | | | | | |
| TEP (0.45%) | | | | | | | |

“0.45%” refers to 0.45 weight % copper in solution, and the “equiv.” values for ACN, TEP, TBC, and TBB are molar equivalents relative to amount of copper in solution.

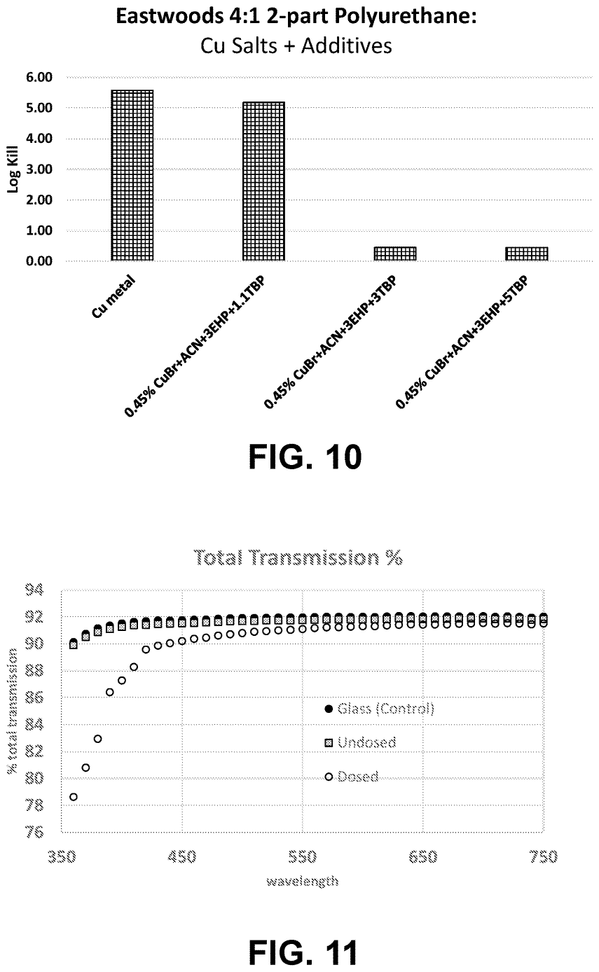

Tributyl phosphine (“TBP”) was also shown to be effective as a copper-assisting additive in 2-part polyurethane with copper(I) bromide and EHP in the amounts as provided below in Table 10. TBP demonstrated full kill antimicrobial efficacy at slight excess of TBP relative to copper, but not demonstrating antimicrobial efficacy at larger molar excess of TBP relative to copper, as illustrated in FIG. 10.

TABLE 10

| | | | | | Mass Part | Mass Part | |
|---|---|---|---|---|---|---|---|
| | Mass | | | | A of Poly- | B of Poly- | |
| | Cu salt | Mass | Mass | Mass | urethane | urethane | Total |
| Condition | (g) | ACN (g) | EHP (g) | TBP (g) | (g) | (g) | (g) |
| CuBr (0.45%) | 0.1264 | 1.2661 | 0.8524 | 0.1961 | 8 | 2 | 12.4409 |
| in 35 equiv. | | | | | | | |
| ACN + 3 | | | | | | | |
| equiv. EHP + | | | | | | | |
| 1.1 equiv. TBP | | | | | | | |
| CuBr (0.45%) | 0.1309 | 1.3113 | 0.8828 | 0.554 | 8 | 2 | 12.879 |
| in 35 equiv. | | | | | | | |
| ACN + 3 | | | | | | | |
| equiv. EHP + | | | | | | | |
| 3 equiv. TBP | | | | | | | |
| CuBr (0.45%) | 0.1359 | 1.361 | 0.9163 | 0.9583 | 8 | 2 | 13.3715 |
| in 35 equiv. | | | | | | | |
| ACN + 3 | | | | | | | |
| equiv. EHP + | | | | | | | |
| 5 equiv. TBP | | | | | | | |

“0.45%” refers to 0.45 weight % copper in solution and the “equiv.” values for ACN, EHP, and TBP are molar equivalents relative to amount of copper in solution.

Coatings (~40 μm) spun coat on glass with and without copper(I) resulted in minimal changes in color and only a slight loss of transmission for dosed copper, with ΔE* of 0.1 for the undosed polyurethane (“undosed”) relative to uncoated glass (“glass (control)”), and 0.6 for the copper-dosed polyurethane coating. The copper-dosed polyurethane coating (“dosed”) used the Iodo (TEP) Cu(I) in ACN+EHP (0.45%) exemplary composition including amounts as recited above in Table 4. The transmission loss was minimal, with minor absorbance at approximately 350 nm, as illustrated in FIG. 11. The CIE values for glass, undosed polyurethane, and copper-additive dosed polyurethane are provided below in Table 11.

TABLE 11

| Sample | L* | a* | b* | ΔE* | Haze |
|---|---|---|---|---|---|
| Glass | 96.8 | 0 | 0.1 | N/A | 0.0 |
| (control) | | | | | |
| Undosed | 96.7 | 0.0 | 0.2 | 0.1 | 0.0 |
| Dosed | 96.4 | 0.0 | 0.7 | 0.6 | 1.1 |

It will be appreciated that the various disclosed aspects or examples may involve particular features, elements, or steps that are described in connection with that particular aspect or example. It will also be appreciated that a particular feature, element, or step, although described in relation to one particular aspect or example, may be interchanged or combined with alternate aspects or examples in various non-illustrated combinations or permutations.

While various features, elements, or steps of particular aspects or examples may be disclosed using the transitional phrase “comprising,” it is to be understood that alternative aspects or examples, including those that may be described using the transitional phrases “consisting of” or “consisting essentially of,” are implied. Thus, for example, implied alternative aspects or examples to a device that comprises A+B+C include aspects or examples where a device consists of A+B+C and aspects or examples where a device consists essentially of A+B+C.

It will be apparent to those ordinarily skilled in the art that various modifications and variations may be made to the present disclosure without departing from the spirit and scope of the disclosure. Because modifications, combinations, sub-combinations, and variations of the disclosed examples incorporating the spirit and substance of the disclosure may occur to persons ordinarily skilled in the art, the disclosure should be construed to include everything within the scope of the appended claims and their equivalents.

1. A biocidal composition, comprising:
a carrier, comprising a polyurethane, a polyurethane precursor, an epoxy resin, an epoxy resin precursor, a melamine resin, or any combination thereof;
a copper(I) salt; and
a copper-assisting additive different from the carrier;
wherein the copper-assisting additive comprises a phosphite, a phosphine, or a combination thereof; and
wherein the biocidal composition or a film thereof exhibits an antimicrobial efficacy of at least 3 log kill as measured with an EPA Test after storage of the biocidal composition or the film thereof at ambient temperature and ambient relative humidity for 90 days.

2. The biocidal composition of claim 1, wherein the phosphite is a compound of formula (I): 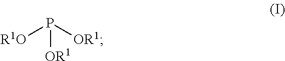
wherein each R¹ is independently selected from C₁-C₂₀ alkyl, aryl, and aryl(C₁-C₄)alkyl, any of which is optionally fluorosubstituted.

3. The biocidal composition of claim 1, wherein the phosphine is a compound of formula (II): 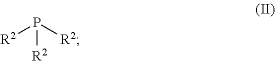
wherein each R² is independently selected from C₁-C₂₀ alkyl, aryl, and aryl(C₁-C₄)alkyl, any of which is optionally substituted with a hydroxy group.

4.-6. (canceled)

7. The biocidal composition of claim 1, wherein the copper(I) salt is a copper(I) halide, iodo(triethyl phosphite)copper(I), or a tetrakis(acetonitrile)copper(I) salt.

8. The biocidal composition of claim 1, wherein the copper(I) salt is copper(I) bromide or copper(I) iodide.

9.-10. (canceled)

11. The biocidal composition of claim 1, wherein the copper-assisting additive is triethyl phosphite, tributyl phosphine, triphenyl phosphite, or any combination thereof.

12. (canceled)

13. The biocidal composition of claim 1, further comprising a compound of formula (III), (IV), (V), or any combination thereof: 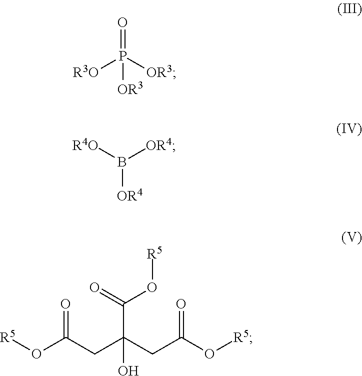
wherein each R³ is independently selected from hydrogen, C₁-C₂₀ alkyl, aryl, and aryl(C₁-C₄)alkyl, provided that all R³ are not simultaneously hydrogen;
wherein each R⁴ is independently selected from hydrogen, C₁-C₂₀ alkyl, aryl, and aryl(C₁-C₄)alkyl, provided that all R⁴ are not simultaneously hydrogen; and
wherein each R⁵ is independently selected from hydrogen, C₁-C₂₀ alkyl, aryl, and aryl(C₁-C₄)alkyl, provided that all R⁵ are not simultaneously hydrogen.

14. (canceled)

15. The biocidal composition of claim 1, further comprising 2-ethylhexyl phosphate, tributyl borate, tributyl citrate, or any combination thereof.

16.-19. (canceled)

20. The biocidal composition of claim 1, wherein at least one of the following is satisfied:
(1) the biocidal composition exhibits a ΔE of less than 6, as calculated according to
$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$
and
wherein L*, a*, and b* are CIE values of the biocidal composition after preparing and then storing the biocidal composition at ambient temperature and ambient relative humidity for 90 days, and
$${L}_{control}^{*} , {a}_{control}^{*} ,$$
and
$${b}_{control}^{*}$$
are CIE values of an otherwise identical composition without either the copper(I) salt or the copper-assisting additive;
(2) the biocidal composition or the film thereof exhibits a transmittance of at least 98% as measured at each wavelength from 400 to 700 nanometers when measured at a thickness of 40 μm;
(3) the transmittance is within 10 percentage points of a second transmittance of an otherwise identical composition or film thereof without either the copper(I) salt or the copper-assisting additive when measured at a thickness of 40 μm; or
(4) any combination thereof.

21.-22. (canceled)

23. A method of preparing the biocidal composition of claim 1, comprising:
adding a biocidal additive formulation to a carrier;
wherein when the carrier is a polyurethane or an epoxy resin, the biocidal additive formulation comprises the copper(I) salt and the copper-assisting additive;
wherein when the carrier is a second polyurethane precursor, the biocidal additive formulation comprises a first polyurethane precursor, the copper(I) salt, and the copper-assisting additive; and
wherein when the carrier is a second epoxy resin precursor, the biocidal additive formulation comprises a first epoxy resin precursor, the copper(I) salt, and the copper-assisting additive.

24. A biocidal additive formulation, comprising:
a copper(I) salt; and
a copper-assisting additive;
wherein a biocidal composition comprising the biocidal additive formulation and a carrier, or a film of the biocidal composition, exhibits an antimicrobial efficacy of at least 3 log kill as measured with an EPA Test after storage of the biocidal composition or the film thereof at ambient temperature and ambient relative humidity for 90 days;
wherein the carrier comprises a polyurethane, a polyurethane precursor, an epoxy resin, an epoxy resin precursor, a melamine resin, or any combination thereof;
wherein the biocidal composition exhibits a ΔE of less than 6, as calculated according to
$$Δ E = \sqrt{( {( {L}^{*} - {L}_{control}^{*} )}^{2} + {( {a}^{*} - {a}_{control}^{*} )}^{2} + {( {b}^{*} - {b}_{control}^{*} )}^{2} )} ;$$
and
wherein L*, a*, and b* are CIE values of the biocidal composition after preparing and then storing the biocidal composition at ambient temperature and ambient relative humidity for 90 days, and
$${L}_{control}^{*} , {a}_{control}^{*} ,$$
and
$${b}_{control}^{*}$$
are CIE values of an otherwise identical composition without either the copper(I) salt or the copper-assisting additive.

25. (canceled)

26. The biocidal additive formulation of claim 24, wherein the copper(I) salt is a copper(I) halide, iodo (triethyl phosphite)copper(I), or a tetrakis(acetonitrile)copper(I) salt.

27. The biocidal additive formulation of claim 24, wherein the copper(I) salt is copper(I) bromide or copper(I) iodide.

28. The biocidal additive formulation of claim 24, wherein the copper-assisting additive comprises a phosphite, a phosphine, or a combination thereof.

29. The biocidal additive formulation of claim 28, wherein the phosphite is a compound of formula (I): 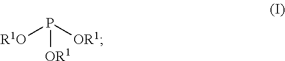
wherein each R¹ is independently selected from C₁-C₂₀ alkyl, aryl, and aryl(C₁-C₄)alkyl, any of which is optionally fluorosubstituted.

30. The biocidal additive formulation of claim 28, wherein the phosphine is a compound of formula (II): 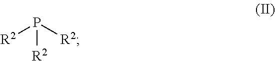
wherein each R² is independently selected from C₁-C₂₀ alkyl, aryl, and aryl(C₁-C₄)alkyl, any of which is optionally substituted with a hydroxy group.

31.-32. (canceled)

33. The biocidal additive formulation of claim 24, wherein the copper-assisting additive is triethyl phosphite, tributyl phosphine, triphenyl phosphite, or any combination thereof.

34. (canceled)

35. The biocidal additive formulation of claim 24, further comprising a compound of formula (III), (IV), (V), or any combination thereof: 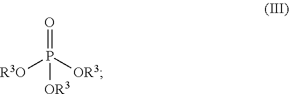 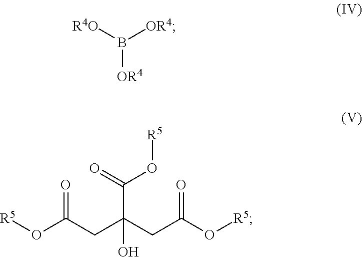
wherein each R³ is independently selected from hydrogen, C₁-C₂₀ alkyl, aryl, and aryl(C₁-C₄)alkyl, provided that all R³ are not simultaneously hydrogen;
wherein each R⁴ is independently selected from hydrogen, C₁-C₂₀ alkyl, aryl, and aryl(C₁-C₄)alkyl, provided that all R⁴ are not simultaneously hydrogen; and
wherein each R⁵ is independently selected from hydrogen, C₁-C₂₀ alkyl, aryl, and aryl(C₁-C₄)alkyl, provided that all R⁵ are not simultaneously hydrogen.

36.-38. (canceled)

39. The biocidal additive formulation of claim 24, further comprising tributyl borate, tributyl citrate, or any combination thereof.

40.-41. (canceled)

42. The biocidal additive formulation of claim 24, wherein at least one of the following is satisfied:
(1) the biocidal composition or the film thereof exhibits a transmittance of at least 98% as measured at each wavelength from 400 to 700 nanometers when measured at a thickness of 40 μm;
(2) the biocidal additive formulation further comprises tributyl borate, tributyl citrate, or any combination thereof;
(3) the transmittance is within 10 percentage points of a second transmittance of an otherwise identical composition or film thereof without either the copper(I) salt or the copper-assisting additive when measured at a thickness of 40 μm; or
(4) any combination thereof.

43.-46. (canceled)
